(19) United States
(12) Patent Application Publication
(10) Pub. No.: US 2025/0254451 A1
(43) Pub. Date: Aug. 7, 2025

(54) SOUND APPARATUS AND VEHICULAR APPARATUS INCLUDING THE SAME

(71) Applicant: LG Display Co., Ltd., Seoul (KR)

(72) Inventors: SangWoo JIN, Paju-si (KR); NohJin MYUNG, Paju-si (KR); Eun ROH, Paju-si (KR)

(73) Assignee: LG Display Co., Ltd., Seoul (KR)

(21) Appl. No.: 19/037,856

(22) Filed: Jan. 27, 2025

(30) Foreign Application Priority Data
Feb. 7, 2024 (KR) 10-2024-0019190

(51) Int. Cl. H04R 1/02; H04R 17/00

(52) U.S. Cl. CPC H04R 1/025; H04R 17/00; H04R 2499/13

(57) ABSTRACT

In one or more examples, a sound apparatus includes an enclosure including an internal space, a sound generating module in the internal space of the enclosure, and a coupling member partially provided between the enclosure and the sound generating module. One or more examples of a vehicular apparatus having the sound apparatus are also disclosed.

### CROSS-REFERENCE TO RELATED APPLICATION

This application claims the benefit of and priority to Korean Patent Application No. 10-2024-0019190 filed on Feb. 7, 2024, the entirety of which is hereby incorporated by reference for all purposes as if fully set forth herein.

### BACKGROUND

### 1. Technical Field

The present disclosure relates to a sound apparatus and a vehicular apparatus including the same.

### 2. Description of the Related Art

Vehicles include a sound apparatus which outputs a sound based on an audio signal output from a multimedia device such as a car audio device. For example, the sound apparatus applied to vehicles may include a front speaker and a rear speaker, which are configured as a coil type.

However, a sound apparatus in the vehicles may be limited when outputting a realistic sound or stereo sound of a multichannel through the front speaker and the rear speaker to limitations of the coil type device. Further, in the sound apparatus in vehicles, in a case where the number of speakers are increased, a stereo sound may be output, but due to a size of the speakers based on the coil type device and a limitation of a space in vehicles, there is a limitation in increasing the number of speakers so that a realistic sound or stereo sound cannot be provided using the coil type device.

The description of the related art should not be assumed to be prior art merely because it is mentioned in or associated with this section. The description of the related art includes information that describes one or more aspects of the subject technology, and the description in this section does not limit the invention.

### SUMMARY

The inventors of the present disclosure have recognized the problems and disadvantages of the related art and have performed extensive research and experiments for enhancing a sound characteristic and/or a sound pressure level characteristic of a sound apparatus for vehicles. Based on the extensive research and experiments, the inventors have invented a sound apparatus and a vehicular apparatus including the same, which may enhance a sound characteristic and/or a sound pressure level characteristic.

An aspect of the present disclosure is directed to providing a sound apparatus and a vehicular apparatus including the same, which may enhance a sound characteristic and/or a sound pressure level characteristic.

An aspect of the present disclosure is directed to providing a sound apparatus and a vehicular apparatus including the same, which may enhance a sound characteristic and/or a sound pressure level characteristic in a pitched sound band including a sound of a middle-low-pitched sound band.

Additional features, advantages, and aspects will be set forth in the description that follows, and in part will be apparent from the description, or may be learned by practice of the inventive concepts provided herein. Other features, advantages, and aspects of the present disclosure may be realized and attained by the structure particularly pointed out in the written description, or derivable therefrom, and the claims hereof as well as the appended drawings.

To achieve these and other advantages and aspects of the present disclosure, as embodied and broadly described herein, in one or more aspects, a sound apparatus comprises an enclosure including an internal space, a sound generating module in the internal space of the enclosure, and a coupling member partially provided between the enclosure and the sound generating module.

In one or more aspects, a vehicular apparatus comprises an interior material exposed at an interior space, and at least one or more sound generating apparatuses connected to the interior material and configured to output a sound to the interior space. The at least one or more sound generating apparatuses comprise an enclosure including an internal space, a sound generating module in the internal space of the enclosure, and a coupling member partially provided between the enclosure and the sound generating module.

In one or more aspects, a vehicular apparatus comprises an interior material exposed at an interior space, and at least one or more sound apparatuses as described above, connected to the interior material and configured to output a sound to the interior space.

Details of other example embodiments will be included in the detailed description of the disclosure and the accompanying drawings.

According to a sound apparatus and a vehicular apparatus including the same according to one or more example embodiments of the present disclosure, a sound characteristic and/or a sound pressure level characteristic may be enhanced.

According to a sound apparatus and a vehicular apparatus including the same according to one or more example embodiments of the present disclosure, a sound characteristic and/or a sound pressure level characteristic may be enhanced in a pitched sound band including a sound of a middle-low-pitched sound band.

According to a sound apparatus and a vehicular apparatus including the same according to one or more example embodiments of the present disclosure, a plurality of holes may be configured at an enclosure, and thus, a sound characteristic and/or a sound pressure level characteristic in a specific pitched sound band (or a specific frequency) can be additionally enhanced.

According to a sound apparatus and a vehicular apparatus including the same according to one or more example embodiments of the present disclosure, a signal supply member and a vibration generating part may be configured as one part (or one component), thereby realizing an effect of uni-materialization.

Other systems, methods, features and advantages will be, or will become, apparent to one with skill in the art upon examination of the following figures and detailed description. It is intended that all such additional systems, methods, features and advantages be included within this description, be within the scope of the present disclosure, and be protected by the following claims. Nothing in this section should be taken as a limitation on those claims. Further aspects and advantages are discussed below in conjunction with aspects of the disclosure.

It is to be understood that both the foregoing description and the following description of the present disclosure are example and explanatory and are intended to provide further explanation of the disclosure as claimed.

### BRIEF DESCRIPTION OF THE DRAWINGS

The accompanying drawings, which are included to provide a further understanding of the present disclosure, are incorporated in and constitute a part of this present disclosure, illustrate aspects and embodiments of the present disclosure, and together with the description serve to explain principles and examples of the disclosure.

FIG. 1 is a diagram illustrating a sound apparatus for vehicles according to an example embodiment of the present disclosure.

FIG. 2 is a diagram illustrating a sound apparatus for vehicles according to another example embodiment of the present disclosure.

FIG. 3 is a perspective view illustrating a sound apparatus according to an example embodiment of the present disclosure.

FIG. 4 is a cross-sectional view taken along line I-I′ illustrated in FIG. 3 according to an example embodiment of the present disclosure.

FIG. 5 is a cross-sectional view taken along line II-II′ illustrated in FIG. 3 according to an example embodiment of the present disclosure.

FIG. 6 is an exploded perspective view of a sound apparatus according to an example embodiment of the present disclosure.

FIG. 7 is a plan view illustrating a sound generating module and a coupling member in a sound apparatus according to an experimental example.

FIGS. 8 to 21 are plan views illustrating various example embodiments of a sound generating module and a coupling member in a sound apparatus according to example embodiments of the present disclosure.

FIGS. 22 to 26 are plan views illustrating a sound generating module and a coupling member in a sound apparatus according to another example embodiment of the present disclosure.

FIG. 27 is a plan view illustrating a sound generating module and a coupling member in a sound apparatus according to another example embodiment of the present disclosure.

FIG. 28 is a perspective view of a sound apparatus according to another example embodiment of the present disclosure.

FIG. 29 is a cross-sectional view taken along line III-III′ illustrated in FIG. 28 according to an example embodiment of the present disclosure.

FIG. 30 is a cross-sectional view taken along line IV-IV′ illustrated in FIG. 28 according to an example embodiment of the present disclosure.

FIG. 31 is a perspective view of a sound apparatus according to another example embodiment of the present disclosure.

FIG. 32 is a cross-sectional view taken along line V-V′ illustrated in FIG. 31 according to an example embodiment of the present disclosure.

FIG. 33 is a perspective view of a sound apparatus according to another example embodiment of the present disclosure.

FIG. 34 is a cross-sectional view taken along line VI-VI′ illustrated in FIG. 33 according to an example embodiment of the present disclosure.

FIG. 35 is a perspective view of a sound apparatus according to another example embodiment of the present disclosure.

FIG. 36 is a cross-sectional view taken along line VII-VII′ illustrated in FIG. 35 according to an example embodiment of the present disclosure.

FIG. 37 is an exploded perspective view of a sound apparatus according to another example embodiment of the present disclosure.

FIG. 38 is a perspective view of a sound apparatus according to another example embodiment of the present disclosure.

FIG. 39 is a cross-sectional view taken along line VIII-VIII′ illustrated in FIG. 38 according to an example embodiment of the present disclosure.

FIG. 40 is a cross-sectional view taken along line IX-IX′ illustrated in FIG. 38 according to an example embodiment of the present disclosure.

FIG. 41 is a perspective view of a sound apparatus according to another example embodiment of the present disclosure.

FIG. 42 is a diagram illustrating a sound apparatus according to another example embodiment of the present disclosure.

FIG. 43 is a diagram illustrating a sound apparatus according to another example embodiment of the present disclosure.

FIG. 44 is an exploded perspective view of a sound apparatus illustrated in FIG. 43 according to an example embodiment of the present disclosure.

FIG. 45 is a cross-sectional view illustrating a sound apparatus according to another example embodiment of the present disclosure.

FIG. 46 is a perspective view illustrating an enclosure illustrated in FIG. 45 according to an example embodiment of the present disclosure.

FIG. 47 is a diagram illustrating a vibration apparatus according to an example embodiment of the present disclosure.

FIG. 48 is a cross-sectional view taken along line X-X′ illustrated in FIG. 47 according to an example embodiment of the present disclosure.

FIG. 49 is a cross-sectional view taken along line XI-XI′ illustrated in FIG. 47 according to an example embodiment of the present disclosure.

FIG. 50 is a diagram illustrating a vibration part according to another example embodiment of the present disclosure.

FIG. 51 is a diagram illustrating a vibration part according to another example embodiment of the present disclosure.

FIG. 52 is a diagram illustrating a vibration apparatus according to another example embodiment of the present disclosure.

FIG. 53 is a diagram illustrating a vehicular apparatus according to an example embodiment of the present disclosure.

FIG. 54 is a diagram illustrating a vehicular apparatus according to an example embodiment of the present disclosure.

FIG. 55 is a diagram illustrating a sound generating apparatus disposed at a roof of a vehicular apparatus illustrated in FIGS. 53 and 54.

FIG. 56 is a diagram illustrating a sound generating apparatus disposed at a roof and a seat of a vehicular apparatus illustrated in FIGS. 53 and 54.

FIG. 57 is a diagram illustrating a sound output characteristic of a sound apparatus according to an example embodiment of the present disclosure and an experimental example.

FIG. 58 is a diagram illustrating a sound output characteristic of a sound apparatus according to example embodiments of the present disclosure and an experimental example.

FIG. 59 is a diagram illustrating a sound output characteristic of a sound apparatus according to example embodiments of the present disclosure and an experimental example.

FIG. 60 is a diagram illustrating a sound output characteristic of a sound apparatus according to example embodiments of the present disclosure and an experimental example.

FIG. 61 is a diagram illustrating a sound output characteristic of a sound apparatus according to an example embodiment of the present disclosure.

FIG. 62 is a diagram illustrating a sound output characteristic of a sound apparatus according to an example embodiment of the present disclosure.

FIG. 63 is a diagram illustrating a sound output characteristic of a sound apparatus according to another example embodiment of the present disclosure illustrated in FIG. 27.

Throughout the drawings and the detailed description, unless otherwise described, the same drawing reference numerals should be understood to refer to the same elements, features, and structures. The sizes, lengths, and thicknesses of layers, regions and elements, and depiction thereof may be exaggerated for clarity, illustration, and/or convenience.

### DETAILED DESCRIPTION

Advantages and features of the present disclosure, and implementation methods thereof, are clarified through the aspects described with reference to the accompanying drawings. The present disclosure may, however, be embodied in different forms and should not be construed as limited to the example aspects set forth herein. Rather, these example aspects are examples and are provided so that this disclosure may be thorough and complete to assist those skilled in the art to understand the inventive concepts without limiting the protected scope of the present disclosure.

A shape, a size, a ratio, an angle, and a number disclosed in the drawings for describing example embodiments of the present disclosure are merely an example, and thus, the present disclosure is not limited to the illustrated details. Like reference numerals refer to like elements throughout. In the following description, when a detailed description of well-known methods, functions, structures or configurations may unnecessarily obscure aspects of the present disclosure, the detailed description thereof may have been omitted for brevity.

In a situation where “comprise,” “have,” and “include” described in the present specification are used, another part can be added unless “only” is used. The terms of a singular form can include plural forms unless referred to the contrary.

In construing an element, the element is construed as including an error range although there is no explicit description.

In describing a position relationship, for example, when a position relation between two parts is described as “on,” “over,” “under,” and “next,” one or more other parts can be disposed between the two parts unless ‘just’ or ‘direct’ is used.

In describing a temporal relationship, for example, when the temporal order is described as “after,” “subsequent,” “next,” and “before,” a situation which is not continuous can be included, unless “just” or “direct” is used.

It will be understood that, although the terms “first,” “second,” etc. can be used herein to describe various elements, these elements should not be limited by these terms. These terms are only used to distinguish one element from another. For example, a first element could be termed a second element, and, similarly, a second element could be termed a first element, without departing from the scope of the present disclosure.

In describing elements of the present disclosure, the terms “first,” “second,” “A,” “B,” “(a),” “(b),” or the like can be used. These terms are intended to identify the corresponding element(s) from the other element(s), and these are not used to define the essence, basis, order, or number of the elements.

For the expression that an element is “connected,” “coupled,” or “contact,” to another element, the element may not only be directly connected, coupled, or contacted to another element, but also be indirectly connected, coupled, or contacted to another element with one or more intervening elements interposed between the elements, unless otherwise specified.

For the expression that an element is “contacts” or “overlaps” with another element, the element can not only directly contact, overlap, or the like with another element, but also indirectly contact or overlap with another element with one or more intervening elements disposed or interposed between the elements, unless otherwise specified.

The term “at least one” should be understood as including any and all combinations of one or more of the associated listed items. For example, the meaning of “at least one of a first item, a second item and a third item” denotes the combination of all items proposed from two or more of the first item, the second item and the third item as well as the first item, the second item or the third item.

Features of various example embodiments of the present disclosure can be partially or overall coupled to or combined with each other and can be variously inter-operated with each other and driven technically as those skilled in the art can sufficiently understand. The example embodiments of the present disclosure can be carried out independently from each other or can be carried out together in co-dependent relationship.

Hereinafter, example embodiments of a sound apparatus according to the present disclosure will be described in detail with reference to the accompanying drawings. For convenience of description, a scale of each of elements illustrated in the accompanying drawings differs from a real scale, and thus, is not limited to a scale illustrated in the drawings.

FIG. 1 is a diagram illustrating a sound apparatus according to an example embodiment of the present disclosure. For example, FIG. 1 is a diagram illustrating a sound apparatus for vehicles according to an example embodiment of the present disclosure.

With reference to FIG. 1, a sound apparatus 30 according to an example embodiment of the present disclosure may be disposed or equipped at an inner portion of a vehicle 10 to output a sound S toward an interior space (or an indoor space) IS of the vehicle (or a vehicular apparatus) 10.

The vehicle 10 may be a vehicular apparatus which includes one or more seats and one or more windows. For example, the vehicle 10 may include a vehicle, a train, a ship, or an aircraft, or the like, but example embodiments of the present disclosure are not limited thereto.

The vehicle 10 according to an example embodiment of the present disclosure may include a main structure 110.

The main structure 110 of the vehicle 10 may include a main frame, a sub-frame, a side frame, a door frame, an under-frame, and a seat frame, or the like, but example embodiments of the present disclosure are not limited thereto. For example, the main structure 110 may be a vehicle body, a vehicle structure, or a frame structure, or the like, but example embodiments of the present disclosure are not limited thereto.

The vehicle 10 according to an example embodiment of the present disclosure may further include an exterior material 120.

The exterior material 120 of the vehicle 10 may be configured to cover the main structure 110. For example, the exterior material 120 of the vehicle 10 may be configured to cover an outer portion of the main structure 110. In the following description, the exterior material 120 may be a vehicle exterior material 120, and may be used interchangeably.

The exterior material 120 of the vehicle 10 may include a hood panel, a front fender panel, a dash panel, a pillar panel, a trunk panel, a roof panel (or ceiling), a floor panel, a door inner panel, and a door outer panel, or the like, but example embodiments of the present disclosure are not limited thereto.

The exterior material 120 according to an example embodiment of the present disclosure may include at least one or more of a planar portion (or a flat portion) and a curved portion (or a flexural portion or an uneven portion). For example, the exterior material 120 may have a structure corresponding to a structure of a corresponding main structure 110, or may have a structure which differs from a structure of a corresponding main structure 110.

The vehicle 10 according to an example embodiment of the present disclosure may further include a vehicle interior material 130. In the following description, the vehicle interior material 130 may be an interior material 130, and may be used interchangeably.

The vehicle interior material 130 may include all elements (or components) configuring an inner portion of the vehicle 10, or may include all elements disposed at the interior space IS of the vehicle 10. For example, the vehicle interior material 130 may be an interior member or an interior finish material of the vehicle 10, but example embodiments of the present disclosure are not limited thereto.

The vehicle interior material 130 according to an example embodiment of the present disclosure may be configured to cover one or more of main structure 110 and the exterior material 120 in the interior space IS of the vehicle 10. For example, the interior material 130 may cover one or more of main structure 110 and the exterior material 120 in the interior space IS of the vehicle 10 and may be configured to be exposed at the interior space IS of the vehicle 10.

The vehicle interior material 130 according to an example embodiment of the present disclosure may be configured to be exposed at the inner portion and/or the interior space IS of the vehicle 10 in the inner portion and/or the interior space IS of the vehicle 10. For example, the vehicle interior material 130 may be configured to cover one or more surfaces (or an interior surfaces) of at least one or more of a main frame (or a vehicle body), a side frame (or a side body), a door frame (or a door body), a handle frame (or a steering hub), and a seat frame, which are exposed at the interior space IS of the vehicle 10.

The vehicle interior material 130 according to an example embodiment of the present disclosure may include a dashboard, a pillar interior material (or a pillar trim), a floor interior material (or a floor carpet), a roof interior material (or a headliner), a door interior material (or a door trim), a handle interior material (or a steering cover), a seat interior material, a rear package interior material (or a back seat shelf), an overhead console (or an illumination interior material), a rear view mirror, a glove box, and a sun visor, or the like, but example embodiments of the present disclosure are not limited thereto.

The vehicle interior material 130 according to an example embodiment of the present disclosure may include one or more of metal, wood, rubber, plastic, glass, fiber, cloth, paper, a mirror, leather, and carbon, but example embodiments of the present disclosure are not limited thereto. The vehicle interior material 130 including a plastic material may be an injection material which is implemented by an injection process using a thermoplastic resin or a thermosetting resin, but example embodiments of the present disclosure are not limited thereto. The vehicle interior material 130 including a fiber material may include at least one or more of a plastic composite fiber, a carbon fiber (or an aramid fiber), and a natural fiber, but example embodiments of the present disclosure are not limited thereto. The vehicle interior material 130 including the fiber material may include a textile sheet, a knit sheet, or a nonwoven fabric, or the like, but example embodiments of the present disclosure are not limited thereto. For example, the paper may be cone paper for speakers. For example, the cone paper may be pulp or foamed plastic, or the like, but example embodiments of the present disclosure are not limited thereto. The vehicle interior material 130 including a leather material may include natural leather or artificial leather, but example embodiments of the present disclosure are not limited thereto.

The vehicle interior material 130 according to an example embodiment of the present disclosure may include at least one or more of a planar portion and a curved portion (or a flexural portion or an uneven portion). For example, the vehicle interior material 130 may have a structure corresponding to a structure (or an inner surface structure) of a corresponding main structure 110, or may have a structure which differs from a structure of a corresponding main structure 110.

According to an example embodiment of the present disclosure, the sound apparatus 30 may be disposed at the vehicle interior material 130. The sound apparatus 30 may vibrate (or directly vibrate) the vehicle interior material 130 to generate a sound S based on a vibration of the vehicle interior material 130. For example, the sound apparatus 30 may be configured to vibrate the vehicle interior material 130 to output the sound S toward the inner portion and/or the interior space IS of the vehicle 10. Thus, the sound apparatus 30 may use the vehicle interior material 130 as a sound vibration plate. The vehicle interior material 130 may be a vibration plate, a sound vibration plate, or a sound generating plate for outputting the sound S. For example, the vehicle interior material 130 may have a size which is greater than the sound apparatus 30, but example embodiments of the present disclosure are not limited thereto.

According to an example embodiment of the present disclosure, the sound apparatus 30 may be disposed in at least one or more of a dashboard, a pillar interior material, a floor interior material, a roof interior material, a door interior material, a handle interior material, and a seat interior material, or may be disposed in or connected to (or coupled to) at least one or more of a rear package interior material, an overhead console, a rear view mirror, a glove box, and a sun visor. For example, the sound apparatus 30 may vibrate (or directly vibrate) at least one or more of the dashboard, the pillar interior material, the floor interior material, the roof interior material, the door interior material, the handle interior material, the seat interior material, the rear package interior material, the overhead console, the rear view mirror, the glove box, and the sun visor to output the sound S toward the inner portion and/or the interior space IS of the vehicle 10.

The vehicle 10 according to an example embodiment of the present disclosure may include one or more sound apparatuses 30 disposed in or connected to at least one or more regions (or portions) of the vehicle interior material 130. The one or more sound apparatuses 30 may vibrate the at least one or more regions (or portions) of the vehicle interior material 130 to output a realistic sound S and/or stereo sound including a multichannel toward the interior space IS of the vehicle 10.

According to an example embodiment of the present disclosure, the sound apparatus 30 may be configured in a region between the vehicle interior material 130 and the main structure 110, or a region between the vehicle interior material 130 and the exterior material 120. The sound apparatus 30 may be disposed in a region between the vehicle interior material 130 and the main structure 110, or a region between the vehicle interior material 130 and the exterior material 120, and may indirectly or directly vibrate one or more of the region between the vehicle interior material 130 and the main structure 110 and the region between the vehicle interior material 130 and the exterior material 120 to output sound S.

According to an example embodiment of the present disclosure, the sound apparatus 30 may be disposed in one or more of a region (or a first region) between the main structure 110 and the exterior material 120, a region (or a second region) between the main structure 110 and the vehicle interior material 130, the exterior material 120, and the vehicle interior material 130. For example, the sound apparatus 30 may be disposed in one or more of the region (or first region) between the main structure 110 and the exterior material 120, the region (or second region) between the main structure 110 and the vehicle interior material 130, the exterior material 120, and the vehicle interior material 130, and may be configured to output a sound. For example, the sound apparatus 30 may be disposed in one or more of the region (or first region) between the main structure 110 and the exterior material 120, the region (or second region) between the main structure 110 and the vehicle interior material 130, the exterior material 120, and the vehicle interior material 130, and may indirectly or directly vibrate one or more of the main structure 110, the exterior material 120, and the vehicle interior material 130 to output sound.

According to an example embodiment of the present disclosure, the sound apparatuses 30 may output a sound in a region between the exterior material 120 and the vehicle interior material 130 of the vehicle 10. For example, the sound apparatus 30 may be disposed in at least one or more of a region (or a third region) between the exterior material 120 and the vehicle interior material 130, the exterior material 120 and the vehicle interior material 130. For example, the sound apparatus 30 may be disposed in between the exterior material 120 and the vehicle interior material 130, and may indirectly or directly vibrate one or more of the exterior material 120 and the vehicle interior material 130 to output sound. For example, the sound apparatuses 30 may be connected or coupled to one or more of the exterior material 120 and the vehicle interior material 130 between the exterior material 120 and the vehicle interior material 130, and may indirectly or directly vibrate one or more of the exterior material 120 and the vehicle interior material 130 to output sound. For example, the at least one or more of the exterior material 120 and the vehicle interior material 130 may output a sound S based on driving (or vibration or displacement) of the one or more sound apparatuses 30.

According to an example embodiment of the present disclosure, one or more of the exterior material 120 and the vehicle interior material 130 of the vehicle 10 may be a vibration plate, a sound vibration plate, or a sound generating plate, or the like for outputting the sound S. For example, each of the exterior material 120 and the vehicle interior material 130 for outputting the sound S may have a size (or an area) which is greater than that of the sound apparatus 30, and thus, may perform a function of a large-area vibration plate, a large-area sound vibration plate, or a large-area sound generating plate, thereby enhancing a sound characteristic and/or a sound pressure level characteristic of a pitched sound band including a low-pitched sound band generated by the sound apparatus 30. For example, a frequency of a sound of the low-pitched sound band may be 300 Hz or less, 400 Hz or less, or 500 Hz or less, but example embodiments of the present disclosure are not limited thereto.

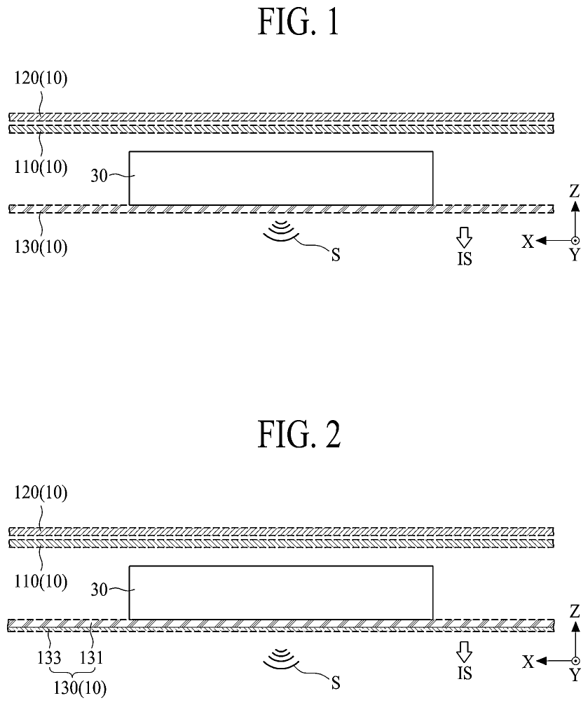

FIG. 2 is a diagram illustrating a sound apparatus for vehicles according to another example embodiment of the present disclosure. For example, FIG. 2 illustrates an example embodiment implemented by modifying the vehicle interior material 130 on which the sound apparatus described above with reference to FIG. 1 is disposed. Therefore, in the following description, repeated descriptions of other elements other than the vehicle interior material 130 may be omitted or will be briefly given.

With reference to FIG. 2, the sound apparatus 30 according to another example embodiment of the present disclosure may vibrate a vehicle interior material 130 to output a sound S.

The vehicle interior material 130 according to an example embodiment of the present disclosure may include one or more materials of metal, wood, rubber, plastic, glass, fiber, cloth, paper, a mirror, leather, and carbon, but example embodiments of the present disclosure are not limited thereto.

The vehicle interior material 130 according to another example embodiment of the present disclosure may include a base member 131 and a surface member 133. For example, the base member 131 may be an injection material, a first interior material, an inner interior material, or a rear interior material, but example embodiments of the present disclosure are not limited thereto. The surface member 133 may be a second interior material, an outer interior material, a front interior material, an outer surface member, a reinforcement member, or a decoration member, but example embodiments of the present disclosure are not limited thereto.

The base member 131 may include a plastic material. The base member 131 according to an example embodiment of the present disclosure may include an injection material. For example, the base member 131 may be an injection material which is implemented by an injection process using a thermoplastic resin or a thermosetting resin, but example embodiments of the present disclosure are not limited thereto. The vehicle interior material 130 or the base member 131 may be configured to cover an inner portion of a vehicle 10. For example, the vehicle interior material 130 or the base member 131 may be configured to cover one or more of the main structure 110 and the exterior material 120 in an interior space IS of the vehicle 10. For example, the vehicle interior material 130 or the base member 131 may be configured to cover one surface (or an inner surface) of one or more of a main frame, a side frame, a door frame, and a handle frame, which are exposed at the interior space IS of the vehicle 10.

The base member 131 may include at least one or more of a planar portion and a curved portion. For example, the base member 131 may have a structure corresponding to a structure (or a rear structure) of a corresponding main structure 110, or may have a structure which differs from a structure of a corresponding main structure 110.

The surface member 133 may be disposed on the base member 131. For example, the surface member 133 may be disposed to cover the base member 131. The surface member 133 may cover the base member 131 at the inner portion or the interior space IS of the vehicle 10 and may be configured to be exposed at the inner portion or the interior space IS of the vehicle 10. For example, the surface member 133 may be disposed in or coupled to a front surface (or an interior surface) of the base member 131 exposed at the interior space IS of the vehicle 10.

The vehicle interior material 130 or the surface member 133 according to an example embodiment of the present disclosure may include one or more materials of plastic, glass, fiber, leather, cloth, rubber, a mirror, wood, paper, carbon, and metal, but example embodiments of the present disclosure are not limited thereto. For example, the surface member 133 may be a fiber material. For example, the surface member 133 including the fiber material may include at least one or more of a synthetic fiber, a carbon fiber (or an aramid fiber), and a natural fiber, but example embodiments of the present disclosure are not limited thereto. For example, the surface member 133 including the fiber material may be a textile sheet, a knit sheet, or a nonwoven fabric, but example embodiments of the present disclosure are not limited thereto. For example, the surface member 133 including the fiber material may be a fabric member, but example embodiments of the present disclosure are not limited thereto.

The synthetic fiber may be a thermoplastic resin and may include a polyolefin-based fiber which is an eco-friendly material which does not relatively release a harmful substance. For example, the polyolefin-based fiber may include a polyethylene fiber, a polypropylene fiber, or a polyethylene terephthalate fiber, but example embodiments of the present disclosure are not limited thereto. The polyolefin-based fiber may be a fiber of a single resin or a fiber of a core-shell structure, but example embodiments of the present disclosure are not limited thereto. The natural fiber may be a composite fiber of one or two or more of a jute fiber, a kenaf fiber, an abaca fiber, a coconut fiber, and a wood fiber, but example embodiments of the present disclosure are not limited thereto.

The sound apparatus 30 may be covered by the vehicle interior material 130. The sound apparatus 30 may be configured to vibrate the vehicle interior material 130 including the base member 131 and the surface member 133 to output a sound S toward the inner portion and/or the interior space IS of the vehicle 10.

The sound apparatus 30 according to another example embodiment of the present disclosure may output the sound S toward the interior space IS of the vehicle 10 using the vehicle interior material 130 as a vibration plate or a sound vibration plate and may output a realistic sound S and/or stereo sound including a multichannel toward the interior space IS of the vehicle 10.

According to another example embodiment of the present disclosure, the sound apparatus 30 may be configured to be surrounded by an enclosure. A space may be provided between the sound apparatus 30 and the enclosure, and a sound (or a sound pressure level) may be output based on a vibration of the vehicle interior material 130 based on air between the sound apparatus 30 and the enclosure. However, there may be a problem where a sound of the low-pitched sound band is not output, and there may be a problem where the flatness of a sound pressure level is reduced because the number of peaks and dips occurring in a reproduction frequency band of a sound (or a sound pressure level) generated based on a vibration of the vehicle interior material 130 increases and each of a highest sound pressure level and a lowest sound pressure level occurring in a reproduction frequency band of a sound (or a sound pressure level) generated based on a vibration of the vehicle interior material 130 increases. The peak may be a phenomenon where a sound pressure level bounces in a specific frequency, and the dip may be a phenomenon where a low sound pressure level is generated as the occurrence of a sound having a specific frequency is reduced. The flatness of a sound characteristic may be a level of a deviation between a highest sound pressure and a lowest sound pressure in a specific frequency.

The inventors of the present disclosure have performed extensive research and experiments for implementing a sound apparatus and a vehicular apparatus including the same, in which a sound characteristic of a sound including a middle-low-pitched sound band may be increased (or improved). Based on the extensive research and experiments, the inventors of the present disclosure have invented a sound apparatus and a vehicular apparatus including the same, which may enhance a sound characteristic of a sound including the middle-low-pitched sound band. This will be described below in detail.

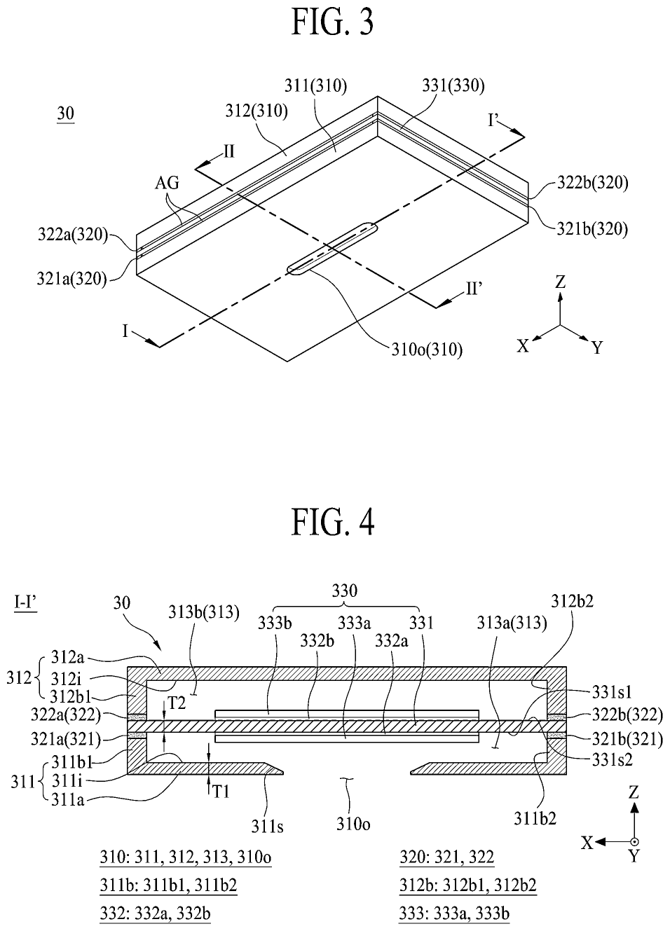

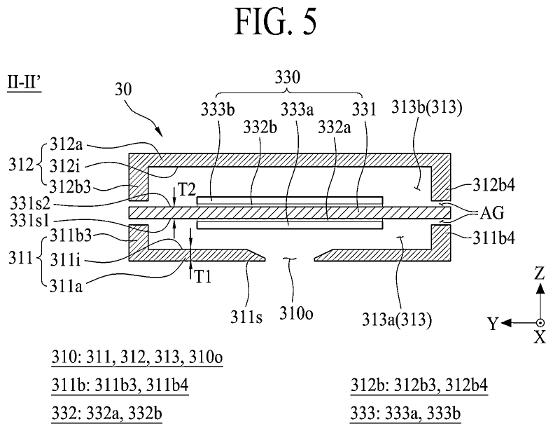

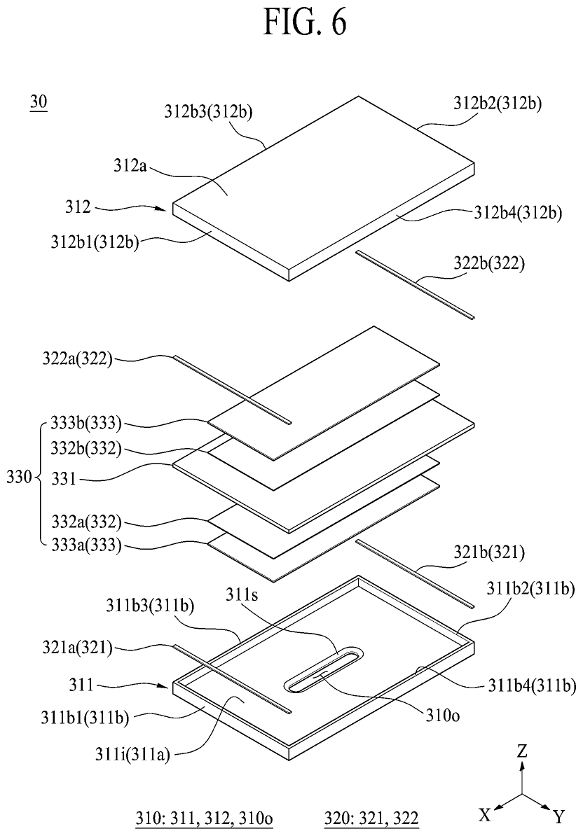

FIG. 3 is a perspective view illustrating a sound apparatus according to an example embodiment of the present disclosure. FIG. 4 is a cross-sectional view taken along line I-I′ illustrated in FIG. 3 according to an example embodiment of the present disclosure. FIG. 5 is a cross-sectional view taken along line II-II′ illustrated in FIG. 3 according to an example embodiment of the present disclosure. FIG. 6 is an exploded perspective view of a sound apparatus according to an example embodiment of the present disclosure.

With reference to FIGS. 3 to 6, the sound apparatus 30 (or a sound apparatus for vehicles) according to an example embodiment of the present disclosure may be configured to vibrate a vibration object or a vehicle structure. For example, the sound apparatus 30 may be a sound generating apparatus, a sound output apparatus, a speaker apparatus, a car audio device, or an audio apparatus, but example embodiments of the present disclosure are not limited thereto.

The sound apparatus 30 may be configured to be connected (or coupled) to the vibration object or the vehicle structure. For example, the sound apparatus 30 may be disposed in (or connected to) a portion of any one of the main structure 110, the exterior material 120, and the interior material 130 illustrated in FIG. 1 or 2 to generate (or output) a sound. For example, the sound apparatus 30 may vibrate any one of the main structure 110, the exterior material 120, and the interior material 130 illustrated in FIG. 1 or 2 to generate (or output) a sound.

The sound apparatus 30 according to an example embodiment of the present disclosure may include an enclosure 310, a sound generating module 330, and a coupling member 320.

The enclosure 310 may be configured to support the sound generating module 330. The enclosure 310 may be configured to surround or cover the sound generating module 330. For example, the enclosure 310 may be configured to support the sound generating module 330 and surround the sound generating module 330. For example, the enclosure 310 may be configured to accommodate (or receive) the sound generating module 330. For example, the enclosure 310 may be a housing, a case, an outer case, a case member, a housing member, a cabinet, a sealing member, a sealing cap, a sealing box, a sound box, or the like, but example embodiments of the present disclosure are not limited thereto.

The enclosure 310 may include a rectangular shape including a long side and a short side, but example embodiments of the present disclosure are not limited thereto. The enclosure 310 may include a rectangular shape having an internal space 313, but example embodiments of the present disclosure are not limited thereto. The internal space 313 may accommodate (or receive) the sound generating module 330. The internal space 313 may be configured to accommodate (or receive) the sound generating module 330. For example, the internal space 313 may be an accommodation space, a receiving space, a gap space, an air space, a vibration space, a sound space, a sound box, or a sealing space, or the like, but example embodiments of the present disclosure are not limited thereto.

The enclosure 310 according to an example embodiment of the present disclosure may include one or more materials of a metal material and a nonmetal material (or a composite nonmetal material), but example embodiments of the present disclosure are not limited thereto. For example, the enclosure 310 may include one or more materials of a metal material, plastic, carbon, and wood, but example embodiments of the present disclosure are not limited thereto. For example, the enclosure 310 may be configured in a metal material such as aluminum (Al) material, or configured in a plastic material such as plastic or styrene material, but example embodiments of the present disclosure are not limited thereto. For example, the styrene material may be an ABS material. The ABS material may be acrylonitrile, butadiene, and styrene.

The enclosure 310 according to an example embodiment of the present disclosure may include one or more enclosures (or enclosure members) 311 and 312. For example, the enclosure 310 may include a first enclosure 311 and a second enclosure 312.

The first enclosure (or a first enclosure member) 311 may be configured at a first surface (or a rear surface or a lower surface) of the sound generating module 330. The first enclosure 311 may be configured to support a portion of the first surface of the sound generating module 330. For example, the first enclosure 311 may be configured to cover the first surface of the sound generating module 330. For example, the first enclosure 311 may be configured to support a portion of an edge portion (or a periphery portion) of the sound generating module 330. For example, the first enclosure 311 may be configured to surround the first surface of the sound generating module 330. For example, the first enclosure 311 may be configured to be connected or coupled to a portion of an edge portion (or a periphery portion) of the first surface of the sound generating module 330. For example, the first enclosure 311 may include a rectangular shape including a long side and a short side, but example embodiments of the present disclosure are not limited thereto.

The first enclosure 311 according to an example embodiment of the present disclosure may include a first plate 311a and a first sidewall portion 311b.

The first plate 311a may be configured (or disposed) to be spaced apart from the sound generating module 330. The first plate 311a may be configured at the first surface of the sound generating module 330. The first plate 311a may be configured to cover the first surface of the sound generating module 330. The first plate 311a may be disposed or configured to be spaced apart from the first surface of the sound generating module 330. For example, the first plate 311a may include a rectangular shape having a long side and a short side, but example embodiments of the present disclosure are not limited thereto. For example, the first plate 311a may include a flat plate structure having a rectangular shape, which includes the long side and the short side, but example embodiments of the present disclosure are not limited thereto.

The first sidewall portion 311b may be configured (or disposed) between the sound generating module 330 and the first plate 311a. For example, the first sidewall portion 311b may be configured (or disposed) along an edge portion (or a periphery portion) of the first plate 311a. For example, the first sidewall portion 311b may be vertically connected to the edge portion of the first plate 311a. For example, the first sidewall portion 311b may be vertically connected to the edge portion (or an inner edge portion or a front edge portion) of the first plate 311a facing the first surface of the sound generating module 330. The first sidewall portion 311b may be configured at the edge portion of the first plate 311a to support a portion of the sound generating module 330. For example, the first sidewall portion 311b may be configured to be connected or coupled to a portion of the edge portion of the sound generating module 330.

The first plate 311a of the first enclosure 311 may be configured to have a first thickness (or height) T1.

The first thickness T1 of the first plate 311a may be a same as or different from a second thickness (or height) T2 of the vibration member 331. For example, the first thickness T1 of the first plate 311a may be thinner than or equal to the second thickness T2 of the vibration member 331, but example embodiments of the present disclosure are not limited thereto. For example, the first thickness T1 of the first plate 311a may be 0.5 mm to 3 mm, but example embodiments of the present disclosure are not limited thereto.

According to an example embodiment of the present disclosure, the amount of displacement (or bending force) or an amplitude displacement (or vibration width) of the first enclosure 311 (or the first plate 311a) based on a vibration of the sound generating module 330 may increase as the first thickness T1 of the first plate 311a is thinner. For example, the flexibility of the first plate 311a may increase as the first thickness T1 is thinner, and the amount of displacement (or bending force) or an amplitude displacement (or vibration width) of the first plate 311a may increase as the flexibility of the first plate 311a increases, and thus, a sound characteristic and/or a sound pressure level characteristic of a low-pitched sound band generated based on a vibration (or displacement) of the first enclosure 311 (or the first plate 311a) based on a vibration of the sound generating module 330 may be increased (or enhanced). For example, when the first plate 311a has the first thickness T1 of 0.5 mm to 3 mm, a sound characteristic and/or a sound pressure level characteristic in a pitched sound band of 300 Hz or less may be increased (or enhanced).

The first sidewall portion 311b may be configured (or disposed) along the edge portion of the first plate 311a and may be configured to provide a space 313a between the sound generating module 330 and the first plate 311a. For example, the first sidewall portion 311b may be disposed a region between the first surface of the sound generating module 330 and the first plate 311a. The first sidewall portion 311b may provide a space 313a on an inner surface 311i of the first enclosure 311 or an inner surface 311i of the first plate 311a. Accordingly, the first surface of the sound generating module 330 may be spaced apart from the inner surface 311i of the first plate 311a by the first sidewall portion 311b.

The first sidewall portion 311b according to an example embodiment of the present disclosure may include first to fourth sidewalls 311b1, 311b2, 311b3, and 311b4.

Each of the first sidewall 311b1 and the second sidewall 311b2 of the first sidewall portion 311b may be configured to be parallel to a first direction X. Each of the first sidewall 311b1 and the second sidewall 311b2 may be configured in parallel with the short side of the enclosure 310 or the short side of the first plate 311a.

According to an example embodiment of the present disclosure, the first sidewall 311b1 of the first sidewall portion 311b may be connected to a first edge portion of the first plate 311a in parallel with the short side of the enclosure 310 or the short side of the first plate 311a. For example, the first sidewall 311b1 may be connected to the first edge portion, which is adjacent to a first short side, of the first plate 311a. For example, the first sidewall 311b1 may be vertically connected to the first edge portion of the first plate 311a.

According to an example embodiment of the present disclosure, the second sidewall 311b2 of the first sidewall portion 311b may be connected to a second edge portion of the first plate 311a in parallel with the short side of the enclosure 310 or the short side of the first plate 311a. For example, the second sidewall 311b2 may be connected to the second edge portion, which is adjacent to a second short side, of the first plate 311a. For example, the second sidewall 311b2 may be vertically connected to the second edge portion of the first plate 311a.

Each of the third sidewall 311b3 and the fourth sidewall 311b4 of the first sidewall portion 311b may be configured to be parallel to a second direction Y. Each of the third sidewall 311b3 and the fourth sidewall 311b4 may be configured in parallel with the long side of the enclosure 310 or the long side of the first plate 311a.

According to an example embodiment of the present disclosure, the third sidewall 311b3 of the first sidewall portion 311b may be connected to a third edge portion of the first plate 311a in parallel with the long side of the enclosure 310 or the long side of the first plate 311a. For example, the third sidewall 311b3 may be connected to the third edge portion, which is adjacent to a first long side, of the first plate 311a. For example, the third sidewall 311b3 may be vertically connected to the third edge portion of the first plate 311a. For example, a first lateral surface (or first end) of the third sidewall 311b3 may be connected to a first lateral surface (or first end) of the first sidewall 311b1. A second lateral surface (or second end), which is opposite to the first lateral surface, of the third sidewall 311b3 may be connected to a first lateral surface (or first end) of the second sidewall 311b2.

According to an example embodiment of the present disclosure, the fourth sidewall 311b4 of the first sidewall portion 311b may be connected to a fourth edge portion of the first plate 311a in parallel with the long side of the enclosure 310 or the long side of the first plate 311a. For example, the fourth sidewall 311b4 may be connected to the fourth edge portion, which is adjacent to a second long side, of the first plate 311a. For example, the fourth sidewall 311b4 may be vertically connected to the fourth edge portion of the first plate 311a. For example, a first lateral surface (or first end) of the fourth sidewall 311b4 may be connected to the second lateral surface (or second end), which is opposite to the first lateral surface, of the first sidewall 311b1. A second lateral surface (or second end), which is opposite to the first lateral surface, of the fourth sidewall 311b4 may be connected to a second lateral surface (or second end), which is opposite to the first lateral surface of the second sidewall 311b2.

The second enclosure 312 (or second enclosure member) may be configured in a second surface (or front surface or upper surface), which is opposite to the first surface, of the sound generating module 330. For example, the second enclosure 312 may be configured to cover the second surface of the sound generating module 330. For example, the second enclosure 312 may be configured to support a portion of the edge portion of the sound generating module 330. For example, the second enclosure 312 may be configured to surround the second surface of the sound generating module 330. For example, the second enclosure 312 may be configured to be connected or coupled to a portion of an edge portion of the second surface of the sound generating module 330. For example, the second enclosure 312 may include a rectangular shape including a long side and a short side, but example embodiments of the present disclosure are not limited thereto.

The second enclosure 312 according to an example embodiment of the present disclosure may include a second plate 312a and a second sidewall portion 312b.

The second plate 312a may be configured to be spaced apart from the sound generating module 330. The second plate 312a may be configured at the second surface of the sound generating module 330. The second plate 312a may be configured to cover the second surface of the sound generating module 330. The second plate 312a may be disposed or configured to be spaced apart from the second surface of the sound generating module 330. For example, the second plate 312a may include a flat plate structure having a rectangular shape, which includes a long side and a short side, but example embodiments of the present disclosure are not limited thereto.

The second sidewall portion 312b may be configured (or disposed) along an edge portion (or a periphery portion) of the second plate 312a. For example, the second sidewall portion 312b may be vertically connected to the edge portion of the second plate 312a. For example, the second sidewall portion 312b may be vertically connected to the edge portion (or an inner edge portion or a rear edge portion) of the second plate 312a facing the second surface of the sound generating module 330. For example, the second sidewall portion 312b may be configured to be connected or coupled to a portion of the edge portion of the sound generating module 330.

The second sidewall portion 312b may be disposed between the second surface of the sound generating module 330 and the second plate 312a. The second sidewall portion 312b may provide a space 313b on an inner surface 312i of the second enclosure 312 or an inner surface 312i of the second plate 312a. Accordingly, the second surface of the sound generating module 330 may be spaced apart from the inner surface 312i of the second plate 312a by the second sidewall portion 312b.

The second sidewall portion 312b according to an example embodiment of the present disclosure may include first to fourth sidewalls 312b1, 312b2, 312b3, and 312b4.

Each of the first sidewall 312b1 and the second sidewall 312b2 of the second sidewall portion 312b may be configured to be parallel to the first direction X. Each of the first sidewall 312b1 and the second sidewall 312b2 may be configured in parallel with the short side of the enclosure 310 or the short side of the second plate 312a.

According to an example embodiment of the present disclosure, the first sidewall 312b1 of the second sidewall portion 312b may be connected to a first edge portion of the second plate 312a in parallel with the short side of the enclosure 310 or the short side of the second plate 312a. For example, the first sidewall 312b1 may be connected to the first edge portion, which is adjacent to a first short side, of the second plate 312a. For example, the first sidewall 312b1 may be vertically connected to the first edge portion of the second plate 312a. For example, the first sidewall 312b1 of the second sidewall portion 312b may overlap the first sidewall 311b1 of the first sidewall portion 311b.

According to an example embodiment of the present disclosure, the second sidewall 312b2 of the second sidewall portion 312b may be connected to a second edge portion of the second plate 312a in parallel with the short side of the enclosure 310 or the short side of the second plate 312a. For example, the second sidewall 312b2 may be connected to the second edge portion, which is adjacent to a second short side, of the second plate 312a. For example, the second sidewall 312b2 may be vertically connected to the second edge portion of the second plate 312a. For example, the second sidewall 312b2 of the second sidewall portion 312b may overlap the second sidewall 311b2 of the first sidewall portion 311b.

Each of the third sidewall 312b3 and the fourth sidewall 312b4 of the second sidewall portion 312b may be configured to be parallel to the second direction Y. Each of the third sidewall 311b3 and the fourth sidewall 311b4 may be configured in parallel with the long side of the enclosure 310 or the long side of the second plate 312a.

According to an example embodiment of the present disclosure, the third sidewall 311b3 of the second sidewall portion 312b may be connected to a third edge portion of the second plate 312a in parallel with the long side of the enclosure 310 or the long side of the second plate 312a. For example, the third sidewall 311b3 may be connected to the third edge portion, which is adjacent to a first long side, of the second plate 312a. For example, the third sidewall 311b3 may be vertically connected to the third edge portion of the second plate 312a. For example, a first lateral surface (or first end) of the third sidewall 312b3 may be connected to a first lateral surface (or first end) of the first sidewall 312b1. A second lateral surface (or second end), which is opposite to the first lateral surface, of the third sidewall 312b3 may be connected to a first lateral surface (or first end) of the second sidewall 312b2. For example, the third sidewall 312b3 of the second sidewall portion 312b may overlap the third sidewall 311b3 of the first sidewall portion 311b.

According to an example embodiment of the present disclosure, the fourth sidewall 312b4 of the second sidewall portion 312b may be connected to a fourth edge portion of the second plate 312a in parallel with the long side of the enclosure 310 or the long side of the second plate 312a. For example, the fourth sidewall 312b4 may be connected to the fourth edge portion, which is adjacent to a second long side, of the second plate 312a. For example, the fourth sidewall 312b4 may be vertically connected to the fourth edge portion of the second plate 312a. For example, a first lateral surface (or first end) of the fourth sidewall 312b4 may be connected to the second lateral surface (or second end), which is opposite to the first lateral surface, of the first sidewall 312b1. A second lateral surface (or second end), which is opposite to the first lateral surface, of the fourth sidewall 312b4 may be connected to a second lateral surface (or second end), which is opposite to the first lateral surface of the second sidewall 312b2. For example, the fourth sidewall 312b4 of the second sidewall portion 312b may overlap the fourth sidewall 311b4 of the first sidewall portion 311b.

According to an example embodiment of the present disclosure, the internal space 313 of the enclosure 310 may be between the first enclosure 311 and the second enclosure 312. For example, the internal space 313 of the enclosure 310 may be provided at a region between the first enclosure 311 and the sound generating module 330, and may be provided at a region between the second enclosure 312 and the sound generating module 330.

According to an example embodiment of the present disclosure, the internal space 313 of the enclosure 310 may include a first space 313a and a second space 313b.

The first space 313a and the second space 313b may be spatially separated from each other by the sound generating module 330, but example embodiments of the present disclosure are not limited thereto.

The first space 313a may include a space which is provided between the first enclosure 311 and the sound generating module 330. For example, the first space 313a may include a space which is provided between the first enclosure 311 and the first surface of the sound generating module 330. For example, the first space 313a may include a space which is provided between the inner surface 311i of the first plate 311a and the first surface of the sound generating module 330 by the first sidewall portion 311b of the first enclosure 311.

The second space 313b may include a space which is provided between the second enclosure 312 and the sound generating module 330. For example, the second space 313b may include a space which is provided between the second enclosure 312 and the second surface of the sound generating module 330. For example, the second space 313b may include a space which is provided between the inner surface 312i of the second plate 312a and the second surface of the sound generating module 330 by the second sidewall portion 312b of the second enclosure 312.

The sound generating module 330 may be configured to be accommodated (or received) into the internal space 313 of the enclosure 310. The sound generating module 330 may be configured to generate a sound (or a sound pressure level or a sound wave) in the internal space 313 of the enclosure 310. For example, the sound generating module 330 may be a sound generating apparatus, a sound generating unit, a sound generating member, a sound reproduction module, a sound reproduction unit, a car audio module, a car audio unit, a speaker module, or a speaker unit, but example embodiments of the present disclosure are not limited thereto.

The sound generating module 330 according to an example embodiment of the present disclosure may be configured to generate or output a sound (or a sound wave) or a vibration. For example, the sound generating module 330 may be configured to output the sound (or sound wave) or the vibration toward an interior space of a vehicle, based on driving (or vibration or displacement). For example, the sound (or sound wave) or the vibration generated based on driving (or vibration) of the sound generating module 330 may be directly output to the interior space of the vehicle.

The sound generating module 330 according to another example embodiment of the present disclosure may generate a sound, based on a vibration of a vibration object or a vehicle structure. For example, the sound generating module 330 may be configured to vibrate the vehicle interior material. For example, the sound generating module 330 may generate or output a sound (or a sound wave) or a vibration, based on a vibration (or displacement) of the vehicle interior material. For example, the sound (or sound wave) generated based on driving (or vibration or displacement) of the sound generating module 330 may vibrate the vehicle interior material, and a sound (or a sound wave) or a vibration generated based on a vibration of the vehicle interior material may be directly output to the interior space of the vehicle.

The sound generating module 330 according to another example embodiment of the present disclosure may generate a sound, based on a vibration of the enclosure 310 and the vibration object (or the vehicle structure). For example, the sound generating module 330 may be configured to vibrate or indirectly vibrate the enclosure 310 and the vibration object (or the vehicle structure). For example, the sound generating module 330 may generate or output a sound or a vibration, based on a vibration (or displacement) of the enclosure 310 and the vehicle interior material. For example, a sound (or a sound wave) generated in the internal space 313 of the enclosure 310 based on driving (or vibration or displacement) of the sound generating module 330 may vibrate the enclosure 310, a vibration of the enclosure 310 may vibrate the vehicle interior material, and a sound or a vibration generated based on a vibration of the vehicle interior material may be output to the interior space of the vehicle.

According to another example embodiment of the present disclosure, a portion of a sound (or a sound wave or a vibration) generated in the internal space 313 of the enclosure 310 based on driving (or vibration or displacement) of the sound generating module 330 may be directly output to the interior space of the vehicle, and the other of the sound (or the sound wave or the vibration) generated or output based on driving (or vibration or displacement) of the sound generating module 330 may vibrate one or more of the enclosure 310 and the vehicle interior material. A sound (or a sound wave) or a vibration generated by the vibration of the vehicle interior material based on the vibration of one or more of the enclosure 310 and the vehicle interior material may be output to the interior space of the vehicle.

The sound generating module 330 according to an example embodiment of the present disclosure may include a vibration member 331 and a vibration apparatus 333.

The vibration member 331 may generate a vibration or may output a sound (or a sound wave or a sound pressure level) based on the driving (or vibration) of the vibration apparatus 333. For example, the vibration member 331 may be a diaphragm, a vibration plate, a vibration substrate, a vibration panel, a sound plate, a sound panel, a passive vibration plate, a passive vibration member, a passive vibration panel, a sound output plate, or a sound vibration plate, but example embodiments of the present disclosure are not limited thereto.

The vibration member 331 may include a single nonmetal material or a composite nonmetal material, but example embodiments of the present disclosure are not limited thereto. For example, the single nonmetal material or the composite nonmetal material of the vibration member 331 may include one or more materials of wood, rubber, plastic, carbon, glass, fiber, cloth, paper, mirror, and leather, but example embodiments of the present disclosure are not limited thereto. For example, the paper may be cone paper for speakers. For example, the cone paper may be pulp or foamed plastic, or the like, but example embodiments of the present disclosure are not limited thereto. For example, the vibration member 331 may be configured in a same material as that of the enclosure 310 or may be configured in a different material from the enclosure 310.

The vibration member 331 according to an example embodiment of the present disclosure may be configured in a plastic material such as plastic material or styrene material, but example embodiments of the present disclosure are not limited thereto.

The plastic material of the vibration member 331 may be configured in polyethylene terephthalate, polycarbonate, polyimide, polypropylene, polyarylate, polyethersulfone, polyethylene naphthalate, polysulfone, cyclo-olefin copolymer, or carbon fiber reinforced plastic (CFRP), or the like, but example embodiments of the present disclosure are not limited thereto.

The styrene material of the vibration member 331 may be an ABS material. The ABS material may be acrylonitrile, butadiene, and styrene.

The vibration member 331 according to an example embodiment of the present disclosure may include a porous material. For example, the vibration member 331 may include a micro cellular plastic material. For example, the vibration member 331 may be configured in a polyethylene terephthalate material or a polycarbonate material. For example, the vibration member 331 may be configured in a Micro Cellular polyethylene terephthalate (MCPET) material. The vibration member 331 configured in the MCPET may have capability to reproduce a high original sound because having a low density and an excellent elastic force, thereby enhancing the quality of a sound.

According to an example embodiment of the present disclosure, the vibration member 331 may include a tetragonal shape, but example embodiments of the present disclosure are not limited thereto. For example, the vibration member 331 may have a rectangular shape including a long side and a short side, but example embodiments of the present disclosure are not limited thereto. For example, the vibration member 331 may include a first surface 331s1 and a second surface 331s2 different from (or opposite to) the first surface 331s1. For example, in the vibration member 331, the first surface 331s1 may be a rear surface, a backside surface, or a lower surface, and the second surface 331s2 may be a front surface or an upper surface. For example, the first surface 331s1 of the vibration member 331 may correspond to the first surface of the sound generation module 330. For example, the second surface 331s2 of the vibration member 331 may correspond to the second surface of the sound generation module 330.

The vibration member 331 may be at a periphery of the enclosure 310. The vibration member 331 may be partially supported by the enclosure 310. The vibration member 331 may be partially supported by the first enclosure 311 and the second enclosure 312 of the enclosure 310. For example, the vibration member 331 may be partially supported by the first enclosure 311. The vibration member 331 may be disposed or configured between the first enclosure 311 and the second enclosure 312. The vibration member 331 may be configured to separate (or divide) the internal space 313 of the enclosure 310 into the first space 313a and the second space 313b. For example, the internal space 313 of the enclosure 310 may be separated into the first space 313a and the second space 313b by the vibration member 331. For example, the first space 313a of the internal space 313 may be provided between the first enclosure 311 and the vibration member 331 and may be covered by the vibration member 331. The second space 313b of the internal space 313 may be provided between the second enclosure 312 and the vibration member 331.

The vibration apparatus 333 may be configured to vibrate (or displace) the vibration member 331. For example, the vibration apparatus 333 may be configured to vibrate (or displace or drive) based on a driving signal (or a vibration driving signal or a voice signal) applied thereto to vibrate (or displace or drive) the vibration member 331.

The vibration apparatus 333 may correspond to the vibration member 331, or have a same shape as that of the vibration member 331, but example embodiments of the present disclosure are not limited thereto. For example, the vibration apparatus 333 may have a different shape from the vibration member 331. For example, the vibration apparatus 333 may include a rectangular shape or a square shape, but example embodiments of the present disclosure are not limited thereto. For example, the vibration apparatus 333 may include a size which is smaller than that of the vibration member 331, but example embodiments of the present disclosure are not limited thereto.

The vibration apparatus 333 may be disposed or configured at the internal space 313 of the enclosure 310 to vibrate (or displace) the vibration member 331. The vibration apparatus 333 may be disposed or configured at the vibration member 331. For example, the vibration apparatus 333 may be disposed or configured at one or more of the first surface and the second surface of the vibration member 331. For example, the sound generating module 330 may include a plurality of vibration apparatuses 333. For example, the plurality of vibration apparatuses 333 may be disposed or configured at one or more of the first surface and the second surface of the vibration member 331. For example, the plurality of vibration apparatuses 333 may be disposed or configured at each of the first surface and the second surface of the vibration member 331 with the vibration member 331 therebetween.

The sound generating module 330 or the vibration apparatus 333 according to an example embodiment of the present disclosure may include a first vibration apparatus 333a and a second vibration apparatus 333b.

The first vibration apparatus 333a and the second vibration apparatus 333b may be configured at the vibration member 331. For example, the first vibration apparatus 333a and the second vibration apparatus 333b may be disposed with the vibration member 331 therebetween. For example, the first vibration apparatus 333a may be disposed or configured at the first surface of the vibration member 331, and the second vibration apparatus 333b may be disposed or configured at the second surface of the vibration member 331. For example, the second vibration apparatus 333b may be disposed or configured at the second surface, which is opposite to the first surface, of the vibration member 331.

According to an example embodiment of the present disclosure, a long side of each of the first vibration apparatus 333a and the second vibration apparatus 333b may be parallel to the long side of the vibration member 331 and may be spaced apart from the long side of the vibration member 331. For example, each of the first vibration apparatus 333a and the second vibration apparatus 333b may have a size which is smaller than that of the vibration member 331, but example embodiments of the present disclosure are not limited thereto.

The first vibration apparatus 333a and the second vibration apparatus 333b may vibrate (or displace or drive) based on a driving signal (or a vibration driving signal or a voice signal) applied thereto to vibrate (or displace or drive) the vibration member 331. The vibration member 331 may generate a vibration or may output a sound (or a sound wave), based on the displacements (or driving) of each of the first vibration apparatus 333a and the second vibration apparatus 333b.

According to an example embodiment of the present disclosure, the driving signals (or the vibration driving signals or the voice signals) applied to the first vibration apparatus 333a and the second vibration apparatus 333b may be a same or different. For example, the driving signals applied to the first vibration apparatus 333a and the second vibration apparatus 333b may have a same phase or different phases. For example, the first vibration apparatus 333a and the second vibration apparatus 333b may have a bimorph structure which are disposed with the vibration member 331 therebetween. Each of the first vibration apparatus 333a and the second vibration apparatus 333b may independently vibrate the vibration member 331, and thus, an influence thereof on a sound characteristic based on a material and a characteristic of the vibration member 331 may be reduced. Accordingly, in the sound apparatus 30, a sound characteristic and/or a sound pressure level characteristic of a pitched sound band including the low-pitched sound band may be enhanced by the bimorph structure of the vibration apparatus 333.

According to another example embodiment of the present disclosure, the first vibration apparatus 333a and the second vibration apparatus 333b may be configured at any one of the first surface and the second surface of the vibration member 331. For example, the first vibration apparatus 333a may be configured at any one of the first surface and the second surface of the vibration member 331. For example, the first vibration apparatus 333a may be connected to or configured at the first surface of the vibration member 331. For example, the second vibration apparatus 333b may be connected to or stacked on the first vibration apparatus 333a.

The sound apparatus 30 or the sound generating module 330 according to an example embodiment of the present disclosure may further include an adhesive member 332. For example, the vibration apparatus 333 or each of the first vibration apparatus 333a and the second vibration apparatus 333b may be connected or coupled to the vibration member 331 by the adhesive member 332.

The adhesive member 332 according to an example embodiment of the present disclosure may include a first adhesive member 332a and a second adhesive member 332b.

The first adhesive member 332a may be disposed (or interposed) between the vibration member 331 and the first vibration apparatus 333a. The first vibration apparatus 333a may be connected or coupled to the vibration member 331 by the first adhesive member 332a. For example, the first vibration apparatus 333a may be connected or coupled to the first surface of the vibration member 331 by the first adhesive member 332a.

The second adhesive member 332b may be disposed (or interposed) between the vibration member 331 and the second vibration apparatus 333b. The second vibration apparatus 333b may be connected or coupled to the vibration member 331 by the second adhesive member 332b. For example, the second vibration apparatus 333b may be connected or coupled to the second surface of the vibration member 331 by the second adhesive member 332b.

The adhesive member 332, or the first adhesive member 332a and the second adhesive member 332b may include an adhesive layer (or a tacky layer) which is good in adhesive force or attaching force. For example, the adhesive member 332, or the first adhesive member 332a and the second adhesive member 332b may include a same or different adhesive layers (or tacky layers). For example, the adhesive member 332, or the first adhesive member 332a and the second adhesive member 332b may include an adhesive, a double-sided adhesive, a double-sided tape, a double-sided adhesive tape, a double-sided adhesive foam tape, a double-sided pad, a double-sided foam pad, a double-sided adhesive foam pad, a double-sided cushion tape, or a tacky sheet, but example embodiments of the present disclosure are not limited thereto.

The coupling member 320 may be partially between the sound generating module 330 and the enclosure 310. For example, the coupling member 320 may be partially between an edge portion of the sound generating module 330 and the enclosure 310. For example, the edge portion of the sound generating module 330 may be partially connected or coupled to the enclosure 310 by the coupling member 320. For example, the sound apparatus 30 according to an example embodiment of the present disclosure may further include an air gap which is partially provided between the edge portion of the sound generating module 330 and the enclosure 310. For example, the coupling member 320 may be partially between the edge portion of the sound generating module 330 and the enclosure 310 to include the air gap between the edge portion of the sound generating module 330 and the enclosure 310. For example, the air gap may be in at least a portion of a region between the edge portion, which is adjacent to the long side, of the enclosure 310 and the sound generating module 330.

The coupling member 320 according to an example embodiment of the present disclosure may be configured to partially connect or couple the enclosure 310 to the vibration member 331 of the sound generating module 330. For example, the coupling member 320 may be partially in a region between the vibration member 331 and the enclosure 310. For example, the coupling member 320 may be a portion of the region between the enclosure 310 and the vibration member 331. For example, the coupling member 320 may be disposed (or interposed) in a portion region of a region between the edge portion of the vibration member 331 and the enclosure 310. For example, the coupling member 320 may be partially disposed (or interposed) in the region between the edge portion of the vibration member 331 and the enclosure 310.

The sound apparatus 30 according to an example embodiment of the present disclosure may include an air gap which is partially provided between the enclosure 310 and the vibration member 331. For example, the sound apparatus 30 may include the air gap which is partially provided between the enclosure 310 and the vibration member 331 by the coupling member 320. For example, the coupling member 320 may be partially disposed (or interposed) in a region between the vibration member 331 and the enclosure 310 to include (or allow) the air gap between the vibration member 331 and the enclosure 310. For example, the coupling member 320 may be partially disposed (or interposed) in a region between the edge portion of the vibration member 331 and the enclosure 310 to include (or allow) the air gap between the edge portion of the vibration member 331 and the enclosure 310. For example, the air gap may be in at least a portion of the region between the edge portion, which is adjacent to the long side, of the enclosure 310 and the sound generating module 330.

The coupling member 320 according to an example embodiment of the present disclosure may be configured to enhance a sound characteristic and/or a sound pressure level characteristic of a middle-low pitched sound band generated based on a vibration of the vibration member 331. For example, the coupling member 320 may be configured to increase or maximize the amount of displacement (or bending force) or amplitude displacement (or vibration width) of the vibration member 331. For example, the coupling member 320 may be configured (or disposed) not to hinder (or restrain) a vibration (or displacement) at a center portion including a center of the vibration member 331 when the vibration member 331 is vibrating (or displace) based on a vibration of the vibration apparatus 333. For example, the coupling member 320 may be configured (or disposed) not to hinder (or restrain) a vibration (or displacement) of the vibration member 331 in a long-side length direction of the vibration member 331.

The coupling member 320 according to an example embodiment of the present disclosure may be disposed (or interposed) between the enclosure 310 and an edge portion (or a short side edge portion), which is adjacent to a short side, of the vibration member 331. For example, the coupling member 320 may be disposed (or interposed) in a region between the enclosure 310 and both edge portions, which are adjacent to the short side, of the vibration member 331. For example, the coupling member 320 may be disposed (or interposed) in a region between the enclosure 310 and each of the first and second edge portions, which are adjacent to the short side, of the vibration member 331. For example, the coupling member 320 may be disposed (or interposed) over an entire region (or without an air gap) between the enclosure 310 and each of first and second edge portions of the vibration member 331.

The coupling member 320 according to an example embodiment of the present disclosure may not be disposed (or interposed) between the enclosure 310 and an edge portion (or a long side edge portion), which is adjacent to a long side, of the vibration member 331. For example, the coupling member 320 may not be disposed (or interposed) between the enclosure 310 and both edge portions, which are adjacent to the long side, of the vibration member 331. For example, the coupling member 320 may not be disposed (or interposed) in a region between the enclosure 310 and each of third and fourth edge portions, which are adjacent to the long side, of the vibration member 331. Therefore, an air gap AG may be provided in a region between the enclosure 310 and each of the third and fourth edge portions of the vibration member 331. For example, the third and fourth edge portions of the vibration member 331 may be freely vibrated (or displaced) without being hindered (or restrained) by the coupling member 320 or the enclosure 310 due to the air gap AG. Accordingly, the amount of displacement (or bending force) or the amplitude displacement (or vibration width) of the vibration member 331 in a long-side length direction of the vibration member 331 may increase or be maximized, and thus, a sound characteristic and/or a sound pressure level characteristic of a middle-low pitched sound band generated based on a vibration of the vibration member 331 based on a vibration (or displacement) of the vibration apparatus 333 may be increased (or enhanced).

The coupling member (or joint member) 320 according to an example embodiment of the present disclosure may include a first coupling member (or first joint member) 321 and a second coupling member (or second joint member) 322.

The first coupling member 321 may be partially between the vibration member 331 and the first enclosure 311. The first coupling member 321 may be partially between the edge portion of the vibration member 331 and the first sidewall portion 311b of the first enclosure 311. For example, the first sidewall portion 311b of the first enclosure 311 may be partially connected or coupled to a first surface of the vibration member 331 by the first coupling member 321. For example, the first sidewall portion 311b of the first enclosure 311 may be partially connected or coupled to an edge portion of the first surface of the vibration member 331 by the first coupling member 321.

The first coupling member 321 according to an example embodiment of the present disclosure may be disposed (or interposed) in a region between the first enclosure 311 and both edge portions, which are adjacent to the short side, of the vibration member 331. For example, the first coupling member 321 may be disposed (or interposed) in a region between the first enclosure 311 and each of the first and second edge portions, which are adjacent to the short side, of the vibration member 331. For example, the first coupling member 321 may be disposed (or interposed) over an entire region (or without an air gap) between the first enclosure 311 and each of first and second edge portions of the vibration member 331.

The first coupling member 321 according to an example embodiment of the present disclosure may include a first side coupling member 321a and a second side coupling member 321b.

The first side coupling member 321a of the first coupling member 321 may be configured to couple the vibration member 331 to a first edge portion of the first enclosure 311 adjacent to a first short side of the first enclosure 311. For example, the first side coupling member 321a may be disposed (or interposed) in a region between the first sidewall 311b1 of the first sidewall portion 311b in the first enclosure 311 and a first rear edge portion of the vibration member 331. For example, the first side coupling member 321a may be disposed (or interposed) in an entire region between the first sidewall 311b1 of the first sidewall portion 311b and the first rear edge portion of the vibration member 331. For example, the first side coupling member 321a may be disposed (or interposed) over the entire region (or without an air gap) between the first sidewall 311b1 of the first sidewall portion 311b and the first rear edge portion of the vibration member 331. Therefore, the entire first rear edge portion of the vibration member 331 may be coupled (or fixed) to the first sidewall portion 311b of the first enclosure 311 or the first sidewall 311b1 of the first sidewall portion 311b by the first side coupling member 321a. For example, the first side coupling member 321a may be a 1-1^{th} coupling member, a first edge coupling member, a first lower coupling member, a first lower edge coupling member, a first left coupling member, a first lower fixing member, a first lower edge fixing member, or a first left fixing member, but example embodiments of the present disclosure are not limited thereto.

The second side coupling member 321b of the first coupling member 321 may be configured to couple the vibration member 331 to a second edge portion of the first enclosure 311 adjacent to a second short side of the first enclosure 311. For example, the second side coupling member 321b may be disposed (or interposed) in a region between the second sidewall 311b2 of the first sidewall portion 311b in the first enclosure 311 and a second rear edge portion of the vibration member 331. For example, the second side coupling member 321b may be disposed (or interposed) in an entire region between the second sidewall 311b2 of the first sidewall portion 311b and the second rear edge portion of the vibration member 331. For example, the second side coupling member 321b may be disposed (or interposed) over the entire region (or without an air gap) between the second sidewall 311b2 of the first sidewall portion 311b and the second rear edge portion of the vibration member 331. Therefore, the entire second rear edge portion of the vibration member 331 may be coupled (or fixed) to the first sidewall portion 311b of the first enclosure 311 or the second sidewall 311b2 of the first sidewall portion 311b by the second side coupling member 321b. For example, the second side coupling member 321b may be a 1-2^{th} coupling member, a second edge coupling member, a second lower coupling member, a second lower edge coupling member, a first right coupling member, a second lower fixing member, a second lower edge fixing member, or a first right fixing member, but example embodiments of the present disclosure are not limited thereto.

The second coupling member 322 may be partially between the vibration member 331 and the second enclosure 312. The second coupling member 322 may be partially between the edge portion of the vibration member 331 and the second sidewall portion 312b of the second enclosure 312. For example, the second sidewall portion 312b of the second enclosure 312 may be partially connected or coupled to a second surface of the vibration member 331 by the second coupling member 322. For example, the second sidewall portion 312b of the second enclosure 312 may be partially connected or coupled to an edge portion of the second surface of the vibration member 331 by the second coupling member 322.

The second coupling member 322 according to an example embodiment of the present disclosure may be disposed (or interposed) in a region between the second enclosure 312 and both edge portions, which are adjacent to the short side, of the vibration member 331. For example, the second coupling member 322 may be disposed (or interposed) in a region between the second enclosure 312 and each of the first and second edge portions, which are adjacent to the short side, of the vibration member 331. For example, the second coupling member 322 may be disposed (or interposed) over an entire region (or without an air gap) between the second enclosure 312 and each of first and second edge portions of the vibration member 331.

The second coupling member 322 according to an example embodiment of the present disclosure may include a first side coupling member 322a and a second side coupling member 322b.

The first side coupling member 322a of the second coupling member 322 may be configured to couple the vibration member 331 to a first edge portion of the second enclosure 312 adjacent to a first short side of the second enclosure 312. For example, the first side coupling member 322a may be disposed (or interposed) in a region between the first sidewall 312b1 of the second sidewall portion 312b in the second enclosure 312 and a first front edge portion of the vibration member 331. For example, the first side coupling member 322a may be disposed (or interposed) in an entire region between the first sidewall 312b1 of the second sidewall portion 312b and the first front edge portion of the vibration member 331. For example, the first side coupling member 322a may be disposed (or interposed) over the entire region (or without an air gap) between the first sidewall 312b1 of the second sidewall portion 312b and the first front edge portion of the vibration member 331. Therefore, the entire first front edge portion of the vibration member 331 may be coupled (or fixed) to the second sidewall portion 312b of the second enclosure 312 or the first sidewall 312b1 of the second sidewall portion 312b by the first side coupling member 322a. For example, the first side coupling member 322a may be a 2-1^{th} coupling member, a first edge coupling member, a first upper coupling member, a first upper edge coupling member, a second left coupling member, a first upper fixing member, a first upper edge fixing member, or a second left fixing member, but example embodiments of the present disclosure are not limited thereto.

The second side coupling member 322b of the second coupling member 322 may be configured to couple the vibration member 331 to a second edge portion of the second enclosure 312 adjacent to a second short side of the second enclosure 312. For example, the second side coupling member 322b may be disposed (or interposed) in a region between the second sidewall 312b2 of the second sidewall portion 312b in the second enclosure 312 and a second front edge portion of the vibration member 331. For example, the second side coupling member 322b may be disposed (or interposed) in an entire region between the second sidewall 312b2 of the second sidewall portion 312b and the second front edge portion of the vibration member 331. For example, the second side coupling member 322b may be disposed (or interposed) over the entire region (or without an air gap) between the second sidewall 312b2 of the second sidewall portion 312b and the second front edge portion of the vibration member 331. Therefore, the entire second front edge portion of the vibration member 331 may be coupled (or fixed) to the second sidewall portion 312b of the second enclosure 312 or the second sidewall 312b2 of the second sidewall portion 312b by the second side coupling member 322b. For example, the second side coupling member 322b may be a 2-2^{th} coupling member, a second edge coupling member, a second upper coupling member, a second upper edge coupling member, a second right coupling member, a second upper fixing member, a second upper edge fixing member, or a second right fixing member, but example embodiments of the present disclosure are not limited thereto.

According to an example embodiment of the present disclosure, the first coupling member 321 may not be disposed (or interposed) in a region between the first enclosure 311 and each of third and fourth rear edge portions of the vibration member 331. For example, the first coupling member 321 may not be disposed (or interposed) in a region between the first sidewall portion 311b of the first enclosure 311 and each of the third and fourth rear edge portions of the vibration member 331. For example, the first coupling member 321 may not be disposed (or interposed) in a region between the third sidewall 311b3 of the first sidewall portion 311b and the third rear edge portion of the vibration member 331, and may not be disposed (or interposed) in a region between the fourth sidewall 311b4 of the first sidewall portion 311b and the fourth rear edge portion of the vibration member 331. Therefore, an air gap (or a first air gap or a lower air gap) AG may be provided in a region between the first enclosure 311 and each of the third and fourth rear edge portions of the vibration member 331.

According to an example embodiment of the present disclosure, the second coupling member 322 may not be disposed (or interposed) in a region between the second enclosure 312 and each of third and fourth front edge portions of the vibration member 331. For example, the second coupling member 322 may not be disposed (or interposed) in a region between the second sidewall portion 312b of the second enclosure 312 and each of the third and fourth front edge portions of the vibration member 331. For example, the second coupling member 322 may not be disposed (or interposed) in a region between the third sidewall 312b3 of the second sidewall portion 312b and the third front edge portion of the vibration member 331, and may not be disposed (or interposed) in a region between the fourth sidewall 312b4 of the second sidewall portion 312b and the fourth front edge portion of the vibration member 331. Therefore, an air gap (or a second air gap or an upper air gap) AG may be provided in a region between the second enclosure 312 and each of the third and fourth front edge portions of the vibration member 331.

According to an example embodiment of the present disclosure, the first and second edge portions of the vibration member 331 may be coupled (or fixed) to the enclosure 310 by the first and second coupling members 321 and 322, and an air gap AG may be provided between the enclosure 310 and each of the third and fourth edge portions of the vibration member 331, thereby increasing or maximizing the amount of displacement (or bending force) of the vibration member 331 in the long-side length direction of the vibration member 331. Therefore, according to an example embodiment of the present disclosure, the amount of displacement (or bending force) or the amplitude displacement (or vibration width) of the vibration member 331 may be increased or be maximized due to an air gap AG between the enclosure 310 and each of the third and fourth edge portions of the vibration member 331, and thus, a sound characteristic and/or a sound pressure level characteristic of a middle-low pitched sound band generated based on a vibration of the vibration member 331 based on a vibration (or displacement) of the vibration apparatus 333 may be increased (or enhanced).

According to an example embodiment of the present disclosure, the coupling member 320 or the first and second coupling members 321 and 322 may be configured to minimize the transfer of a vibration of the vibration member 331 to the first sidewall portion 311b of the first enclosure 311. The coupling member 320 or the first and second coupling members 321 and 322 may include a material characteristic suitable for blocking the vibration. For example, the coupling member 320 or the first and second coupling members 321 and 322 may include a material having elasticity. For example, the coupling member 320 or the first and second coupling members 321 and 322 may include a material having elasticity for vibration absorption (or impact absorption). The coupling member 320 or the first and second coupling members 321 and 322 according to an example embodiment of the present disclosure may be configured in polyurethane materials or polyolefin materials, but example embodiments of the present disclosure are not limited thereto. For example, the coupling member 320 or the first and second coupling members 321 and 322 may include one or more of an adhesive, a double-sided adhesive, a double-sided tape, a double-sided adhesive tape, a double-sided foam tape, a double-sided adhesive foam tape, a double-sided pad, a double-sided foam pad, a double-sided adhesive foam pad, and a double-sided cushion tape, but example embodiments of the present disclosure are not limited thereto.

The sound apparatus 30 or the enclosure 310 according to an example embodiment of the present disclosure may further include an opening part 3100.

The opening part 3100 may be configured at the enclosure 310 to overlap the sound generating module 330. The opening part 3100 may be configured at the first enclosure 311 to overlap the sound generating module 330 with respect to a thickness direction Z (or a vertical direction) of the sound apparatus 30. The opening part 3100 may be configured to pass through (or vertically pass through) the first enclosure 311 along the thickness direction Z (or vertical direction) of the enclosure 310. For example, the opening part 3100 may face or directly face the first surface of the sound generating module 330. The opening part 3100 may be connected to (or communicated with) the internal space 313 of the enclosure 310. For example, the opening part 3100 may be connected to the first space 313a of the enclosure 310. For example, the internal space 313 of the enclosure 310 may include a space which is connected to the opening part 3100. For example, the internal space 313 of the enclosure 310 may include the first space 313a which is connected to the opening part 3100.

The opening part 3100 may be configured to decrease an air pressure of the internal space 313 of the enclosure 310. The opening part 3100 may be configured to decrease an air pressure of the first space 313a of the first enclosure 311 or an air pressure of the first space 313a provided between the vibration member 331 and the first enclosure 311. Therefore, a band of the low-pitched sound band may be expanded, and thus, a sound characteristic of the low-pitched sound band may be improved. For example, because a pressure (or air pressure) of the first space 313a of the enclosure 310 is reduced by the opening part 3100, the amount of displacement (or a bending force) of the vibration member 331 between the vibration member 331 and the first enclosure 311 may increase, and thus, a band of the low-pitched sound band may be expanded, thereby enhancing a sound characteristic and/or a sound pressure level characteristic of the low-pitched sound band. Accordingly, a sound (or a sound pressure level) of the low-pitched sound band generated by the vibration (or displacement) of the vibration member 331 based on the driving (or vibration or displacement) of the sound generating module 330 (or the vibration apparatus 333) may be improved.

According to an example embodiment of the present disclosure, the opening part 3100 may be disposed to correspond to a center portion of the sound generating module 330 (or the vibration apparatus 333). For example, the opening part 3100 may include a short axis and a long axis. For example, the opening part 3100 may include a line shape passing through the center portion of the sound generating module 330 (or the vibration apparatus 333) or may include a rectangular shape, but example embodiments of the present disclosure are not limited thereto. For example, the opening part 3100 may include a width (or a short-axis length) parallel to a second direction Y or a short-side length direction of the enclosure 310 and a length (or a long-axis length) parallel to a first direction X or a long-side length direction of the enclosure 310. For example, the length of the opening part 3100 may be smaller than a length (or a long-side length) of the vibration apparatus 333, but example embodiments of the present disclosure are not limited thereto. For example, the opening part 3100 may be a hole, a slot, or a slit, but example embodiments of the present disclosure are not limited thereto. For example, the opening part 3100 may be a sound emission portion, a first sound emission port, a sound output portion, a sound output port, a sound output hole, a duct hole, or a vent hole, but example embodiments of the present disclosure are not limited thereto.

The opening part 3100 may be a space where a sound (or a sound wave) generated in the internal space 313 of the enclosure 310 based on a vibration of the sound generating module 330 is output to an external space of the enclosure 310, for example, the interior space of the vehicle. For example, a vibration or a sound generated by vibration (or displacement) of the vibration member 331 based on the vibration of the vibration apparatus 333 may be output (or emitted) into the interior space of the vehicle through the opening part 3100.

The first enclosure 311 of the enclosure 310 may further include a slope surface (or an inclined surface) 311s. The slope surface 311s may be configured to be inclined between the opening part 3100 and the inner surface 311i of the first enclosure 311. The slope surface 311s may be configured to guide a sound, generated based on the vibration of the sound generating module 330, to the interior space of the vehicle. Accordingly, the sound generated based on the vibration of the sound generating module 330 may be output to the interior space of the vehicle, and a sound characteristic and/or a sound pressure level characteristic of a sound including the low-pitched sound band may be more enhanced. For example, the slope surface 311s may be a guide surface or a sound guide surface, but example embodiments of the present disclosure are not limited thereto.

According to another example embodiment of the present disclosure, the vibration or the sound generated by the vibration of the vibration member 331 based on the vibration of the sound generating module 330 (or the vibration apparatus 333) may be transferred (or output or discharged) to the vehicle interior material through the opening part 3100, and the vehicle interior material may vibrate based on a vibration or a sound transferred through the opening part 3100 to output a sound to the interior space of the vehicle. Accordingly, a sound may be generated based on a vibration of the vehicle interior material having a size which is greater than that of the sound apparatus 30, and thus, a sound characteristic and/or a sound pressure level characteristic of a pitched sound band including a low-pitched sound band generated based on driving (or vibration) of the sound apparatus 30 may be enhanced.

The sound apparatus 30 according to an example embodiment of the present disclosure may include the sound generating module 330 configured at the internal space 313 of the enclosure 310 or the sound generating module 300 having a bimorph structure, and thus, a sound characteristic and/or a sound pressure level characteristic of a sound including the low-pitched sound band may be enhanced. Because the sound apparatus 30 according to an example embodiment of the present disclosure may include an air gap AG between the enclosure 310 and the portion of the vibration member 331, the amount of displacement (or bending force) or the amplitude displacement (or vibration width) of the vibration member 331 may be increased or maximized, and thus, a sound characteristic and/or a sound pressure level characteristic of a middle-low pitched sound band generated based on a vibration of the vibration member 331 based on a vibration (or displacement) of the vibration apparatus 333 may be increased (or enhanced). In addition, because the sound apparatus 30 according to an example embodiment of the present disclosure includes the enclosure 310 having the opening part 3100, an air pressure of the internal space 313 of the enclosure 310 may be reduced, and thus, a pitched sound band of the low-pitched sound band may be expanded, and thus, a sound characteristic and/or a sound pressure level characteristic of the low-pitched sound band may be improved.

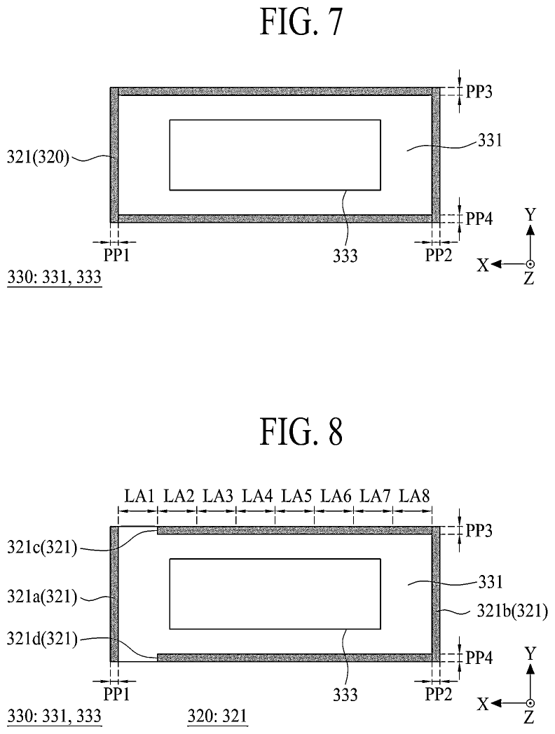

FIG. 7 is a plan view illustrating a sound generating module and a coupling member in a sound apparatus according to an experimental example. FIGS. 8 to 21 are plan views illustrating various example embodiments of a sound generating module and a coupling member in a sound apparatus according to an example embodiment of the present disclosure. For example, FIG. 7 illustrates the coupling member disposed at a vibration member in the sound apparatus according to the experimental example, and FIGS. 8 to 21 illustrate various example embodiments of the coupling member disposed at a vibration member in the sound apparatus according to an example embodiment of the present disclosure. For convenience of description, FIGS. 7 to 21 illustrate only a first coupling member of the coupling member disposed at a first surface of the vibration member, and a second coupling member may be disposed at a second surface of the vibration member like the first coupling member, and thus, a description of the first coupling member may be applied to (or replaced with) a description of the second coupling member.

With reference to FIG. 7, in the sound apparatus according to the experimental example, the coupling member 320 may be disposed along first to fourth edge portions PP1 to PP4 of the vibration member 331. The first coupling member 321 of the coupling member 320 may be disposed along the first to fourth edge portions PP1 to PP4 of the vibration member 331. Therefore, in the sound apparatus according to the experimental example, an entire region of each of first to fourth edge portions PP1 to PP4 of the vibration member 331 may be coupled (or fixed) to the enclosure by the first coupling member 321. For example, in the sound apparatus according to the experimental example, the vibration member 331 may have a 4-side fixing structure (or 4-side restrain structure) by the coupling member 320.

With reference to FIGS. 8 to 21, the coupling member 320 according to an example embodiment of the present disclosure may be disposed along the first and second edge portions PP1 and PP2 of the vibration member 331 and may be further disposed at a portion of the third and fourth edge portions PP3 and PP4 of the vibration member 331. For example, the coupling member 320 may be disposed in an entire region of the first and second edge portions PP1 and PP2 of the vibration member 331 and may be further disposed in the other region, except one or more regions, of each of the third and fourth edge portions PP3 and PP4 of the vibration member 331. For example, the first coupling member 321 of the coupling member 320 may be disposed in the entire region of the first and second edge portions PP1 and PP2 of the vibration member 331 and may be further disposed in the other region, except one or more regions, of each of the third and fourth edge portions PP3 and PP4 of the vibration member 331.

According to an example embodiment of the present disclosure, each of the third and fourth edge portions PP3 and PP4 of the vibration member 331 may include a plurality of regions (or division regions) LA1 to LA8. For example, each of the third and fourth edge portions PP3 and PP4 of the vibration member 331 may include first to eighth regions LA1 to LA8. For example, in each of the third and fourth edge portions PP3 and PP4 of the vibration member 331, the first region LA1 may be adjacent to the first edge portion PP1, and the eighth region LA8 may be adjacent to the second edge portion PP2.

According to an example embodiment of the present disclosure, in each of the third and fourth edge portions PP3 and PP4 of the vibration member 331, the coupling member 320 or the first coupling member 321 may be disposed in the other region, except one or more regions, of the first to eighth regions LA1 to LA8. Therefore, because the coupling member 320 or the first coupling member 321 may be disposed in the other region, except one or more regions, of the first to eighth regions LA1 to LA8 of each of the third and fourth edge portions PP3 and PP4 of the vibration member 331, the amount of displacement (or bending force) or an amplitude displacement (or vibration width) in a long-side length direction of the vibration member 331 may increase or be maximized, and thus, a sound characteristic and/or a sound pressure level characteristic of a middle-low pitched sound band generated based on a vibration of the vibration member 331 based on a vibration (or displacement) of the vibration apparatus 333 may be increased (or enhanced).

The coupling member 320 or the first coupling member 321 according to an example embodiment of the present disclosure may be a first side coupling member 321a, a second side coupling member 321b, a third side coupling member 321c, and a fourth side coupling member 321d. For example, the third side coupling member 321c may be a 1-3^{th} coupling member, a third lower coupling member, a third lower edge coupling member, a first upper side coupling member, a third lower fixing member, a third lower edge fixing member, or a first upper side fixing member, but example embodiments of the present disclosure are not limited thereto. For example, the fourth side coupling member 321d may be a 1-4^{th} coupling member, a fourth lower coupling member, a fourth lower edge coupling member, a first lower side coupling member, a fourth lower fixing member, a fourth lower edge fixing member, or a first lower side fixing member, but example embodiments of the present disclosure are not limited thereto.

With reference to FIG. 8, the first side coupling member 321a may be disposed in an entire region of the first edge portion PP1 of the vibration member 331. The second side coupling member 321b may be disposed in an entire region of the second edge portion PP2 of the vibration member 331. The third side coupling member 321c may be disposed in the second to eighth regions LA2 to LA8, except the first region LA1, of the first to eighth regions LA1 to LA8 of the third edge portion PP3 of the vibration member 331. The fourth side coupling member 321d may be disposed in the second to eighth regions LA2 to LA8, except the first region LA1, of the first to eighth regions LA1 to LA8 of the fourth edge portion PP4 of the vibration member 331. For example, the vibration member 331 described above with reference to FIG. 8 may have an entire fixing structure of both short sides and a 7/8 fixing structure of both long sides by using the coupling member 320. For example, the vibration member 331 may be fixed to all of two short sides by using the coupling member 320 and may be fixed to seven regions of regions of each of two long sides.

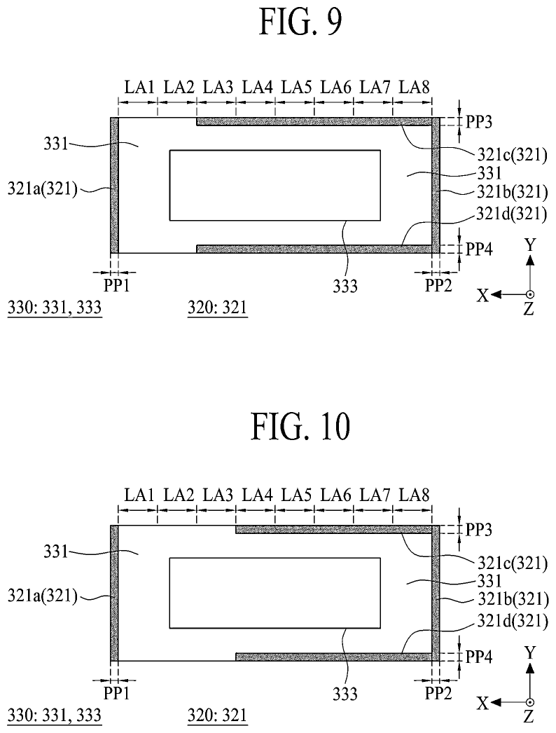

With reference to FIG. 9, the first side coupling member 321a may be disposed in an entire region of the first edge portion PP1 of the vibration member 331. The second side coupling member 321b may be disposed in an entire region of the second edge portion PP2 of the vibration member 331. The third side coupling member 321c may be disposed in the third to eighth regions LA3 to LA8, except the first and second regions LA1 and LA2, of the first to eighth regions LA1 to LA8 of the third edge portion PP3 of the vibration member 331. The fourth side coupling member 321d may be disposed in the third to eighth regions LA3 to LA8, except the first and second regions LA1 and LA2, of the first to eighth regions LA1 to LA8 of the fourth edge portion PP4 of the vibration member 331. For example, the vibration member 331 described above with reference to FIG. 9 may have an entire fixing structure of both short sides and a 6/8 fixing structure of both long sides by using the coupling member 320. For example, the vibration member 331 may be fixed to all of two short sides by using the coupling member 320 and may be fixed to six regions of regions of each of two long sides.

With reference to FIG. 10, the first side coupling member 321a may be disposed in an entire region of the first edge portion PP1 of the vibration member 331. The second side coupling member 321b may be disposed in an entire region of the second edge portion PP2 of the vibration member 331. The third side coupling member 321c may be disposed in the fourth to eighth regions LA4 to LA8, except the first to third regions LA1 to LA3, of the first to eighth regions LA1 to LA8 of the third edge portion PP3 of the vibration member 331. The fourth side coupling member 321d may be disposed in the fourth to eighth regions LA4 to LA8, except the first to third regions LA1 to LA3, of the first to eighth regions LA1 to LA8 of the fourth edge portion PP4 of the vibration member 331. For example, the vibration member 331 described above with reference to FIG. 10 may have an entire fixing structure of both short sides and a 5/8 fixing structure of both long sides by using the coupling member 320. For example, the vibration member 331 may be fixed to all of two short sides by using the coupling member 320 and may be fixed to five regions of regions of each of two long sides.

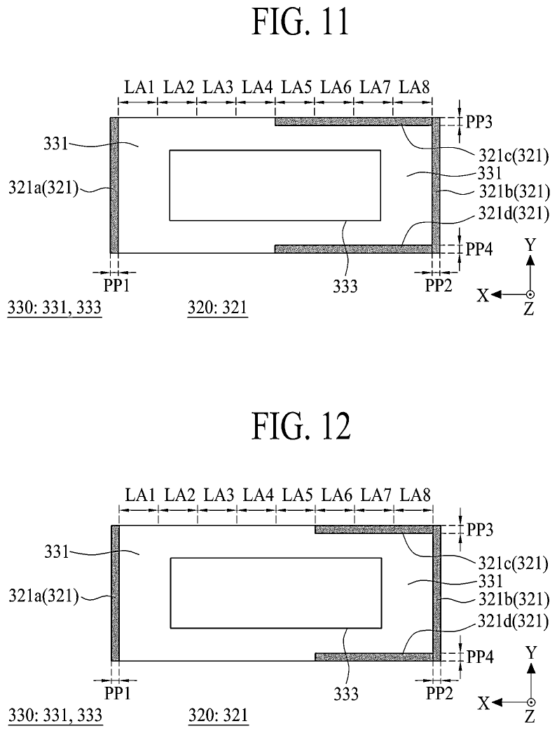

With reference to FIG. 11, the first side coupling member 321a may be disposed in an entire region of the first edge portion PP1 of the vibration member 331. The second side coupling member 321b may be disposed in an entire region of the second edge portion PP2 of the vibration member 331. The third side coupling member 321c may be disposed in the fifth to eighth regions LA5 to LA8, except the first to fourth regions LA1 to LA4, of the first to eighth regions LA1 to LA8 of the third edge portion PP3 of the vibration member 331. The fourth side coupling member 321d may be disposed in the fifth to eighth regions LA5 to LA8, except the first to fourth regions LA1 to LA4, of the first to eighth regions LA1 to LA8 of the fourth edge portion PP4 of the vibration member 331. For example, the vibration member 331 described above with reference to FIG. 11 may have an entire fixing structure of both short sides and a 4/8 fixing structure of both long sides by using the coupling member 320. For example, the vibration member 331 may be fixed to all of two short sides by using the coupling member 320 and may be fixed to four regions of regions of each of two long sides.

With reference to FIG. 12, the first side coupling member 321a may be disposed in an entire region of the first edge portion PP1 of the vibration member 331. The second side coupling member 321b may be disposed in an entire region of the second edge portion PP2 of the vibration member 331. The third side coupling member 321c may be disposed in the sixth to eighth regions LA6 to LA8, except the first to fifth regions LA1 to LA5, of the first to eighth regions LA1 to LA8 of the third edge portion PP3 of the vibration member 331. The fourth side coupling member 321d may be disposed in the sixth to eighth regions LA6 to LA8, except the first to fifth regions LA1 to LA5, of the first to eighth regions LA1 to LA8 of the fourth edge portion PP4 of the vibration member 331. For example, the vibration member 331 described above with reference to FIG. 12 may have an entire fixing structure of both short sides and a 3/8 fixing structure of both long sides by using the coupling member 320. For example, the vibration member 331 may be fixed to all of two short sides by using the coupling member 320 and may be fixed to three regions of regions of each of two long sides.

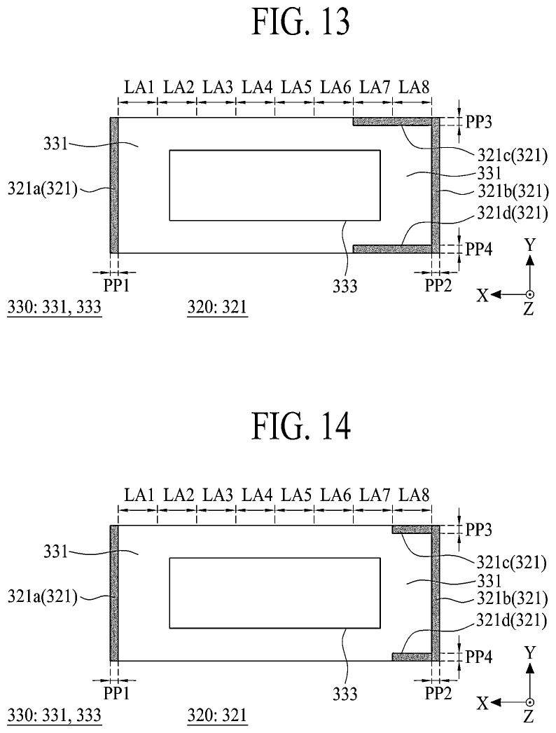

With reference to FIG. 13, the first side coupling member 321a may be disposed in an entire region of the first edge portion PP1 of the vibration member 331. The second side coupling member 321b may be disposed in an entire region of the second edge portion PP2 of the vibration member 331. The third side coupling member 321c may be disposed in the seventh and eighth regions LA7 and LA8, except the first to sixth regions LA1 to LA6, of the first to eighth regions LA1 to LA8 of the third edge portion PP3 of the vibration member 331. The fourth side coupling member 321d may be disposed in the seventh and eighth regions LA7 and LA8, except the first to sixth regions LA1 to LA6, of the first to eighth regions LA1 to LA8 of the fourth edge portion PP4 of the vibration member 331. For example, the vibration member 331 described above with reference to FIG. 13 may have an entire fixing structure of both short sides and a 2/8 fixing structure of both long sides by using the coupling member 320. For example, the vibration member 331 may be fixed to all of two short sides by using the coupling member 320 and may be fixed to two regions of regions of each of two long sides.

With reference to FIG. 14, the first side coupling member 321a may be disposed in an entire region of the first edge portion PP1 of the vibration member 331. The second side coupling member 321b may be disposed in an entire region of the second edge portion PP2 of the vibration member 331. The third side coupling member 321c may be disposed in the eighth region LA8, except the first to seventh regions LA1 to LA7, of the first to eighth regions LA1 to LA8 of the third edge portion PP3 of the vibration member 331. The fourth side coupling member 321d may be disposed in the eighth region LA8, except the first to seventh regions LA1 to LA7, of the first to eighth regions LA1 to LA8 of the fourth edge portion PP4 of the vibration member 331. For example, the vibration member 331 described above with reference to FIG. 14 may have a both-short-side fixing structure and a 1/8 fixing structure of both long sides by using the coupling member 320. For example, the vibration member 331 may be fixed to all of two short sides by using the coupling member 320 and may be fixed to one region of regions of each of two long sides.

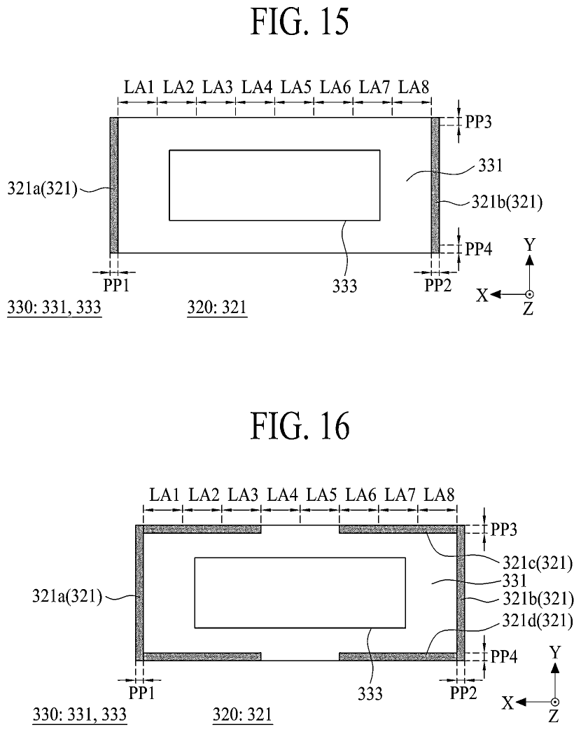

With reference to FIG. 15, the first side coupling member 321a may be disposed in an entire region of the first edge portion PP1 of the vibration member 331. The second side coupling member 321b may be disposed in an entire region of the second edge portion PP2 of the vibration member 331. The third side coupling member 321c may not be disposed in the third edge portion PP3 of the vibration member 331. The fourth side coupling member 321d may not be disposed in the fourth edge portion PP4 of the vibration member 331. For example, the vibration member 331 described above with reference to FIG. 15 may have a both-short-side fixing structure by the coupling member 320. For example, the vibration member 331 may be fixed to all of two short sides by the coupling member 320.

With reference to FIG. 16, the first side coupling member 321a may be disposed in an entire region of the first edge portion PP1 of the vibration member 331. The second side coupling member 321b may be disposed in an entire region of the second edge portion PP2 of the vibration member 331. The third side coupling member 321b may be disposed in the first to third regions LA1 to LA3 and the sixth to eighth regions LA6 to LA8, except the fourth and fifth regions LA4 and LA5, of the first to eighth regions LA1 to LA8 of the third edge portion PP3 of the vibration member 331. The fourth side coupling member 321d may be disposed in the first to third regions LA1 to LA3 and the sixth to eighth regions LA6 to LA8, except the fourth and fifth regions LA4 and LA5, of the first to eighth regions LA1 to LA8 of the fourth edge portion PP4 of the vibration member 331. For example, the vibration member 331 described above with reference to FIG. 16 may have an entire fixing structure of both short sides and a 6/8 edge fixing structure of both long sides by using the coupling member 320. For example, the vibration member 331 may be fixed to all of two short sides by using the coupling member 320 and may be fixed to three regions of regions of each of two long sides. For example, the coupling member 320 may be disposed in an entire region of the first edge portion PP1 of the vibration member 331 and a portion of each of the third edge portion PP3 and the fourth edge portion PP4. For example, the first side coupling member 321a may partially connect the third side coupling member 321c to the fourth side coupling member 321d. For example, the second side coupling member 321b may partially connect the third side coupling member 321c to the fourth side coupling member 321d.

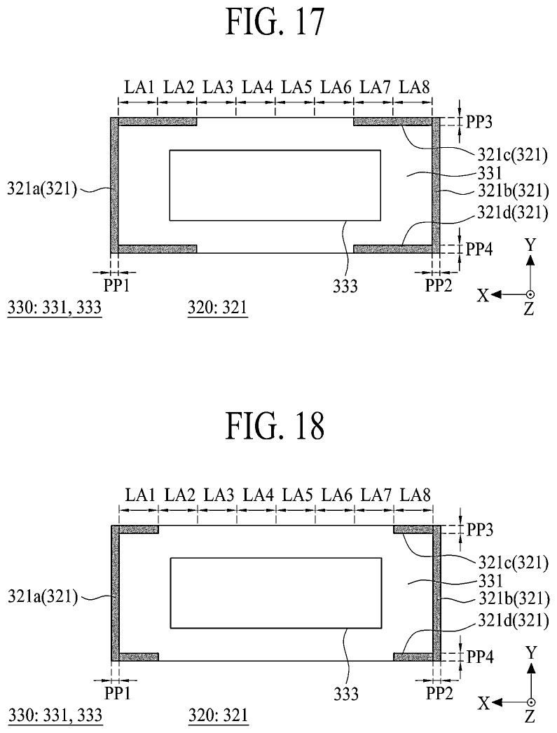

With reference to FIG. 17, the first side coupling member 321a may be disposed in an entire region of the first edge portion PP1 of the vibration member 331. The second side coupling member 321b may be disposed in an entire region of the second edge portion PP2 of the vibration member 331. The third side coupling member 321b may be disposed in the first and second regions LA1 and LA2 and the seventh and eighth regions LA7 and LA8, except the third to sixth regions LA3 to LA6, of the first to eighth regions LA1 to LA8 of the third edge portion PP3 of the vibration member 331. The fourth side coupling member 321d may be disposed in the first and second regions LA1 and LA2 and the seventh and eighth regions LA7 and LA8, except the third to sixth regions LA3 to LA6, of the first to eighth regions LA1 to LA8 of the fourth edge portion PP4 of the vibration member 331. For example, the vibration member 331 described above with reference to FIG. 17 may have an entire fixing structure of both short sides and a 4/8 edge fixing structure of both long sides by using the coupling member 320. For example, the vibration member 331 may be fixed to all of two short sides by using the coupling member 320 and may be fixed to two regions of regions of each of two long sides. For example, the coupling member 320 may be disposed in an entire region of the first edge portion PP1 of the vibration member 331 and a portion of each of the third edge portion PP3 and the fourth edge portion PP4. For example, the first side coupling member 321a may partially connect the third side coupling member 321c to the fourth side coupling member 321d. For example, the second side coupling member 321b may partially connect the third side coupling member 321c to the fourth side coupling member 321d.

With reference to FIG. 18, the first side coupling member 321a may be disposed in an entire region of the first edge portion PP1 of the vibration member 331. The second side coupling member 321b may be disposed in an entire region of the second edge portion PP2 of the vibration member 331. The third side coupling member 321b may be disposed in the first and eighth regions LA1 and LA8, except the second to seventh regions LA2 to LA7, of the first to eighth regions LA1 to LA8 of the third edge portion PP3 of the vibration member 331. The fourth side coupling member 321d may be disposed in the first and eighth regions LA1 and LA8, except the second to seventh regions LA2 to LA7, of the first to eighth regions LA1 to LA8 of the fourth edge portion PP4 of the vibration member 331. For example, the vibration member 331 described above with reference to FIG. 18 may have an entire fixing structure of both short sides and a 2/8 edge fixing structure of both long sides by using the coupling member 320. For example, the vibration member 331 may be fixed to all of two short sides by using the coupling member 320 and may be fixed to one region of regions of each of two long sides. For example, the coupling member 320 may be disposed in an entire region of the first edge portion PP1 of the vibration member 331 and a portion of each of the third edge portion PP3 and the fourth edge portion PP4. For example, the first side coupling member 321a may partially connect the third side coupling member 321c to the fourth side coupling member 321d. For example, the second side coupling member 321b may partially connect the third side coupling member 321c to the fourth side coupling member 321d.

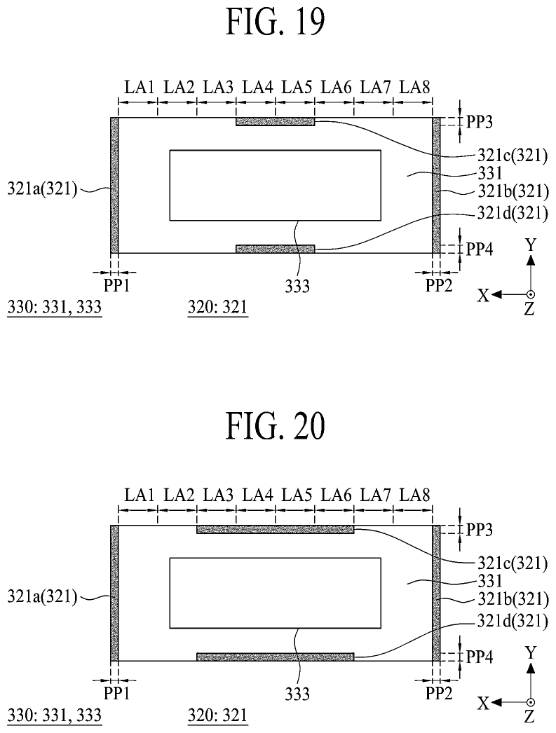

With reference to FIG. 19, the first side coupling member 321a may be disposed in an entire region of the first edge portion PP1 of the vibration member 331. The second side coupling member 321b may be disposed in an entire region of the second edge portion PP2 of the vibration member 331. The third side coupling member 321b may be disposed in the fourth and fifth regions LA4 and LA5, except the first to third regions LA1 to LA3 and the sixth to eighth regions LA6 to LA8, of the first to eighth regions LA1 to LA8 of the third edge portion PP3 of the vibration member 331. The fourth side coupling member 321d may be disposed in the fourth and fifth regions LA4 and LA5, except the first to third regions LA1 to LA3 and the sixth to eighth regions LA6 to LA8, of the first to eighth regions LA1 to LA8 of the fourth edge portion PP4 of the vibration member 331. For example, the vibration member 331 described above with reference to FIG. 19 may have an entire fixing structure of both short sides and a 2/8 middle fixing structure of both long sides by using the coupling member 320. For example, the vibration member 331 may be fixed to all of two short sides by using the coupling member 320 and may be fixed to two regions of regions of each of two long sides. For example, the two regions may be a central region of each of the third edge portion PP3 and the fourth edge portion PP4. For example, the two regions may correspond to a central region of the vibration apparatus 333. For example, the two regions may overlap the central region of the vibration apparatus 333. For example, the coupling member 320 may be disposed in an entire region of the first edge portion PP1 of the vibration member 331 and a portion of each of the third edge portion PP3 and the fourth edge portion PP4.

With reference to FIG. 20, the first side coupling member 321a may be disposed in an entire region of the first edge portion PP1 of the vibration member 331. The second side coupling member 321b may be disposed in an entire region of the second edge portion PP2 of the vibration member 331. The third side coupling member 321b may be disposed in the third to sixth regions LA3 to LA6, except the first and second regions LA1 and LA2 and the seventh and eighth regions LA7 and LA8, of the first to eighth regions LA1 to LA8 of the third edge portion PP3 of the vibration member 331. The fourth side coupling member 321d may be disposed in the third to sixth regions LA3 to LA6, except the first and second regions LA1 and LA2 and the seventh and eighth regions LA7 and LA8, of the first to eighth regions LA1 to LA8 of the fourth edge portion PP4 of the vibration member 331. For example, the vibration member 331 described above with reference to FIG. 20 may have an entire fixing structure of both short sides and a 4/8 middle fixing structure of both long sides by using the coupling member 320. For example, the vibration member 331 may be fixed to all of two short sides by using the coupling member 320 and may be fixed to four regions of regions of each of two long sides. For example, the four regions may be a central region of each of the third edge portion PP3 and the fourth edge portion PP4. For example, the four regions may correspond to a central region of the vibration apparatus 333. For example, the four regions may overlap the central region of the vibration apparatus 333. For example, the coupling member 320 may be disposed in an entire region of the first edge portion PP1 of the vibration member 331 and a portion of each of the third edge portion PP3 and the fourth edge portion PP4.

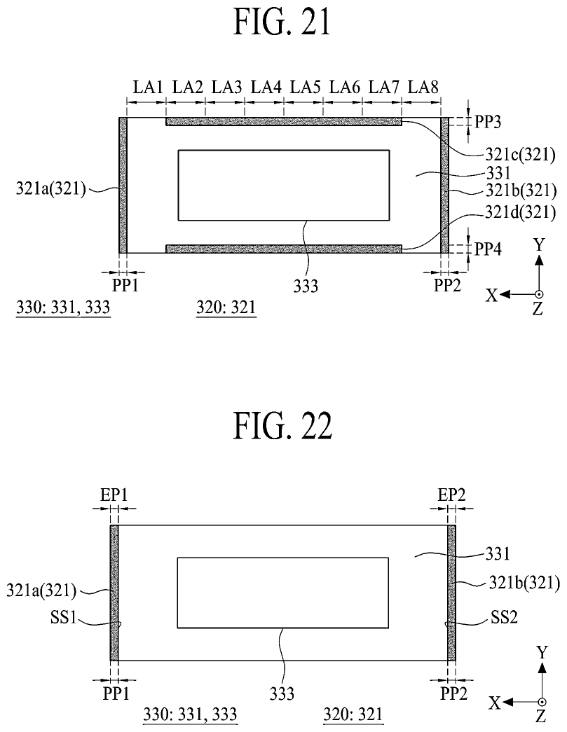

With reference to FIG. 21, the first side coupling member 321a may be disposed in an entire region of the first edge portion PP1 of the vibration member 331. The second side coupling member 321b may be disposed in an entire region of the second edge portion PP2 of the vibration member 331. The third side coupling member 321b may be disposed in the second to seventh regions LA2 to LA7, except the first and eighth regions LA1 and LA8, of the first to eighth regions LA1 to LA8 of the third edge portion PP3 of the vibration member 331. The fourth side coupling member 321d may be disposed in the second to seventh regions LA2 to LA7, except the first and eighth regions LA1 and LA8, of the first to eighth regions LA1 to LA8 of the fourth edge portion PP4 of the vibration member 331. For example, the vibration member 331 described above with reference to FIG. 21 may have an entire fixing structure of both short sides and a 6/8 middle fixing structure of both long sides by using the coupling member 320. For example, the vibration member 331 may be fixed to all of two short sides by using the coupling member 320 and may be fixed to six regions of regions of each of two long sides. For example, the six regions may be a central region of each of the third edge portion PP3 and the fourth edge portion PP4. For example, the six regions may correspond to a central region of the vibration apparatus 333. For example, the six regions may overlap the central region of the vibration apparatus 333. For example, the six regions may be greater than that of the vibration apparatus 333. For example, the coupling member 320 may be disposed in an entire region of the first edge portion PP1 of the vibration member 331 and a portion of each of the third edge portion PP3 and the fourth edge portion PP4.

FIGS. 22 to 26 are plan views illustrating a sound generating module and a coupling member in a sound apparatus according to another example embodiment of the present disclosure. For example, FIGS. 22 to 26 illustrate an example embodiment implemented by modifying the vibration member and the coupling member each described above with reference to FIGS. 3 to 6 or FIG. 15. For convenience of description, FIGS. 22 to 26 illustrate only a first coupling member of a coupling member disposed at a first surface of a vibration member, and a second coupling member may be disposed at a second surface of the vibration member like the first coupling member, and thus, a description of the second coupling member is omitted.

With reference to FIGS. 22 to 26, in the sound apparatus according to another example embodiment of the present disclosure, the vibration member 331 may include a first extension portion EP1 extending from a first short side SS1 and a second extension portion EP2 extending from a second short side SS2. Each of the first and second extension portions EP1 and EP2 of the vibration member 331 may extend along a first direction X or a long-side length direction of the vibration member 331. For example, with respect to the first direction X or the long-side length direction of the vibration member 331, each of the first and second extension portions EP1 and EP2 of the vibration member 331 may be a region which is at least 1.5 or more times a short-side length of the vibration member 331 from a center portion of the vibration member 331, but example embodiments of the present disclosure are not limited thereto. For example, a long-side length of the vibration member 331 may be at least three or more times the short-side length of the vibration member 331, but example embodiments of the present disclosure are not limited thereto. For example, a natural frequency of the vibration member 331 may decrease due to the first and second extension portions EP1 and EP2.

According to another example embodiment of the present disclosure, with respect to a size (or area) of the vibration member 331, a size (or area) of the vibration member 331 illustrated in FIGS. 22 to 26 may be greater than a size (or area) of the vibration member 331 described above with reference to FIGS. 3 to 21. For convenience of description, the vibration member 331 described above with reference to FIGS. 3 to 21 may be referred to as a reference vibration member.

With reference to FIG. 22, the coupling member 320 or the first coupling member 321 according to another example embodiment of the present disclosure may be disposed in each of the first and second extension portions EP1 and EP2 of the vibration member 331 and may be disposed or not be disposed in a portion of each of third and fourth edge portions PP3 and PP4 of the vibration member 331.

With respect to the first direction X or the long-side length direction of the vibration member 331, each of the first and second extension portions EP1 and EP2 of the vibration member 331 may extend from short sides SS1 and SS2 of the reference vibration member. For example, an extension width of each of the first and second extension portions EP1 and EP2 may be equal to a width of the coupling member 320 (or first coupling member 321), but example embodiments of the present disclosure are not limited thereto.

The coupling member 320 or the first coupling member 321 may include a first side coupling member 321a and a second side coupling member 321b.

The first side coupling member (or a 1-1^{th} coupling member) 321a may be disposed in the first extension portion EP1 of the vibration member 331. For example, the first side coupling member 321a may be disposed in an entire region of the first extension portion EP1 of the vibration member 331.

The second side coupling member (or a 1-2^{th} coupling member) 321b may be disposed in the second extension portion EP2 of the vibration member 331. For example, the second side coupling member 321b may be disposed in an entire region of the second extension portion EP2 of the vibration member 331.

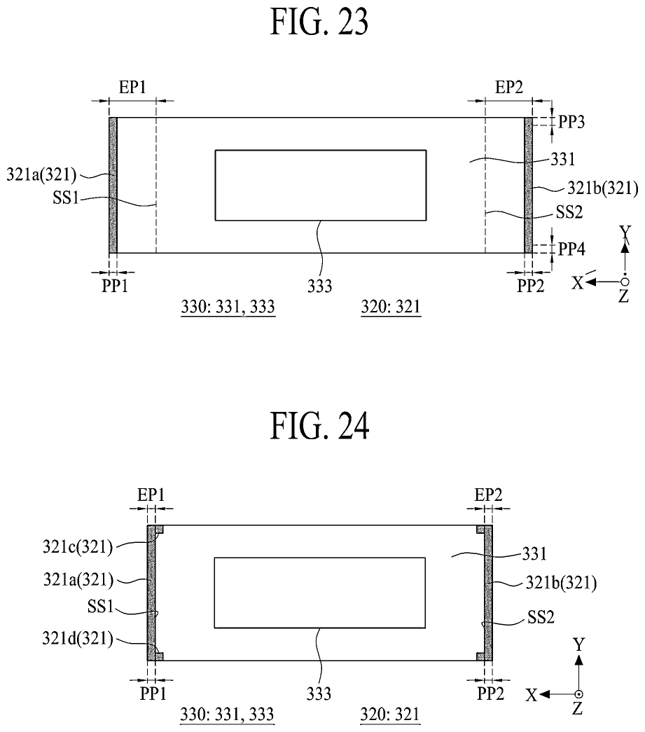

With reference to FIG. 23, the coupling member 320 or the first coupling member 321 according to another example embodiment of the present disclosure may be disposed in each of the first and second extension portions EP1 and EP2 of the vibration member 331 and may not be disposed in each of third and fourth edge portions PP3 and PP4 of the vibration member 331.

With respect to the first direction X or the long-side length direction of the vibration member 331, each of the first and second extension portions EP1 and EP2 of the vibration member 331 may extend from short sides SS1 and SS2 of the reference vibration member. For example, an extension width of each of the first and second extension portions EP1 and EP2 may be two or more times greater than a width of the coupling member 320 (or first coupling member 321), but example embodiments of the present disclosure are not limited thereto.

The coupling member 320 or the first coupling member 321 may include a first side coupling member 321a and a second side coupling member 321b.

The first side coupling member (or a 1-1^{th} coupling member) 321a may be disposed in an edge portion, which is adjacent to a short side, of the first extension portion EP1. For example, the first side coupling member 321a may be disposed between an enclosure and the edge portion, which is adjacent to the short side, of the first extension portion EP1.

The second side coupling member (or a 1-2^{th} coupling member) 321b may be disposed in an edge portion, which is adjacent to a short side, of the second extension portion EP2. For example, the second side coupling member 321b may be disposed between the enclosure and the edge portion, which is adjacent to the short side, of the second extension portion EP2.

With reference to FIG. 24, the coupling member 320 or the first coupling member 321 according to another example embodiment of the present disclosure may be disposed in each of the first and second extension portions EP1 and EP2 of the vibration member 331 and may be disposed or not be disposed in a portion of each of third and fourth edge portions PP3 and PP4 of the vibration member 331.

With respect to the first direction X or the long-side length direction of the vibration member 331, each of the first and second extension portions EP1 and EP2 of the vibration member 331 may extend from short sides SS1 and SS2 of the reference vibration member. For example, an extension width of each of the first and second extension portions EP1 and EP2 may be equal to a width of the coupling member 320 (or first coupling member 321), but example embodiments of the present disclosure are not limited thereto.

The coupling member 320 or the first coupling member 321 may include a first side coupling member 321a, a second side coupling member 321b, a third side coupling member 321c, and a fourth side coupling member 321d.

The first side coupling member (or a 1-1^{th} coupling member) 321a may be disposed in the first extension portion EP1 of the vibration member 331. For example, the first side coupling member 321a may be disposed in an entire region of the first extension portion EP1 of the vibration member 331.

The second side coupling member (or a 1-2^{th} coupling member) 321b may be disposed in the second extension portion EP2 of the vibration member 331. For example, the second side coupling member 321b may be disposed in an entire region of the second extension portion EP2 of the vibration member 331.

The third side coupling member (or a 1-3^{th} coupling member) 321c may be disposed between an enclosure and the third edge portion PP3 of the vibration member 331 so as to be adjacent to each of the first side coupling member 321a and the second side coupling member 321b. For example, with respect to the first direction X or the long-side length direction of the vibration member 331, a width (or length) of the third side coupling member 321c may be equal to a width of the first side coupling member 321a (or second side coupling member 321b), but example embodiments of the present disclosure are not limited thereto.

The fourth side coupling member (or a 1-4^{th} coupling member) 321d may be disposed between the enclosure and the fourth edge portion PP4 of the vibration member 331 so as to be adjacent to each of the first side coupling member 321a and the second side coupling member 321b. For example, with respect to the first direction X or the long-side length direction of the vibration member 331, a width (or length) of the fourth side coupling member 321d may be equal to a width of the first side coupling member 321a (or second side coupling member 321b), but example embodiments of the present disclosure are not limited thereto.

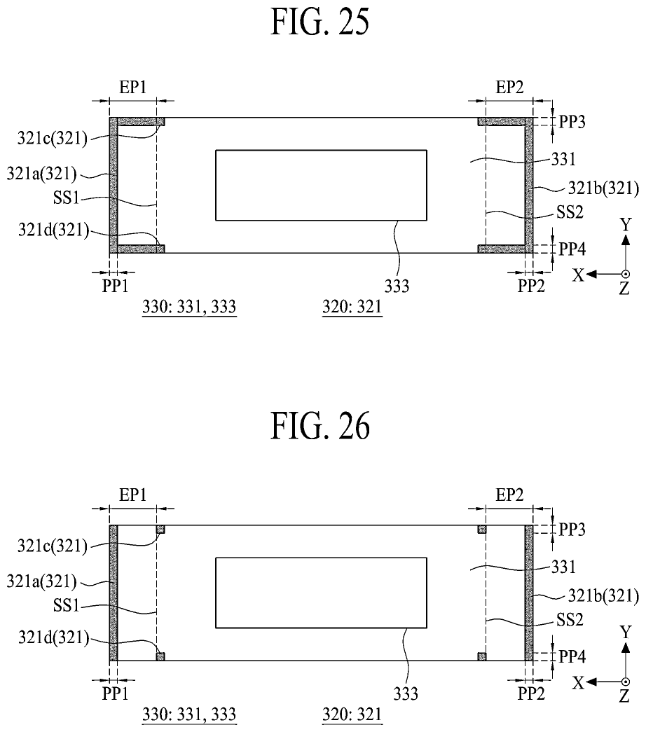

With reference to FIG. 25, the coupling member 320 or the first coupling member 321 according to another example embodiment of the present disclosure may be disposed in each of the first and second extension portions EP1 and EP2 of the vibration member 331 and may be disposed or not be disposed in a portion of each of third and fourth edge portions PP3 and PP4 of the vibration member 331.

With respect to the first direction X or the long-side length direction of the vibration member 331, each of the first and second extension portions EP1 and EP2 of the vibration member 331 may extend from short sides SS1 and SS2 of the reference vibration member. For example, an extension width (or length) of each of the first and second extension portions EP1 and EP2 may be two or more times greater than a width of the coupling member 320 (or first coupling member 321), but example embodiments of the present disclosure are not limited thereto.

The coupling member 320 or the first coupling member 321 may include a first side coupling member 321a, a second side coupling member 321b, a third side coupling member 321c, and a fourth side coupling member 321d.

The first side coupling member (or a 1-1^{th} coupling member) 321a may be disposed in an edge portion, which is adjacent to a short side, of the first extension portion EP1. For example, the first side coupling member 321a may be disposed between an enclosure and the edge portion, which is adjacent to the short side, of the first extension portion EP1.

The second side coupling member (or a 1-2^{th} coupling member) 321b may be disposed in an edge portion, which is adjacent to a short side, of the second extension portion EP2. For example, the second side coupling member 321b may be disposed between the enclosure and the edge portion, which is adjacent to the short side, of the second extension portion EP2.

The third side coupling member (or a 1-3^{th} coupling member) 321c may be disposed between the enclosure and the third edge portion PP3 of the vibration member 331 so as to be adjacent to each of the first side coupling member 321a and the second side coupling member 321b. For example, the third side coupling member 321c may be disposed between the enclosure and an edge portion of each of the first and second extension portions EP1 and EP2, that is adjacent to a first long side of the vibration member 331. For example, with respect to the first direction X or the long-side length direction of the vibration member 331, a length of the third side coupling member 321c may be equal to an extension length of the first extension portion EP1 (or second extension portion EP2), but example embodiments of the present disclosure are not limited thereto.

The fourth side coupling member (or a 1-4^{th} coupling member) 321d may be disposed between the enclosure and the fourth edge portion PP4 of the vibration member 331 so as to be adjacent to each of the first side coupling member 321a and the second side coupling member 321b. For example, the fourth side coupling member 321d may be disposed between the enclosure and an edge portion of each of the first and second extension portions EP1 and EP2, that is adjacent to a second long side of the vibration member 331. For example, with respect to the first direction X or the long-side length direction of the vibration member 331, a length of the fourth side coupling member 321d may be equal to an extension length of the first extension portion EP1 (or second extension portion EP2), but example embodiments of the present disclosure are not limited thereto.

With reference to FIG. 26, the coupling member 320 or the first coupling member 321 according to another example embodiment of the present disclosure may be disposed in each of the first and second extension portions EP1 and EP2 of the vibration member 331 and may be disposed or not be disposed in a portion of each of third and fourth edge portions PP3 and PP4 of the vibration member 331.

With respect to the first direction X or the long-side length direction of the vibration member 331, each of the first and second extension portions EP1 and EP2 of the vibration member 331 may extend from short sides SS1 and SS2 of the reference vibration member. For example, an extension width of each of the first and second extension portions EP1 and EP2 may be two or more times greater than a width of the coupling member 320 (or first coupling member 321), but example embodiments of the present disclosure are not limited thereto.

The coupling member 320 or the first coupling member 321 may include a first side coupling member 321a, a second side coupling member 321b, a third side coupling member 321c, and a fourth side coupling member 321d.

The first side coupling member (or a 1-1^{th} coupling member) 321a may be disposed in an edge portion, which is adjacent to a short side, of the first extension portion EP1. For example, the first side coupling member 321a may be disposed between an enclosure and the edge portion, which is adjacent to the short side, of the first extension portion EP1.

The second side coupling member (or a 1-2^{th} coupling member) 321b may be disposed in an edge portion, which is adjacent to a short side, of the second extension portion EP2. For example, the second side coupling member 321b may be disposed between the enclosure and the edge portion, which is adjacent to the short side, of the second extension portion EP2.

The third side coupling member (or a 1-3^{th} coupling member) 321c may be disposed between the enclosure and the third edge portion PP3, which is adjacent to each of the first extension portion EP1 and the second extension portions EP2, of the vibration member 331, so as to be spaced apart from each of the first side coupling member 321a and the second side coupling member 321b. For example, with respect to the first direction X or the long-side length direction of the vibration member 331, a width (or length) of the third side coupling member 321c may be equal to a width of the first side coupling member 321a (or second side coupling member 321b), but example embodiments of the present disclosure are not limited thereto.

The fourth side coupling member (or a 1-4^{th} coupling member) 321d may be disposed between the enclosure and the fourth edge portion PP4, which is adjacent to each of the first extension portion EP1 and the second extension portions EP2, of the vibration member 331, so as to be spaced apart from each of the first side coupling member 321a and the second side coupling member 321b. For example, with respect to the first direction X or the long-side length direction of the vibration member 331, a width (or length) of the fourth side coupling member 321d may be equal to a width of the first side coupling member 321a (or second side coupling member 321b), but example embodiments of the present disclosure are not limited thereto.

According to another example embodiment of the present disclosure described above with reference to FIGS. 22 to 26, the third side coupling member (or 1-3^{th} coupling member) 321c may be disposed between an enclosure 310 and at least a portion of an edge portion PP3 of each of the first and second extension portions EP1 and EP2 adjacent to the first long side of the vibration member 331, and the fourth side coupling member (or 1-4^{th} coupling member) 321d may be disposed between the enclosure 310 and at least a portion of an edge portion PP4 of each of the first and second extension portions EP1 and EP2 adjacent to the second long side of the vibration member 331. Therefore, the vibration member 331 may have a natural frequency similar to that of the reference vibration member, or may have a natural frequency which is lower than that of the reference vibration member due to the first and second extension portions EP1 and EP2. Accordingly, the third and fourth side coupling members 321c and 321d may be used to tune a natural frequency or a vibration characteristic of the vibration member 331 having a size which is relatively greater than that of the reference vibration member. For example, a width (or length) and an arrangement position of each of the third and fourth side coupling members 321c and 321d may be used to tune a natural frequency or a vibration characteristic of the vibration member 331 having a size which is relatively greater than that of the reference vibration member to a natural frequency or a vibration characteristic of the reference vibration member.

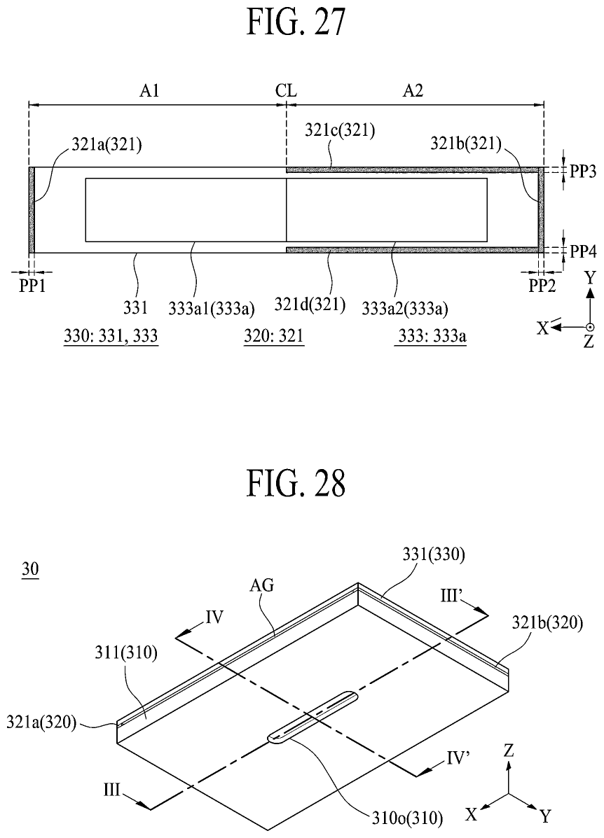

FIG. 27 is a plan view illustrating a sound generating module and a coupling member in a sound apparatus according to another example embodiment of the present disclosure. For example, FIG. 27 illustrates an example embodiment implemented by modifying the vibration member and the coupling member each described above with reference to FIGS. 3 to 6 or FIG. 15. For convenience of description, FIG. 27 illustrates only a first coupling member of a coupling member disposed at a first surface of a vibration member, and a second coupling member may be disposed at a second surface of the vibration member like the first coupling member, and thus, a description of the second coupling member is omitted.

With reference to FIG. 27, in the sound apparatus according to another example embodiment of the present disclosure, a sound generating module 330 may include a vibration member 331 and a first vibration apparatus 333a.

The vibration member 331 may include a rectangular shape including a short side and a long side, but example embodiments of the present disclosure are not limited thereto. For example, in the vibration member 331, a long-side length may be six times a short-side length, or may be two times a long-side length of the reference vibration member, but example embodiments of the present disclosure are not limited thereto.

The vibration member 331 may include a first region A1 and a second region A2. In the vibration member 331, the first region A1 and the second region A2 may be symmetric or have the same size (or area), with respect to a center (or center line) CL of the long-side length, but example embodiments of the present disclosure are not limited thereto.

The first vibration apparatus 333a may be configured to vibrate each of the first region A1 and the second region A2 of the vibration member 331. The first vibration apparatus 333a may be disposed (or configured) in each of the first region A1 and the second region A2 of the vibration member 331.

The first vibration apparatus 333a according to another example embodiment of the present disclosure may include a 1-1^{th} vibration apparatus 333a1 and a 1-2^{th} vibration apparatus 333a2.

The 1-1^{th} vibration apparatus 333a1 may be configured to vibrate the first region A1 of the vibration member 331. The 1-1^{th} vibration apparatus 333a1 may be disposed (or configured) in the first region A1 of the vibration member 331. For example, one end (or one side) of the 1-1^{th} vibration apparatus 333a1 adjacent to the second region A2 of the vibration member 331 may be located or aligned at the center (or center line) CL of the long-side length of the vibration member 331, but example embodiments of the present disclosure are not limited thereto. For example, a center portion of the 1-1^{th} vibration apparatus 333a1 may be located (or aligned) at a center portion of the first region A1 of the vibration member 331, or may be located (or aligned) in a region between the second region A2 and the center portion of the first region A1 of the vibration member 331.

The 1-2^{th} vibration apparatus 333a2 may be configured to vibrate the second region A2 of the vibration member 331. The 1-2^{th} vibration apparatus 333a2 may be disposed (or configured) in the second region A2 of the vibration member 331. For example, one end (or one side) of the 1-2^{th} vibration apparatus 333a2 adjacent to the first region A1 of the vibration member 331 may be located or aligned at the center (or center line) CL of the long-side length of the vibration member 331, but example embodiments of the present disclosure are not limited thereto. For example, one end (or one side) of the 1-2^{th} vibration apparatus 333a2 may contact one end (or one side) of the 1-1^{th} vibration apparatus 333a1, but example embodiments of the present disclosure are not limited thereto. For example, a center portion of the 1-2^{th} vibration apparatus 333a2 may be located (or aligned) at a center portion of the second region A2 of the vibration member 331, or may be located (or aligned) in a region between the first region A1 and the center portion of the second region A2 of the vibration member 331.

In the sound apparatus according to another example embodiment of the present disclosure, the coupling member 320 may be disposed along first and second edge portions PP1 and PP2, which are adjacent to the short side, of the vibration member 331 and may be further disposed at a portion of third and fourth edge portions PP3 and PP4, which are adjacent to the long side, of the vibration member 331. For example, the coupling member 320 may be disposed in an entire region of the first and second edge portions PP1 and PP2 of the vibration member 331 and may be disposed in each of the third and fourth edge portions PP3 and PP4 of one of the first and second regions A1 and A2 of the vibration member 331. For example, the first coupling member 321 of the coupling member 320 may be disposed in an entire region of the first and second edge portions PP1 and PP2 of the vibration member 331 and may be further disposed in each of the third and fourth edge portions PP3 and PP4 of the second region A2 of the vibration member 331. For example, the vibration member 331 illustrated in FIG. 27 may have an entire fixing structure of both short sides and a half fixing structure of both long sides by using the coupling member 320.

The coupling member 320 or the first coupling member 321 according to another example embodiment of the present disclosure may include a first side coupling member 321a, a second side coupling member 321b, a third side coupling member 321c, and a fourth side coupling member 321d.

The first side coupling member (or a 1-1^{th} coupling member) 321a may be disposed in a first edge portion PP1, which is adjacent to a first short side, of the vibration member 331. For example, the first side coupling member 321a may be disposed in an entire region of the first edge portion PP1 of the vibration member 331.

The second side coupling member (or a 1-2^{th} coupling member) 321b may be disposed in a second edge portion PP2, which is adjacent to a second short side, of the vibration member 331. For example, the second side coupling member 321b may be disposed in an entire region of the second edge portion PP2 of the vibration member 331.

The third side coupling member (or a 1-3^{th} coupling member) 321c may be disposed in a third edge portion PP3, which is adjacent to a first long side, of the vibration member 331 among the second region A2 of the vibration member 331. For example, the third side coupling member 321c may be disposed in an entire region of the second region A2 among the third edge portion PP3 of the vibration member 331.

The fourth side coupling member (or a 1-4^{th} coupling member) 321d may be disposed in a fourth edge portion PP4, which is adjacent to a second long side, of the vibration member 331 among the second region A2 of the vibration member 331. For example, the fourth side coupling member 321d may be disposed in an entire region of the second region A2 among the fourth edge portion PP4 of the vibration member 331.

According to another example embodiment of the present disclosure, the coupling member 320 may not be disposed in the first region A1 of each of the third and fourth edge portions PP3 and PP4 of the vibration member 331, and thus, the first region A1 of the vibration member 331 may be freely vibrated (or displaced) without being hindered (or restrained) by the coupling member 320 or the enclosure 310. Accordingly, in the first region A1 of the vibration member 331, the amount of displacement (or bending force) or the amplitude displacement (or vibration width) of the vibration member 331 in a long-side length direction of the vibration member 331 may increase or be maximized, and thus, a sound characteristic and/or a sound pressure level characteristic of a middle-low pitched sound band generated in the first region A1 of the vibration member 331 based on a vibration (or displacement) of the vibration apparatus 333 may be increased (or enhanced).

According to another example embodiment of the present disclosure, in the second region A2 of the vibration member 331, the coupling member 320 may be disposed in each of the third and fourth edge portions PP3 and PP4, and thus, the second region A2 of the vibration member 331 may be fixed (or restrained) to the coupling member 320 or the enclosure 310. Accordingly, in the second region A2 of the vibration member 331, the amount of displacement (or bending force) or an amplitude displacement (or vibration width) of the vibration member 331 in the long-side length direction may be limited (or configured) by the coupling member 320, and thus, a sound characteristic and/or a sound pressure level characteristic of a middle-high pitched sound band generated in the second region A2 of the vibration member 331 based on a vibration (or displacement) of the vibration apparatus 333 may be increased (or enhanced).

According to another example embodiment of the present disclosure, the vibration member 331 may output (or generate) a first sound (or first vibration) based on a vibration of the first region A1 and a second sound (or second vibration) based on a vibration of the second region A2. Due to a fixing structure based on the coupling member 320, a dip phenomenon may occur in a specific pitched sound band (or a specific frequency) generated (or output) based on a vibration of the vibration member 331. For example, the dip phenomenon may occur due to destructive inference between a vibration of the first region A1 and a vibration of the second region A2 occurring in a specific pitched sound band (or a specific frequency), due to a fixing structure based on the coupling member 320.

According to an example embodiment of the present disclosure, to prevent or minimize destructive inference between a vibration of the first region A1 and a vibration of the second region A2, the 1-1^{th} vibration apparatus 333a1 and the 1-2^{th} vibration apparatus 333a2 may be vibrated (or displaced or driven) by a same driving signal in a first pitched sound band and may be vibrated (or displaced or driven) by different driving signals in a second pitched sound band which differs from the first pitched sound band. For example, the 1-1^{th} vibration apparatus 333a1 and the 1-2^{th} vibration apparatus 333a2 may be vibrated (or displaced or driven) by a driving signal having a same phase in the first pitched sound band. For example, the 1-1^{th} vibration apparatus 333a1 and the 1-2^{th} vibration apparatus 333a2 may be vibrated (or displaced or driven) by a driving signal having phases (or antiphase) opposite to each other in the second pitched sound band.

According to an example embodiment of the present disclosure, the first pitched sound band may be a low-pitched sound band and a high-pitched sound band. The first pitched sound band may include a frequency of about 100 Hz or less and a frequency of about 700 Hz or more, but example embodiments of the present disclosure are not limited thereto. The second pitched sound band may be a middle-pitched sound band. For example, the second pitched sound band may include a frequency of about 100 Hz to 700 Hz, but example embodiments of the present disclosure are not limited thereto. For example, the second pitched sound band may include a specific pitched sound band (or a specific frequency) where destructive inference occurs between a vibration of the first region A1 and a vibration of the second region A2.

According to an example embodiment of the present disclosure, in a driving circuit part for applying a driving signal to the vibration apparatus 333, when a frequency of a driving signal to be supplied to the vibration apparatus 333 is included in the first pitched sound band, the driving circuit part may apply a driving signal having the same phase to the 1-1^{th} vibration apparatus 333a1 and the 1-2^{th} vibration apparatus 333a2. In addition, when a frequency of a driving signal to be supplied to the vibration apparatus 333 is included in the second pitched sound band, the driving circuit part may apply a driving signal having an antiphase to the 1-1^{th} vibration apparatus 333a1 and the 1-2^{th} vibration apparatus 333a2. Accordingly, destructive inference between a vibration of the first region A1 and a vibration of the second region A2 and a dip phenomenon caused by destructive inference may be prevented or minimized by antiphase driving of the 1-1^{th} vibration apparatus 333a1 and the 1-2^{th} vibration apparatus 333a2.

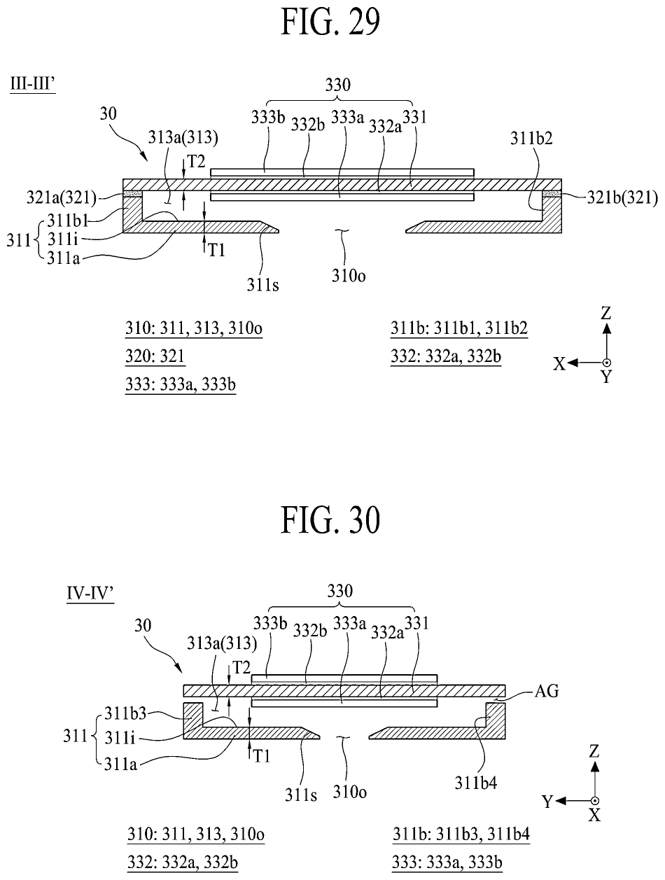

FIG. 28 is a perspective view of a sound apparatus according to another example embodiment of the present disclosure. FIG. 29 is a cross-sectional view taken along line III-III′ illustrated in FIG. 28 according to an example embodiment of the present disclosure. FIG. 30 is a cross-sectional view taken along line IV-IV′ illustrated in FIG. 28 according to an example embodiment of the present disclosure. For example, FIGS. 28 to 30 illustrate an example embodiment implemented by modifying the enclosure in the sound apparatus 30 described above with reference to FIGS. 3 to 27. In the following description, therefore, the enclosure will be described in detail, the other elements may be a same as or substantially the same as that of descriptions described above with reference to FIGS. 3 to 27, and thus, like reference numerals refer to like elements and its repeated descriptions are omitted or will be briefly given below. Therefore, descriptions above with reference to FIGS. 3 to 27 may be included in descriptions of FIGS. 28 to 30.

With reference to FIGS. 28 to 30, in a sound apparatus 30 according to another example embodiment of the present disclosure, the enclosure 310 may include a first enclosure 311. For example, the second enclosure 312 may be removed (or omitted) in the enclosure 310 described above with reference to FIGS. 3 to 27, and the enclosure 310 may be configured with only the first enclosure 311 including the first plate 311a, the first sidewall portion 311b, and the opening part 3100. For example, in a case where the enclosure 310 is configured with only the first enclosure 311, the first enclosure 311 may be an enclosure 310, the first plate 311a may be a plate, and the first sidewall portion 311b may be a sidewall portion, and thus, its repeated descriptions are omitted or will be briefly given below.

The enclosure 310 or the first enclosure 311 may be connected to a sound generating module 330 with the internal space 313 therebetween. The enclosure 310 or the first enclosure 311 may be connected to the rear edge portion of the vibration member 331 with the internal space 313 therebetween.

According to another example embodiment of the present disclosure, the vibration member 331 may be configured to cover the internal space 313 of the first enclosure 311. For example, the vibration member 331 may be configured to cover a portion of the internal space 313 of the first enclosure 311. The vibration member 331 may be configured to cover the first space 313a of the first enclosure 311. For example, the vibration member 331 may be configured to cover a portion of the first space 313a of the first enclosure 311.

The enclosure 310 or the first enclosure 311 may be connected (or coupled) to the vibration member 331 of the sound generating module 330 by the coupling member 320 or the first coupling member 321. The descriptions of the coupling member 320 or the first coupling member 321 may be substantially a same as that of the coupling member 320 or the first coupling member 321 described above with reference to FIGS. 3 to 27, and thus, like reference numerals refer to like elements and its repeated descriptions are omitted or will be briefly given below.

In a case where the enclosure 310 is configured with only the first enclosure 311, the sound apparatus 30 may be slimmed down, and a sound characteristic and/or a sound pressure level characteristic of the sound apparatus 30 may be more enhanced than a case where the enclosure 310 is configured with the first enclosure 311 and the second enclosure 312. For example, in a case where the enclosure 310 is configured with only the first enclosure 311, a sound characteristic and/or a sound pressure level characteristic of a middle-low-pitched sound band (for example, a pitched sound band of 3 kHz or less) may be more enhanced, and a sound reproduction band may be more expanded.

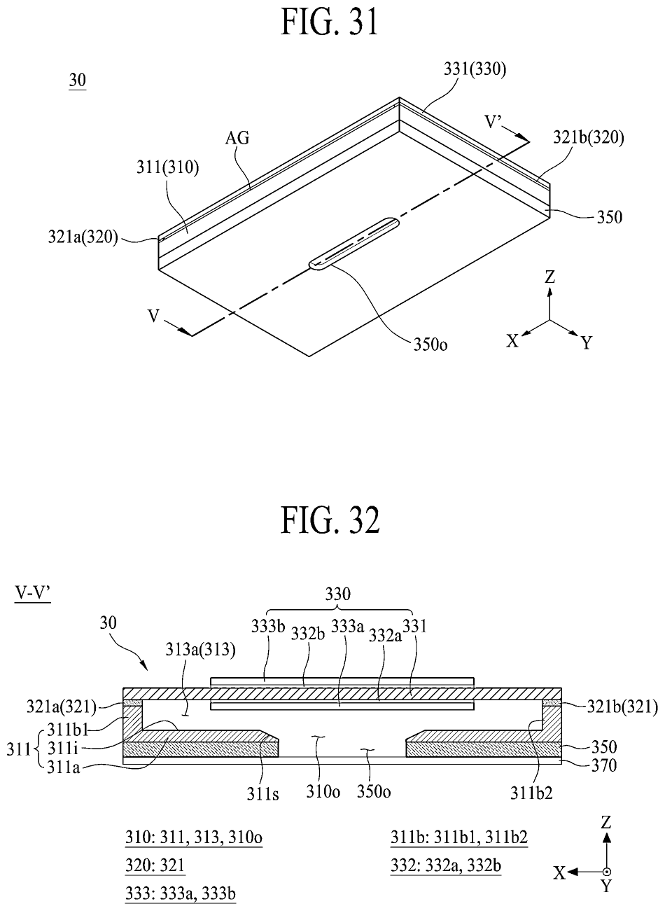

FIG. 31 is a perspective view of a sound apparatus according to another example embodiment of the present disclosure. FIG. 32 is a cross-sectional view taken along line V-V′ illustrated in FIG. 31 according to an example embodiment of the present disclosure. For example, FIGS. 31 and 32 illustrate an example embodiment where a connection member is additionally configured in the sound apparatus 30 described above with reference to FIGS. 28 to 30. In the following description, therefore, the connection member will be described in detail, the other elements may be a same as or substantially the same as that of descriptions described above with reference to FIGS. 28 to 30, and thus, like reference numerals refer to like elements and its repeated descriptions are omitted or will be briefly given below. Therefore, descriptions above with reference to FIGS. 28 to 30 may be included in descriptions of FIGS. 31 and 32.

With reference to FIGS. 31 and 32, the sound apparatus 30 according to another example embodiment of the present disclosure may further include a connection member 350.

The connection member 350 may be provided or configured at a rear surface of the enclosure 310. The connection member 350 may be connected to (or disposed at) the rear surface of the enclosure 310. For example, the connection member 350 may be connected to (or disposed at) a rear surface of the first enclosure 311. The connection member 350 may be disposed between a mount object and the enclosure 310 (or first enclosure 311). For example, the mount object may be a structure with the sound apparatus 30 or the enclosure 310 mounted thereon. The connection member 350 may be a coupling member, an intermediate member, or a buffer member, but example embodiments of the present disclosure are not limited thereto.

The connection member 350 may be configured to transfer a vibration of the first enclosure 311 based on a vibration of the sound generating module 330 to the mount object. Accordingly, the mount object (or a vehicle interior material) may vibrate based on a vibration transferred through the connection member 350 to generate (or output) a sound.

According to another example embodiment of the present disclosure, the first enclosure 311 may include an inner surface 311i and an outer surface. The inner surface 311i of the first enclosure 311 may face a vibration member 331. The outer surface of the first enclosure 311 may be a surface which is opposite to the inner surface 311i of the first enclosure 311. The connection member 350 may be connected to a periphery of an opening part 3100 of the outer surface of the first enclosure 311. For example, the connection member 350 may be connected between the mount object (or vehicle interior material) and the periphery of an opening part 3100 of the outer surface of the first enclosure 311.

According to another example embodiment of the present disclosure, the connection member 350 may be configured as a stiff material (or a hard material). The connection member 350 may have high elasticity (or a Young's modulus) and may include a material which is high in tensile strength. For example, the connection member 350 may include rubber, but example embodiments of the present disclosure are not limited thereto. For example, the rubber may be ethylene propylene rubber or urethane rubber, but example embodiments of the present disclosure are not limited thereto. For example, the ethylene propylene rubber may be ethylene propylene diene monomer (EPDM), but example embodiments of the present disclosure are not limited thereto. For example, a hardness of the EPDM may be 40 to 90, but example embodiments of the present disclosure are not limited thereto. For example, a tensile strength of the EPDM may be 50 kg/cm² to 200 kg/cm², but example embodiments of the present disclosure are not limited thereto.

According to an example embodiment of the present disclosure, the connection member 350 may further include a hole 3500. For example, the connection member 350 may further include a hole 3500 which is connected to the opening part 3100 in the enclosure 310 or the first enclosure 311. The hole 3500 may be disposed to correspond to (or overlap) the opening part 3100. Accordingly, a sound based on a vibration of the sound generating module 330 may be output to an outside of the enclosure 310 or to an interior space of a vehicle through the opening part 3100 and the hole 3500. The hole 3500 may have a same shape as the opening part 3100, but example embodiments of the present disclosure are not limited thereto. For example, the hole 3500 may be an opening part, an opening hole, a slit, a slot, a connection hole, or an intermediate hole, but example embodiments of the present disclosure are not limited thereto.

According to an example embodiment of the present disclosure, the connection member 350 may be protected by a release film (or a protection film) 370. The release film 370 may be attached to an adhesive surface of the connection member 350. In a case where the sound apparatus 30 including the connection member 350 is mounted on the vehicle interior material (or the mount object), the release film 370 may be released (or removed) from the connection member 350.

The connection member 350 described above with reference to FIGS. 31 and 32 may be identically applied to the sound apparatus 30 described above with reference to FIGS. 3 to 30. For example, the connection member 350 may be disposed (or configured) in the rear surface of the enclosure 310 of the sound apparatus 30 described above with reference to FIGS. 3 to 30, and thus, its repeated descriptions are omitted.

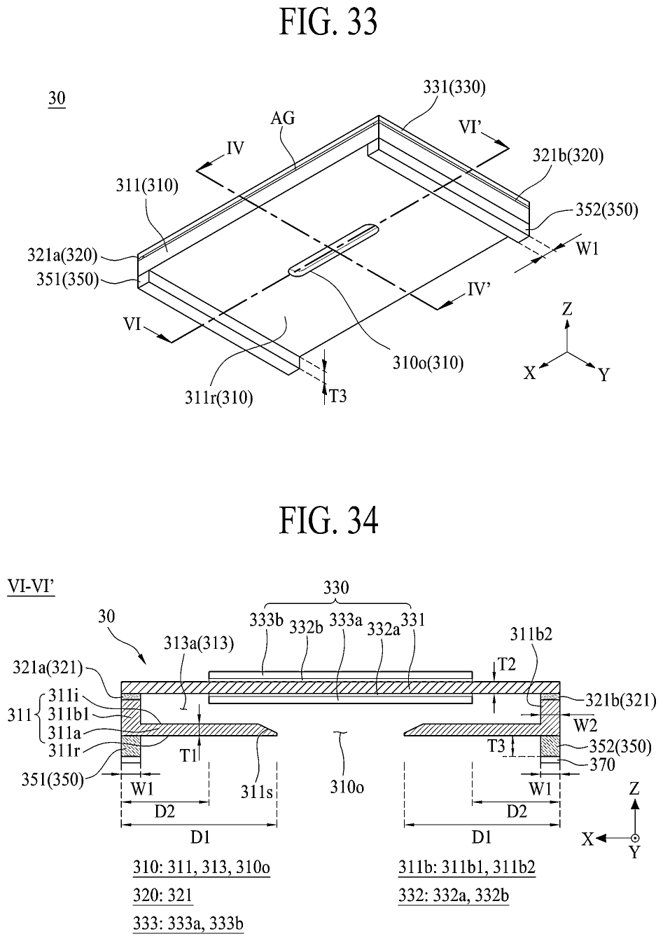

FIG. 33 is a perspective view of a sound apparatus according to another example embodiment of the present disclosure. FIG. 34 is a cross-sectional view taken along line VI-VI′ illustrated in FIG. 33 according to an example embodiment of the present disclosure. A cross-sectional view taken along line IV-IV′ illustrated in FIG. 33 is illustrated in FIG. 30. For example, FIGS. 33 and 34 illustrate an example embodiment implemented by modifying the connection member in the sound apparatus 30 described above with reference to FIGS. 31 and 32. In the following description, therefore, the connection member 350 will be described in detail, the other elements may be a same as or substantially the same as that of descriptions described above with reference to FIGS. 31 and 32, and thus, like reference numerals refer to like elements and its repeated descriptions are omitted or will be briefly given below.

With reference to FIGS. 30, 33, and 34, in the sound apparatus 30 according to another example embodiment of the present disclosure, the connection member 350 may be configured to enhance a sound characteristic and/or a sound pressure level characteristic of a middle-low pitched sound band generated based on a vibration of the enclosure 310 (or first enclosure 311). For example, the connection member 350 may be configured to increase or maximize the amount of displacement (or bending force) or amplitude displacement (or vibration width) of the enclosure 310 (or first enclosure 311). For example, the connection member 350 may be configured (or disposed) not to hinder (or restrain) a vibration (or displacement) at a center portion including a center of the enclosure 310 (or first enclosure 311) when the enclosure 310 (or first enclosure 311) is vibrating based on a vibration of the sound generating module 330. For example, the connection member 350 may be configured (or disposed) not to hinder (or restrain) a vibration (or displacement) in a long-side length direction of the enclosure 310 (or first enclosure 311).

The connection member 350 according to another example embodiment of the present disclosure may be configured to have a size (or an area) which is relatively smaller than that of the rear surface 311r of the enclosure 310 (or first enclosure 311), but example embodiments of the present disclosure are not limited thereto. For example, a total size (or total area) of the connection member 350 may be configured to have a size (or an area) which is relatively smaller than that of a total size (or total area) of the rear surface 311r of the enclosure 310 (or first enclosure 311), but example embodiments of the present disclosure are not limited thereto. For example, the total size (or total area) of the connection member 350 may be half or less of the total size (or total area) of the rear surface 311r of the enclosure 310 (or first enclosure 311), but example embodiments of the present disclosure are not limited thereto.

The connection member 350 according to another example embodiment of the present disclosure may be disposed at (or connected to) a portion of the rear surface 311r of the enclosure 310 (or first enclosure 311). For example, the connection member 350 may be partially disposed at (or connected to) the rear surface 311r of the enclosure 310 (or first enclosure 311).

The connection member 350 according to another example embodiment of the present disclosure may be disposed at (or connected to) an edge portion, except a center portion, of the rear surface 311r of the enclosure 310 (or first enclosure 311). For example, the connection member 350 may be disposed at (or connected to) the edge portion of the rear surface 311r of the enclosure 310 (or first enclosure 311) in parallel with the short side of the enclosure 310. For example, the connection member 350 may not overlap the center portion of the rear surface 311r of the enclosure 310 (or first enclosure 311).

According to an example embodiment of the present disclosure, the enclosure 310 (or first enclosure 311) may include a first rear edge portion adjacent to a first short side, a second rear edge portion adjacent to a second short side, a third rear edge portion adjacent to a first long side, a fourth rear edge portion adjacent to a second long side, and a center portion surrounded by the first to fourth rear edge portions. The connection member 350 may be configured (or disposed) at each of the first rear edge portion and the second rear edge portion of the enclosure 310 (or first enclosure 311). For example, the connection member 350 may be configured (or disposed) at each of the first rear edge portion and the second rear edge portion, except the third rear edge portion, the fourth rear edge portion, and the center portion, of the enclosure 310 (or first enclosure 311).

The connection member 350 according to another example embodiment of the present disclosure may include a first connection member 351 and a second connection member 352.

The first connection member 351 may be disposed at (or connected to) the first edge portion of the rear surface 311r of the enclosure 310 (or first enclosure 311) in parallel with the short side of the enclosure 310. For example, the first connection member 351 may be disposed at (or connected to) the first rear edge portion of the first plate 311a to overlap the first sidewall 311b1 of the first enclosure 311.

The second connection member 352 may be disposed at (or connected to) the second edge portion of the rear surface 311r of the enclosure 310 (or first enclosure 311) in parallel with the short side of the enclosure 310. For example, the second connection member 352 may be disposed at (or connected to) the second rear edge portion of the first plate 311a to overlap the second sidewall 311b2 of the first enclosure 311. For example, the first connection member 351 and the second connection member 352 may be parallel to each other with the opening part 3100 of the enclosure 310 therebetween.

According to an example embodiment of the present disclosure, with respect to the first direction X or the long-side length direction of the enclosure 310, a first width W1 of the connection member 350 or each of the first and second connection members 351 and 352 may be different from or equal to a second width W2 of the first sidewall 311b1 of the first enclosure 311. For example, the first width W1 of the connection member 350 or each of the first and second connection members 351 and 352 may be smaller than or equal to the second width W2 of the first sidewall 311b1 of the first enclosure 311, but example embodiments of the present disclosure are not limited thereto. For example, the first width W1 of the connection member 350 or each of the first and second connection members 351 and 352 may be greater than a first thickness T1 of the first plate 311a of the first enclosure 311, but example embodiments of the present disclosure are not limited thereto. A restraining force applied to a vibration (or displacement) in the long-side length direction of the enclosure 310 may decrease as the first width W1 of the connection member 350 or each of the first and second connection members 351 and 352 is reduced, and thus, the amount of displacement (or bending force) or amplitude displacement (or vibration width) of the enclosure 310 (or first enclosure 311) in the long-side length direction of the enclosure 310 (or first enclosure 311) may be increased or maximized.

According to an example embodiment of the present disclosure, in the first direction X or the long-side length direction of the enclosure 310, the first width W1 of the connection member 350 or each of the first and second connection members 351 and 352 may be smaller than a distance D1 between the opening part 3100 and an outer surface of the enclosure 310, but example embodiments of the present disclosure are not limited thereto. For example, the connection member 350 or each of the first and second connection members 351 and 352 may overlap the first sidewall portion 311b of the first enclosure 311 and may overlap the vibration apparatus 333. For example, a first side (or first end) of each of the first and second connection members 351 and 352 may be disposed to overlap the first sidewall portion 311b of the first enclosure 311. For example, the first side (or first end) of the first connection member 351 may be disposed to overlap the first sidewall 311b1 of the first enclosure 311. For example, the first side (or first end) of the second connection member 352 may be disposed to overlap the second sidewall 311b2 of the first enclosure 311. For example, a second side (or second end), which is opposite to the first side, of each of the first and second connection members 351 and 352 may overlap the vibration apparatus 333.

According to another example embodiment of the present disclosure, in the first direction X or the long-side length direction of the enclosure 310, the first width W1 of the connection member 350 or each of the first and second connection members 351 and 352 may be smaller than a distance D2 between the vibration apparatus 333 and the outer surface of the enclosure 310, but example embodiments of the present disclosure are not limited thereto. For example, the connection member 350 or each of the first and second connection members 351 and 352 may overlap the first sidewall portion 311b of the first enclosure 311 and may not overlap the vibration apparatus 333. For example, the first side (or first end) of each of the first and second connection members 351 and 352 may be disposed to overlap the first sidewall portion 311b of the first enclosure 311. The second side (or second end) of each of the first and second connection members 351 and 352 may not overlap the vibration apparatus 333. For example, the second side (or second end) of the first connection member 351 may overlap a region between the vibration apparatus 333 and the first sidewall 311b1 of the first enclosure 311. For example, the second side (or second end) of the second connection member 352 may overlap a region between the vibration apparatus 333 and the second sidewall 311b2 of the first enclosure 311.

According to another example embodiment of the present disclosure, in the first direction X or the long-side length direction of the enclosure 310, the first width W1 of the connection member 350 may be different from or equal to a width of the coupling member 320. For example, the first width W1 of the connection member 350 may be greater or smaller than the width of the coupling member 320, but example embodiments of the present disclosure are not limited thereto. For example, the first width W1 of the first connection member 351 of the connection member 350 may be equal to a width of the first coupling member 321 of the coupling member 320, but example embodiments of the present disclosure are not limited thereto. For example, the first width W1 of the first connection member 351 may be greater or smaller than the width of the first coupling member 321, but example embodiments of the present disclosure are not limited thereto. For example, the first width W1 of the second connection member 352 of the connection member 350 may be equal to a width of the second coupling member 322 of the coupling member 320, but example embodiments of the present disclosure are not limited thereto. For example, the first width W1 of the second connection member 352 may be greater or smaller than the width of the second coupling member 322, but example embodiments of the present disclosure are not limited thereto.

According to an example embodiment of the present disclosure, with a thickness direction of the enclosure 310 or a third direction Z (or vertical direction) perpendicular to the first direction X or the second direction Y, each of the first and second connection members 351 and 352 may be configured to have a third thickness (or height) T3.

According to an example embodiment of the present disclosure, the third thickness T3 of each of the first connection member 351 and the second connection member 352 may be greater than the first thickness T1 of the first plate 311a of the first enclosure 311, but example embodiments of the present disclosure are not limited thereto. For example, the third thickness T3 of each of the first connection member 351 and the second connection member 352 may be greater than the second thickness T2 of the vibration member 331, but example embodiments of the present disclosure are not limited thereto. For example, the third thickness T3 of each of the first connection member 351 and the second connection member 352 may be 1 mm to 3 mm, but example embodiments of the present disclosure are not limited thereto.

According to an example embodiment of the present disclosure, the connection member 350 or the first connection member 351 and the second connection member 352 may increase (or enlarge) a gap space between the enclosure 310 and the mount object, based on the third thickness T3, and thus, a sound characteristic and/or a sound pressure level characteristic in a specific frequency generated based on a vibration of the enclosure 310 may increase (or enhance). For example, as the gap space between the enclosure 310 and the mount object is increased by the connection member 350 or the first connection member 351 and the second connection member 352, a restraining force of the enclosure 310 applied to the mount object may decrease, and thus, a sound characteristic and/or a sound pressure level characteristic in a specific frequency (for example, 1 kHz) generated based on the vibration of the enclosure 310 may be increased (or enhanced).

The connection member 350 or the first connection member 351 and the second connection member 352 according to an example embodiment of the present disclosure may be configured in a same material as that of the connection member 350 described above with reference to FIGS. 31 and 32, and thus, its repeated descriptions are omitted.

According to an example embodiment of the present disclosure, the connection member 350 (or first and second connection members 351 and 352) may be protected by a release film (or a protection film) 370. The release film 370 may be attached to a rear surface (or an adhesive surface) of the connection member 350 (or first and second connection members 351 and 352). In a case where the sound apparatus 30 including the connection member 350 (or first and second connection members 351 and 352) is mounted on the mount object (or vehicle interior material), the release film 370 may be released (or removed) from the connection member 350 (or first and second connection members 351 and 352).

The connection member 350 or the first and second connection members 351 and 352 described above with reference to FIGS. 33 and 34 may be identically applied to the sound apparatus 30 described above with reference to FIGS. 3 to 30. For example, the connection member 350 or the first and second connection members 351 and 352 may be disposed (or configured) in the first rear edge portion and the second rear edge portion of the enclosure 310 (or first enclosure 311) described above with reference to FIGS. 3 to 30, and thus, its repeated descriptions are omitted.

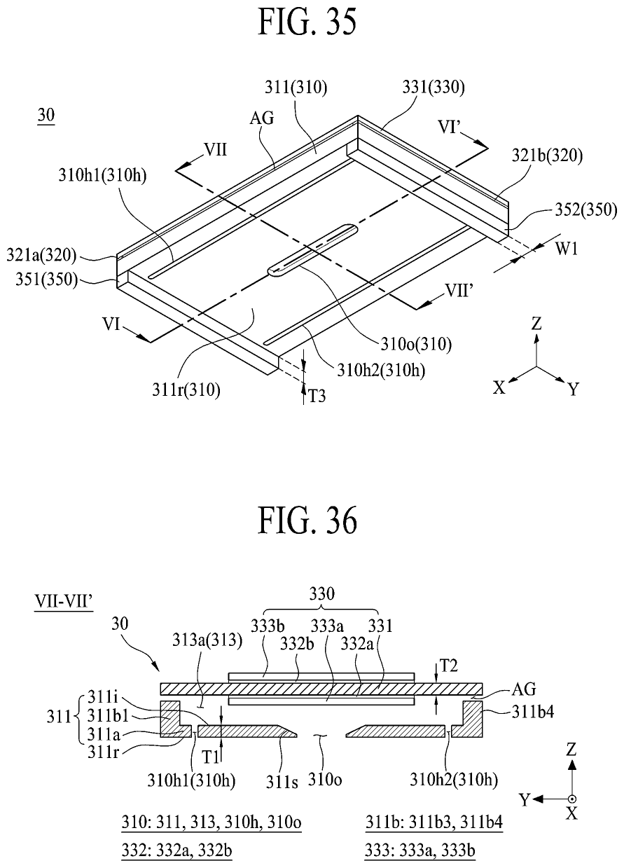

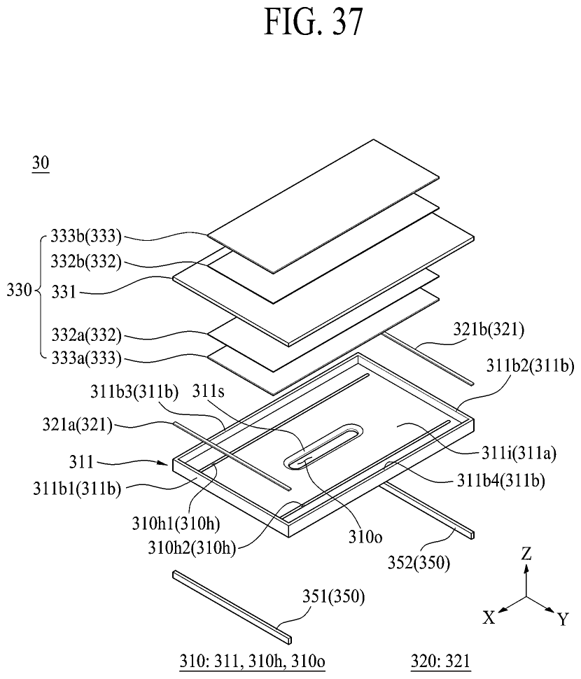

FIG. 35 is a perspective view of a sound apparatus according to another example embodiment of the present disclosure. FIG. 36 is a cross-sectional view taken along line VII-VII′ illustrated in FIG. 35 according to an example embodiment of the present disclosure. FIG. 37 is an exploded perspective view of a sound apparatus according to another example embodiment of the present disclosure. A cross-sectional view taken along line VI-VI′ illustrated in FIG. 35 is illustrated in FIG. 34. For example, FIGS. 35 to 37 illustrate an example embodiment where a plurality of holes are additionally configured in the sound apparatus 30 described above with reference to FIGS. 33 and 34. In the following description, therefore, the plurality of holes will be described in detail, the other elements may be a same as or substantially the same as that of descriptions described above with reference to FIGS. 33 and 34, and thus, like reference numerals refer to like elements and its repeated descriptions are omitted or will be briefly given below. Therefore, descriptions above with reference to FIGS. 33 and 34 may be included in descriptions of FIGS. 35 to 37.

With reference to FIGS. 34 to 37, a sound apparatus 30 or an enclosure 310 according to another example embodiment of the present disclosure may further include a plurality of holes 310h.

The plurality of holes 310h may be configured to increase or maximize the amount of displacement (or bending force) or amplitude displacement (or vibration width) of the enclosure 310 (or first enclosure 311). For example, the plurality of holes 310h may be configured to induce a resonance of the enclosure 310 (or the first enclosure 311). For example, the plurality of holes 310h may be configured to additionally increase (or enhance) a sound characteristic including a low-pitched sound band generated based on a vibration of the enclosure 310 (or the first enclosure 311). For example, the plurality of holes 310h may be configured to additionally increase (or enhance) a sound characteristic and/or a sound pressure level characteristic in 100 Hz to 200 Hz generated based on the vibration of the enclosure 310 (or the first enclosure 311).

According to an example embodiment of the present disclosure, the plurality of holes 310h may be configured (or formed) at the opening part 3100 of the enclosure 310 (or the first enclosure 311). The plurality of holes 310h may be configured (or formed) in parallel with each other with the opening part 3100 of the enclosure 310 therebetween. The plurality of holes 310h may extend along the first direction X or the long-side length direction of the enclosure 310. For example, the plurality of holes 310h may include a width (or a short-axis length) parallel to the second direction Y or the short-side length direction of the enclosure 310 and a length (or a long-axis length) parallel to the first direction X or the long-side length direction of the enclosure 310. For example, the length of each of the plurality of holes 310h may be longer than that the length of the opening part 3100 of the enclosure 310 and/or that of the length (or a long-side length) of the vibration apparatus 333, but example embodiments of the present disclosure are not limited thereto.

According to an example embodiment of the present disclosure, the plurality of holes 310h may be configured to pass through (or vertically pass through) the enclosure 310 (or the first enclosure 311) along the third direction Z (or vertical direction) or the thickness direction of the enclosure 310. For example, the plurality of holes 310h may be configured to pass through (or vertically pass through) the first plate 311a of the first enclosure 311. For example, the plurality of holes 310h may be a slit, a slot, an opening line, or a line hole, but example embodiments of the present disclosure are not limited thereto.

According to an example embodiment of the present disclosure, the plurality of holes 310h may be configured not to overlap the vibration apparatus 333. Therefore, a sound (or sound wave) generated based on a vibration (or displacement) of the vibration apparatus 333 may be transferred to the first plate 311a of the first enclosure 311 without being lost by the plurality of holes 310h, and the first enclosure 311 or the first plate 311a of the first enclosure 311 may vibrate by on a sound (or sound wave) transferred based on a vibration (or displacement) of the vibration apparatus 333 to output (or generate) a sound (or vibration).

The first enclosure 311 or the plurality of holes 310h according to an example embodiment of the present disclosure may include a first hole 310h1 and a second hole 310h2. For example, the first enclosure 311 according to an example embodiment of the present disclosure may include a pair of holes 310h1 and 310h2.

The first hole 310h1 may be configured (or formed) between the opening part 3100 and the first long side of the enclosure 310 (or first enclosure 311). For example, the first hole 310h1 may be configured (or formed) closer to the first long side of the enclosure 310 (or first enclosure 311) than the opening part 3100 of the enclosure 310, so as to increase or maximize a vibration region (or area) of the enclosure 310 (or first enclosure 311). For example, the first hole 310h1 may be configured (or formed) at the third rear edge portion of the enclosure 310 (or first enclosure 311).

The second hole 310h2 may be configured (or formed) between the opening part 3100 and the second long side of the enclosure 310 (or first enclosure 311). For example, the second hole 310h2 may be configured (or formed) closer to the second long side of the enclosure 310 (or first enclosure 311) than the opening part 3100 of the enclosure 310, so as to increase or maximize a vibration region (or area) of the enclosure 310 (or first enclosure 311). For example, the second hole 310h2 may be configured (or formed) at the fourth rear edge portion of the enclosure 310 (or first enclosure 311).

The first hole 310h1 and the second hole 310h2 may be parallel to the first direction X or the long-side length direction of the enclosure 310 with the opening part 3100 of the enclosure 310 therebetween. For example, the first hole 310h1 and the second hole 310h2 may have a symmetric structure with respect to the opening part 3100 of the enclosure 310. For example, a length direction of each of the first hole 310h1, the second hole 310h2, and the opening part 3100 of the enclosure 310 may each be parallel to the first direction X or the long-side length direction of the enclosure 310.

According to an example embodiment of the present disclosure, the width (or short-axis length) of each of the plurality of holes 310h or the first hole 310h1 and the second hole 310h2 may be 1 mm or more, but example embodiments of the present disclosure are not limited thereto. For example, the width (or short-axis length) of each of the plurality of holes 310h or the first hole 310h1 and the second hole 310h2 may be 1 mm to 5 mm to reduce or minimize the inflow of dust or particles from the outside, but example embodiments of the present disclosure are not limited thereto.

The first hole 310h1 and the second hole 310h2 may be between the first connection member 351 and the second connection member 352 of the connection member 350. For example, each of the first hole 310h1 and the second hole 310h2 may overlap or not overlap the connection member 350 along the first width W1 of the connection member 350. For example, an end of each of the first hole 310h1 and the second hole 310h2 may be spaced apart from the connection member 350.

According to an example embodiment of the present disclosure, the enclosure 310 (or first enclosure 311) may be separated from an edge portion by each of the first hole 310h1 and the second hole 310h2, and thus, the amount of displacement (or bending force) or amplitude displacement (or vibration width) based on a vibration of the sound generating module 330 or the vibration apparatus 333 may be increased, and thus, a sound characteristic and/or a sound pressure level characteristic of a sound including a low-pitched sound band may be more enhanced.

The connection member 350 (or first and second connection members 351 and 352) and the plurality of holes 310h described above with reference to FIGS. 34 to 37 may be identically applied to the sound apparatus 30 described above with reference to FIGS. 3 to 30, and thus, its repeated descriptions are omitted.

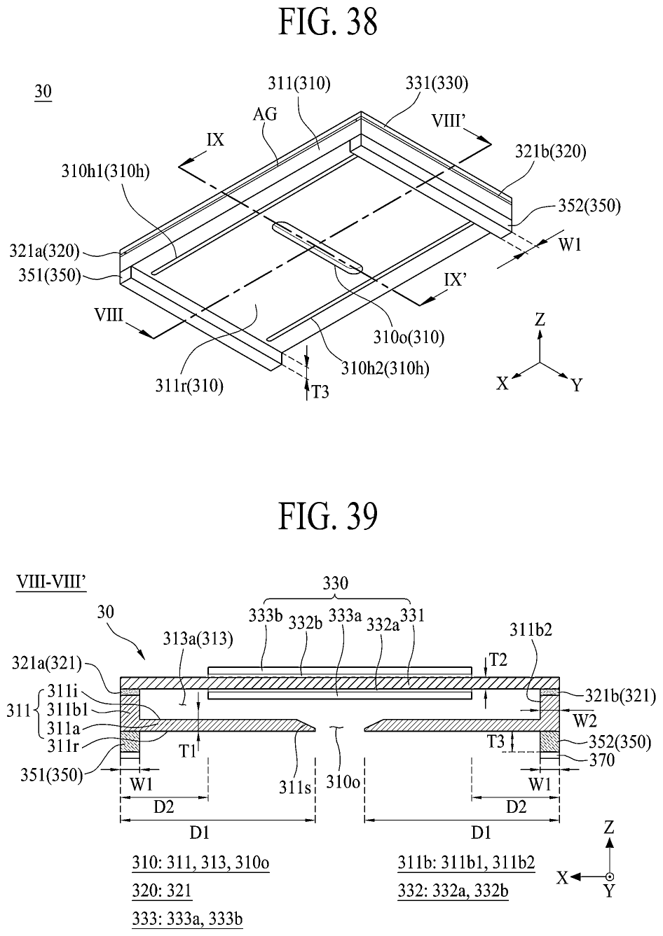

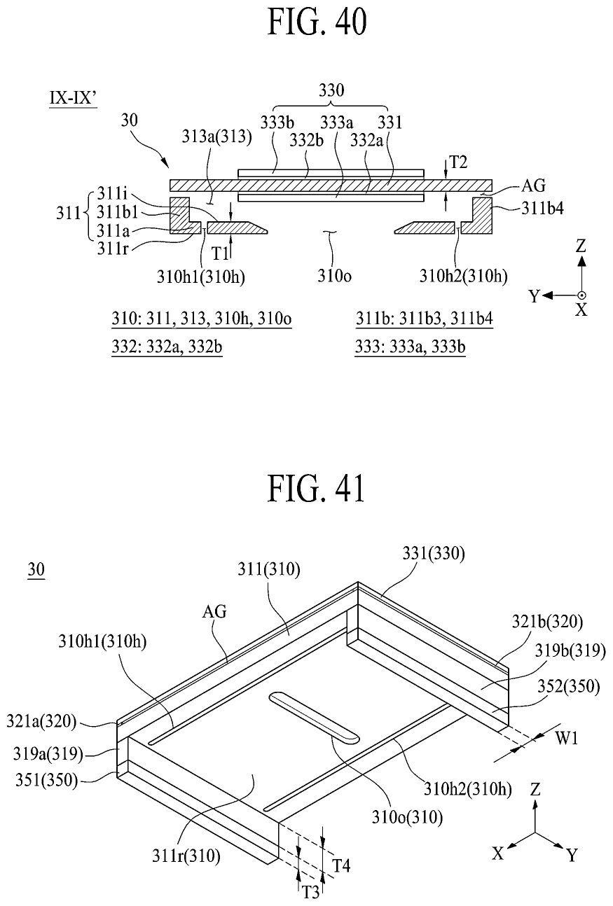

FIG. 38 is a perspective view of a sound apparatus according to another example embodiment of the present disclosure. FIG. 39 is a cross-sectional view taken along line VIII-VIII′ illustrated in FIG. 38 according to an example embodiment of the present disclosure. FIG. 40 is a cross-sectional view taken along line IX-IX′ illustrated in FIG. 38 according to an example embodiment of the present disclosure. For example, FIGS. 38 to 40 illustrate an example embodiment implemented by modifying the opening part 3100 of the enclosure 310 in the sound apparatus 30 described above with reference to FIGS. 34 to 37. In the following description, therefore, the opening part 3100 of the enclosure 310 will be described in detail, the other elements may be a same as or substantially the same as that of descriptions described above with reference to FIGS. 34 to 37, and thus, like reference numerals refer to like elements and its repeated descriptions are omitted or will be briefly given below. Therefore, descriptions above with reference to FIGS. 34 to 37 may be included in descriptions of FIGS. 38 to 40.

With reference to FIGS. 38 to 40, in a sound apparatus 30 or an enclosure 310 according to another example embodiment of the present disclosure, an opening part 3100 may be configured (or formed) in parallel with a second direction Y or a short-side length direction of the enclosure 310. For example, the opening part 3100 may extend along the second direction Y or the short-side length direction of the enclosure 310. Therefore, except for that the opening part 3100 extends along the second direction Y or the short-side length direction of the enclosure 310, the opening part 3100 may be a same or substantially the same as the opening part 3100 described above with reference to FIGS. 34 to 37, and thus, its repeated descriptions may be omitted or briefly given below.

The opening part 3100 may be disposed to correspond to a center portion of the sound generating module 330 (or the vibration apparatus 333). For example, the opening part 3100 may include a line shape passing through the center portion of the sound generating module 330 (or the vibration apparatus 333) or may include a rectangular shape, but example embodiments of the present disclosure are not limited thereto. For example, a center portion of the opening part 3100 may be disposed to correspond to the center portion of the sound generating module 330 or the vibration apparatus 333. For example, the opening part 3100 may include a width (or a short-axis length) parallel to the first direction X or the long-side length direction of the enclosure 310 and a length (or a long-axis length) parallel to the second direction Y or the short-side length direction of the enclosure 310. For example, the length (or long-axis length) of the opening part 3100 may be smaller than the length (or short-side length) of the vibration apparatus 333, but example embodiments of the present disclosure are not limited thereto.

According to another example embodiment of the present disclosure, the opening part 3100 may be configured to extend along the second direction Y or the short-side length direction of the enclosure 310, and thus, a vibration region (or vibration area) of the enclosure 310 (or the first enclosure 311) spaced apart (or separated) from the first hole 310h1 and the second hole 310h2 may be increased. Accordingly, the amount of displacement (or bending force) or amplitude displacement (or vibration width) of the enclosure 310 (or the first enclosure 311) based on a vibration of the sound generating module 330 (or the vibration apparatus 333) may be more increased, and thus, a sound characteristic and/or a sound pressure level characteristic of a sound including a low-pitched sound band may be more enhanced.

The connection member 350 (or first and second connection members 351 and 352), the plurality of holes 310h, and the opening part 3100 described above with reference to FIGS. 34 to 40 may be identically applied to the sound apparatus 30 described above with reference to FIGS. 3 to 30, and thus, its repeated descriptions are omitted.

FIG. 41 is a perspective view of a sound apparatus according to another example embodiment of the present disclosure. For example, FIG. 41 illustrates an example embodiment where a gap member is additionally configured in the sound apparatus 30 described above with reference to FIGS. 38 to 40. In the following description, therefore, the gap member will be described in detail, the other elements may be a same as or substantially the same as that of descriptions described above with reference to FIGS. 38 to 40, and thus, like reference numerals refer to like elements and its repeated descriptions are omitted or will be briefly given below. Therefore, descriptions above with reference to FIGS. 38 to 40 may be included in descriptions of FIG. 41.

With reference to FIG. 41, the sound apparatus 30 according to another example embodiment of the present disclosure may further include a gap member 319 between the enclosure 310 and the connection member 350.

The gap member 319 may be configured (or disposed) to additionally increase a gap space between the enclosure 310 and the mount object. The gap member 319 may be disposed (or interposed) between the connection member 350 and the rear surface 311r of the enclosure 310 (or first enclosure 311). For example, the gap member 319 may be disposed (or interposed) between the connection member 350 and the rear surface 311r of the enclosure 310 (or first enclosure 311) and may thus increase the gap space between the enclosure 310 and the mount object. For example, the gap member 319 may be a block member, a gap block member, a pad member, or a gap pad member, but example embodiments of the present disclosure are not limited thereto.

The gap member 319 may include a same or different material as the connection member 350. For example, the gap member 319 may be configured in a relatively stiff material (or a hard material) than that of the connection member 350, but example embodiments of the present disclosure are not limited thereto.

The gap member 319 may have a first width W1 which is a same as that of the first width W1 of the connection member 350, but example embodiments of the present disclosure are not limited thereto. The gap member 319 may have a fourth thickness (or height) T4 different from the third thickness T3 of the connection member 350, but example embodiments of the present disclosure are not limited thereto. For example, the gap member 319 may have the fourth thickness T4 which is greater than the third thickness T3 of the connection member 350, but example embodiments of the present disclosure are not limited thereto. For example, the fourth thickness T4 of the gap member 319 may be 0.5 mm to 2 mm, but example embodiments of the present disclosure are not limited thereto.

According to an example embodiment of the present disclosure, the gap member 319 may be configured in a same material as that of the enclosure 310 (or first enclosure 311), but example embodiments of the present disclosure are not limited thereto. For example, the gap member 319 may protrude from the rear surface 311r of the enclosure 310 (or first enclosure 311) to have the first width W1 and the fourth thickness T4.

The gap member 319 may include a first gap member 319a and a second gap member 319b.

The first gap member 319a may be disposed (or interposed) between the first connection member 351 of the connection member 350 and the enclosure 310. The first gap member 319a may have a same first width W1 as that of the first width W1 of the first connection member 351, but example embodiments of the present disclosure are not limited thereto. The first gap member 319a may have the fourth thickness T4 which is thicker than the third thickness T3 of the first connection member 351, but example embodiments of the present disclosure are not limited thereto. For example, the first gap member 319a may protrude from the rear surface 311r of the enclosure 310 (or first enclosure 311) to have the first width W1 and the fourth thickness T4.

The second gap member 319b may be disposed (or interposed) between the second connection member 352 of the connection member 350 and the enclosure 310. The second gap member 319b may have a same first width W1 as that of the first width W1 of the second connection member 352, but example embodiments of the present disclosure are not limited thereto. The second gap member 319b may have the fourth thickness T4 which is thicker than the third thickness T4 of the second connection member 352, but example embodiments of the present disclosure are not limited thereto. For example, the second gap member 319b may protrude from the rear surface 311r of the enclosure 310 (or first enclosure 311) to have the first width W1 and the fourth thickness T4.

According to an example embodiment of the present disclosure, the fourth thickness T4 of each of the gap member 319, or the first gap member 319a and the second gap member 319b may be 0.5 mm to 2 mm, but example embodiments of the present disclosure are not limited thereto.

The connection member 350 may be configured at (or connected to) the gap member 319. For example, the connection member 350 may be connected (or attached) to a rear surface of the gap member 319. The first connection member 351 of the connection member 350 may be connected (or attached) to the first gap member 319a. The second connection member 352 of the connection member 350 may be connected (or attached) to the second gap member 319b.

According to an example embodiment of the present disclosure, the gap member 319 and the connection member 350 may increase (or enlarge) the gap space between the enclosure 310 and the mount object, and thus, a sound characteristic and/or a sound pressure level characteristic in a specific frequency generated based on a vibration of the enclosure 310 may increase (or enhance). For example, as the gap space between the enclosure 310 and the mount object is increased by the gap member 319 and the connection member 350, a restraining force of the enclosure 310 applied to the mount object may decrease, and thus, a sound characteristic and/or a sound pressure level characteristic in a specific frequency (for example, 1 kHz) generated based on the vibration of the enclosure 310 may be increased (or enhanced).

The gap member 319 described above with reference to FIG. 41 may be disposed (or interposed) between the connection member 350 and the enclosure 310 (or first enclosure 311) described above with reference to FIGS. 33 to 37, and thus, its repeated descriptions are omitted.

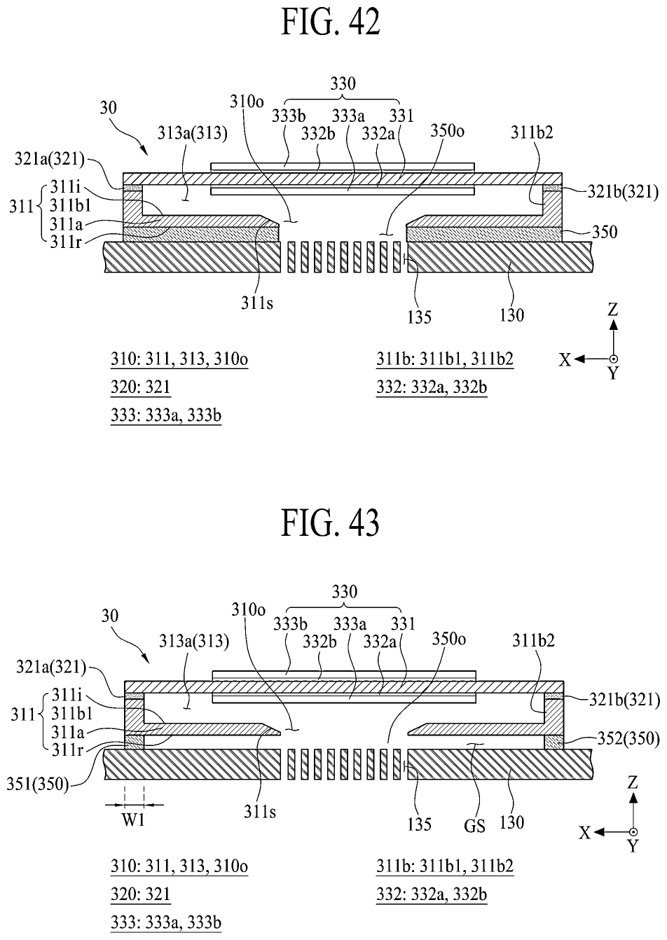

FIG. 42 is a diagram illustrating a sound apparatus according to another example embodiment of the present disclosure.

With reference to FIG. 42, the sound apparatus 30 according to another example embodiment of the present disclosure may be connected or coupled to (or mounted on) the vehicle interior material (or mount object) 130 by using a connection member 350.

The sound apparatus 30 may include an enclosure 310, a sound generating module 330, a coupling member 320, and the connection member 350. The descriptions of the enclosure 310, the sound generating module 330, the coupling member 320, and the connection member 350 may be substantially a same as that of the descriptions described above with reference to FIGS. 21 and 32, and thus, like reference numerals refer to like elements and its repeated descriptions are omitted or will be briefly given below.

The vehicle interior material 130 may be connected or coupled to the connection member 350 in the sound apparatus 30. For example, the vehicle interior material 130 may be connected or coupled to the enclosure 310 by the connection member 350. The connection member 350 may be disposed between an entire region of a rear surface 311r of the enclosure 310 and the vehicle interior material 130. For example, the connection member 350 may be disposed between the first enclosure 311 and the vehicle interior material 130. For example, the connection member 350 may be disposed between an entire region of the rear surface 311r of the first enclosure 311 and the vehicle interior material 130 other than the opening part 3100.

The connection member 350 may be configured to transfer a vibration of the enclosure 311 (or first enclosure 311) based on a vibration of the sound generating module 330 to the vehicle interior material 130. Accordingly, the vehicle interior material 130 may vibrate based on a vibration transferred through the connection member 350 to generate (or output) a sound. For example, the vehicle interior material 130 may be used as a vibration plate for generating (or outputting) sound.

According to an example embodiment of the present disclosure, the vehicle interior material 130 may further include one or more holes 135.

The one or more holes 135 may correspond to (or overlap) the hole 3500 of the connection member 350 and the opening part 3100 of the enclosure 310 (or the first enclosure 311). For example, the one or more holes 135 may have a size which is greater than or equal to each of the hole 3500 and the opening part 3100, but example embodiments of the present disclosure are not limited thereto. For example, the one or more holes 135 may be a through hole, an opening part, an opening hole, a slit, a slot, a sound hole, a sound emission hole, or a sound output hole, but example embodiments of the present disclosure are not limited thereto.

According to an example embodiment of the present disclosure, a sound based on a vibration of the sound generating module 330 may be output to an interior space of a vehicle through the one or more holes 135 of the vehicle interior material 130, the hole 3500 of the connection member 350, and the opening part 3100 of the enclosure 310. In addition, the enclosure 310 (or first enclosure 311) may vibrate by a sound (or a sound wave) generated based on the vibration of the sound generating module 330, and the vehicle interior material 130 may vibrate based on a vibration of the enclosure 310 (or first enclosure 311) transferred through the connection member 350 to generate (or output) a sound.

In FIG. 42, the enclosure 310 is illustrated as being configured with only the first enclosure 311, but is not limited thereto and may include the second enclosure 312 described above with reference to FIGS. 3 to 6, and thus, its repeated descriptions are omitted. For example, the sound apparatus 30 illustrated in FIG. 42 may be replaced with (or modified into) the sound apparatus 30 described above with reference to FIGS. 3 to 30, and thus, its repeated descriptions are omitted.

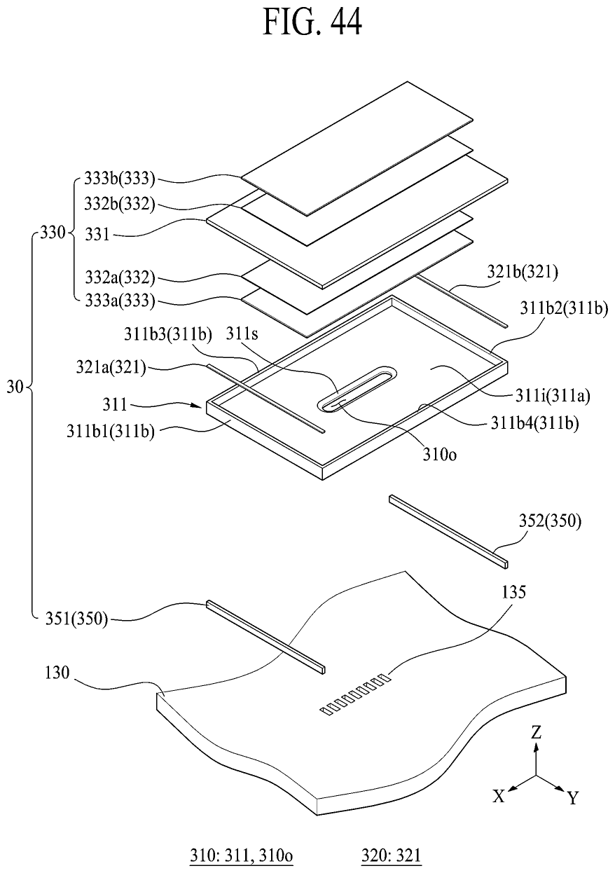

FIG. 43 is a diagram illustrating a sound apparatus according to another example embodiment of the present disclosure. FIG. 44 is an exploded perspective view of a sound apparatus illustrated in FIG. 43 according to an example embodiment of the present disclosure.

With reference to FIGS. 43 and 44, the sound apparatus 30 according to another example embodiment of the present disclosure may be connected or coupled to (or mounted on) the vehicle interior material (or mount object) 130 by using a connection member 350.

The sound apparatus 30 may include an enclosure 310, a sound generating module 330, and a connection member 350. The descriptions of the enclosure 310, the sound generating module 330, and the connection member 350 may be substantially a same as that of the descriptions described above with reference to FIGS. 33 to 41, and thus, like reference numerals refer to like elements and its repeated descriptions are omitted or will be briefly given below.

The vehicle interior material 130 may be connected or coupled to the connection member 350 in the sound apparatus 30. For example, the vehicle interior material 130 may be connected or coupled to the enclosure 310 by the connection member 350. The connection member 350 may be disposed between the enclosure 310 and the vehicle interior material 130. For example, the connection member 350 may be disposed between the first enclosure 311 and the vehicle interior material 130.

According to an example embodiment of the present disclosure, the vehicle interior material 130 may further include one or more holes 135.

The one or more holes 135 may correspond to (or overlap) the opening part 3100 of the enclosure 310 (or the first enclosure 311). For example, the one or more holes 135 may have a size which is greater than or equal to the opening part 3100, but example embodiments of the present disclosure are not limited thereto. For example, the one or more holes 135 may be a through hole, an opening part, an opening hole, a slit, a slot, a sound hole, a sound emission hole, or a sound output hole, but example embodiments of the present disclosure are not limited thereto.

According to an example embodiment of the present disclosure, a sound based on a vibration of the sound generating module 330 may be output to an interior space of a vehicle through the opening part 3100 and the one or more holes 135.

The sound apparatus 30 or the enclosure 310 may be connected or coupled to the vehicular interior material 130 by the connection member 350. The vehicular interior material 130 may be connected or coupled to the first connection member 351 and a second connection member 352 of the connection member 350. Therefore, the vehicular interior material 130 may be connected or coupled to first and second rear edge portions of the enclosure 310 (or first enclosure 311) by using the first connection member 351 and the second connection member 352.

The connection member 350 (or the first and second connection members 351 and 352) may provide a gap space GS between a center portion of the sound apparatus 30 (or the enclosure 310) and the vehicular interior material 130. The connection member 350 (or the first and second connection members 351 and 352) may be parallel to each other with the gap space GS and one or more holes 135 of the vehicular interior material 130 therebetween. The vehicular interior material 130 may be connected or coupled to the connection member 350 and may be spaced apart from the center portion of the sound apparatus 30 (or the enclosure 310). For example, the one or more holes 135 in the vehicular interior material 130 may be spaced apart from the rear surface 311r of the sound apparatus 30 (or the enclosure 310). For example, a rear center portion of the sound apparatus 30 (or the enclosure 310) may face or directly face the vehicular interior material 130 with the gap space GS therebetween. For example, the one or more holes 135 in the vehicular interior material 130 may be spaced apart from the rear surface 311r of the first enclosure 311.

According to an example embodiment of the present disclosure, the connection member 350 is configured in a relatively stiff material (or a hard material), and thus, may transfer a vibration of the first enclosure 311, based on a vibration of a vibration apparatus 333, to the vehicle interior material 130. Accordingly, the vehicle interior material 130 may vibrate based on a vibration transferred through the connection member 350 to generate a sound. For example, when the connection member 350 is configured in the relatively stiff material (or the hard material), the vehicle interior material 130 connected to the connection member 350 may be a vibration plate for generating (or outputting) a sound. For example, when the connection member 350 is configured in the relatively stiff material (or the hard material), a vibration of the first enclosure 311 may be transferred to the vehicle interior material 130 more efficiently.

According to an example embodiment of the present disclosure, the vehicular interior material 130 may vibrate based on a vibration of the enclosure 310 (or first enclosure 311) transferred through the connection member 350 connected (or coupled) to a portion (or both edge portions) of the enclosure 310 (or first enclosure 311) and may thus output a sound to an indoor space of a vehicle. Therefore, a sound may be generated based on a vibration of the vehicular interior material 130 having a size which is greater than that of the enclosure 310 (or first enclosure 311) and an increase in the amount of displacement (or bending force) or amplitude displacement (or vibration width) of the enclosure 310 (or first enclosure 311), and thus, a sound characteristic and/or a sound pressure level characteristic of a pitched sound band including a middle-low pitched sound band generated by driving (or vibration) of the sound apparatus 30 may be enhanced.

The sound apparatus 30 described above with reference to FIGS. 43 and 44 may be replaced with (or modified into) the sound apparatus 30 described above with reference to FIG. 41, and thus, its repeated descriptions are omitted. For example, when the sound apparatus 30 described above with reference to FIGS. 43 and 44 is replaced with (or modified into) the sound apparatus 30 described above with reference to FIG. 41, a distance (or gap) between the enclosure 310 and the vehicular interior material 130 may be increased by one or more of the connection member 350 and the gap member 319, and thus, a sound characteristic and/or a sound pressure level characteristic in a specific frequency (for example, 1 kHz) generated based on a vibration of the enclosure 310 may be increased (or enhanced).

In FIGS. 43 and 44, the enclosure 310 is illustrated as being configured with only the first enclosure 311, but is not limited thereto and may include the second enclosure 312 described above with reference to FIGS. 3 to 6, and thus, its repeated descriptions are omitted. For example, the sound apparatus 30 illustrated in FIGS. 43 and 44 may be replaced with (or modified into) the sound apparatus 30 described above with reference to FIGS. 3 to 30, and thus, its repeated descriptions are omitted.

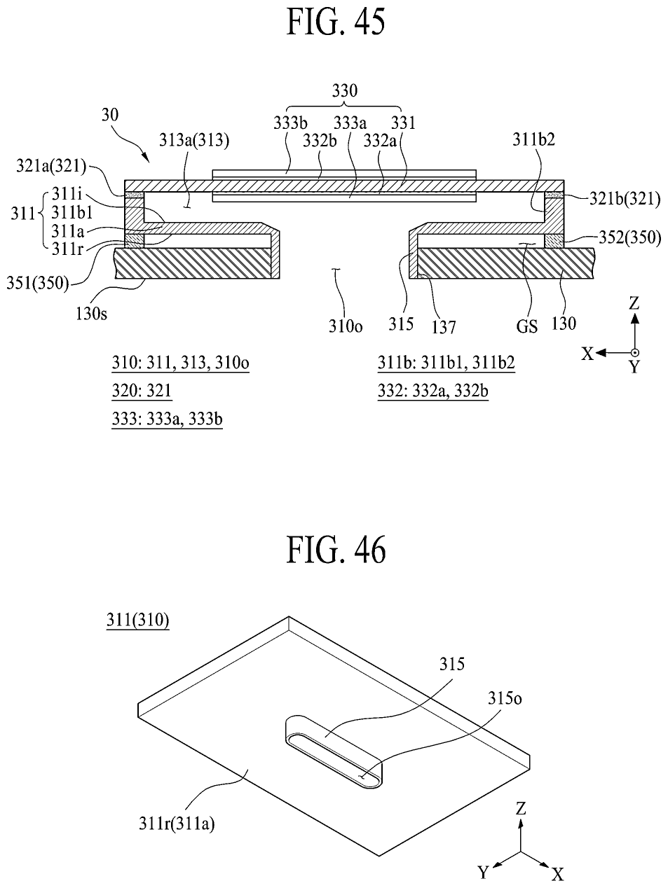

FIG. 45 is a cross-sectional view illustrating a sound apparatus according to another example embodiment of the present disclosure. FIG. 46 is a perspective view illustrating an enclosure illustrated in FIG. 45 according to an example embodiment of the present disclosure. FIGS. 45 and 46 illustrate an example embodiment where a protrusion part is additionally configured in the enclosure of the sound apparatus described above with reference to FIGS. 43 and 44.

With reference to FIGS. 45 and 46, the sound apparatus 30 according to another example embodiment of the present disclosure may include an enclosure 310, a sound generating module 330, and a connection member 350. The descriptions of the enclosure 310, the sound generating module 330, and the connection member 350 may be substantially a same as that of the descriptions described above with reference to FIGS. 33 to 41, and thus, like reference numerals refer to like elements and its repeated descriptions are omitted or will be briefly given below.

The sound apparatus 30 (or the enclosure 310) may be connected or coupled to the vehicular interior material 130 by the connection member 350. The connection member 350 or the first and second connection members 351 and 352 may provide a gap space GS between a center portion of the sound apparatus 30 (or the enclosure 310) and the vehicular interior material 130. The first connection member 351 and the second connection member 352 of the connection member 350 may be parallel to each other with the gap space GS therebetween. Therefore, the vehicular interior material 130 may be connected or coupled to the connection member 350 and may be spaced apart from the center portion of the sound apparatus 30 (or the enclosure 310). For example, a rear center portion of the sound apparatus 30 (or the enclosure 310) may face or directly face the vehicular interior material 130 with the gap space GS therebetween.

The vehicle interior material 130 may include a first surface and a second surface different from (or opposite to) the first surface. The first surface may be a surface facing the enclosure 310. The vehicle interior material 130 may further include a hole 137. The vehicle interior material 130 may further include a hole 137 configured at the first surface and the second surface. For example, the hole 137 of the vehicle interior material 130 may be configured to pass through the first surface and the second surface.

The hole 137 may correspond to (or overlap) the opening part 3100 of the enclosure 310 (or the first enclosure 311). For example, the hole 137 may have a size which is greater than or equal to the opening part 3100. For example, the hole 137 may be a through hole, an opening part, an opening hole, a slit, a slot, a sound hole, a sound emission hole, or a sound output hole, but example embodiments of the present disclosure are not limited thereto.

According to an example embodiment of the present disclosure, the vehicle interior material 130 may vibrate based on a vibration of the enclosure 310 (or the first enclosure 311) transferred through the connection member 350 to output a sound toward an interior space of a vehicle.

According to another example embodiment of the present disclosure, the enclosure 310 (or the first enclosure 311) may be connected or coupled to the vehicle interior material 130 through the connection member 350 described above with reference to FIG. 42. For example, the vehicle interior material 130 may vibrate based on a vibration of the enclosure 310 (or the first enclosure 311) transferred through the connection member 350 which is disposed (or interposed) in an entire gap space GS between the sound apparatus 30 (or the enclosure 310) and the vehicle interior material 130, to output the sound toward the interior space of the vehicle.

The sound apparatus 30 or the enclosure 310 according to another example embodiment of the present disclosure may further include a protrusion part 315. The first enclosure 311 of the enclosure 310 may further include a protrusion part 315.

The protrusion part 315 may surround the opening part 3100 of the enclosure 310. For example, the protrusion part 315 may be configured to surround the opening part 3100. The protrusion part 315 may include an opening hole (or a hollow hole) 3150 corresponding (or connected) to the opening part 3100.

The protrusion part 315 may protrude from a rear surface (or an outer surface) 311r of the first enclosure 311 to have the opening hole 3150. The protrusion part 315 may protrude from a rear surface (or outer surface) 311r of the first plate 311a of the first enclosure 311 to surround the opening part 3100. For example, the protrusion part 315 may protrude from a rear surface (or outer surface) 311r of the first enclosure 311 or the first plate 311a to have the opening hole 3150.

A portion (or end portion) of the protrusion part 315 may be accommodated or inserted into the hole 137 of the vehicle interior material 130. For example, the hole 137 of the vehicle interior material 130 may accommodate the portion (or end portion) of the protrusion part 315. Accordingly, a sound based on a vibration of the sound generating module 330 may be output to an interior space of a vehicle through the hole 137 of the vehicle interior material 130 and the opening hole 3150 of the protrusion part 315.

The sound apparatus 30 according to another example embodiment of the present disclosure may further include a coupling part. The coupling part may be configured to fix the enclosure 310 mounted on the vehicle interior material 130. The vehicle interior material 130 may be disposed (or interposed) between the enclosure 310 (or the sound apparatus 30) and coupling part. For example, the coupling part may be connected (or coupled) or fastened to the protrusion part 315 (or the enclosure 310 or the sound apparatus 30) through the hole 137 of the vehicle interior material 130 at the interior space of the vehicle. For example, the coupling part may be connected (or coupled) or fastened to the protrusion part 315 (or the enclosure 310 or the sound apparatus 30) by a hook coupling scheme.

According to an example embodiment of the present disclosure, the enclosure 310 may include the protrusion part 315, and thus, the coupling part may be easily connected or coupled to the protrusion part 315. Accordingly, a connection process or a coupling process between the vehicle interior material 130 and the sound apparatus 30 may be simplified.

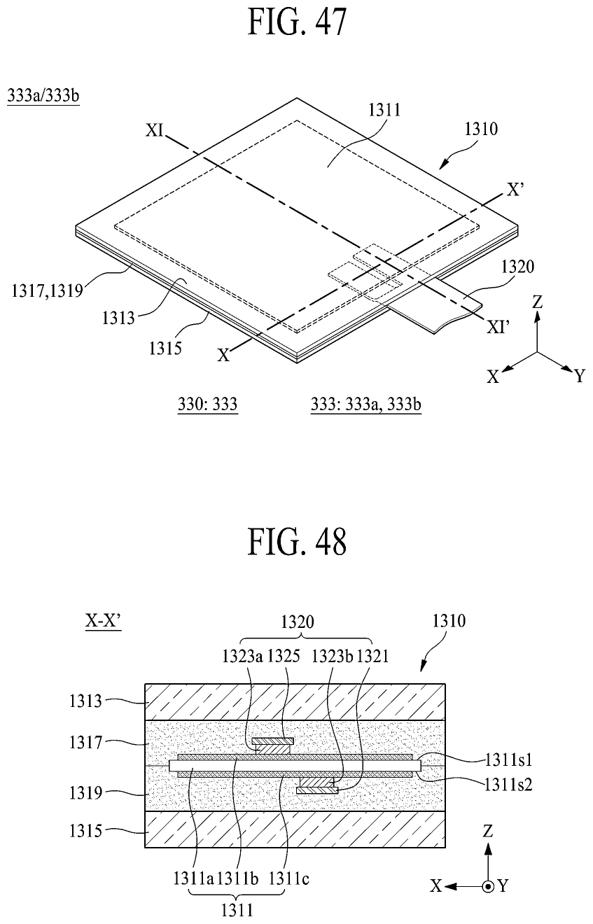

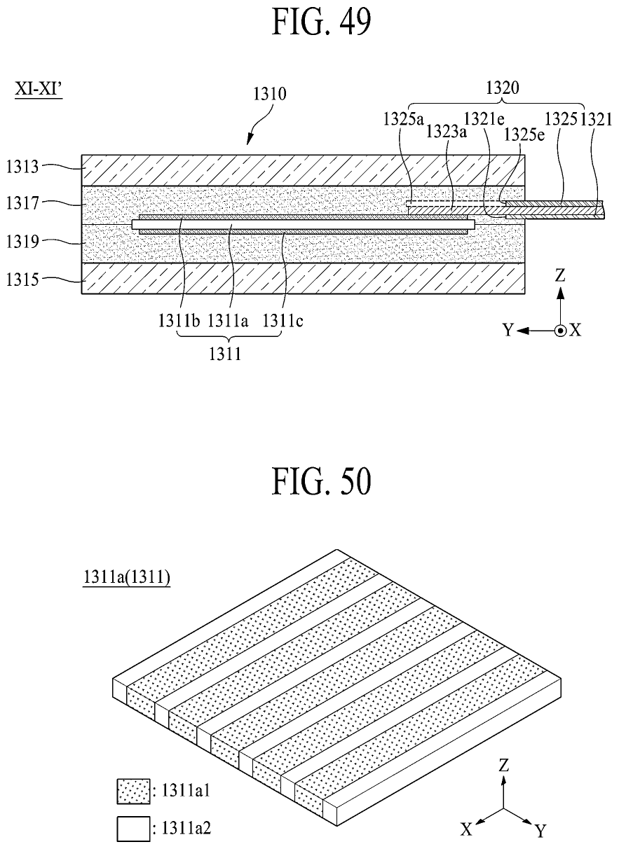

FIG. 47 is a diagram illustrating a vibration apparatus according to an example embodiment of the present disclosure. FIG. 48 is a cross-sectional view taken along line X-X′ illustrated in FIG. 47 according to an example embodiment of the present disclosure. FIG. 49 is a cross-sectional view taken along line XI-XI′ illustrated in FIG. 47 according to an example embodiment of the present disclosure.

With reference to FIGS. 47 to 49, in a sound generating module 330 according to an example embodiment of the present disclosure, a vibration apparatus 333 may include one or more vibration generators 1310. Each of a first vibration apparatus 333a and a second vibration apparatus 333b may include a vibration generator 1310.

The vibration generator 1310 may include a piezoelectric material having a piezoelectric characteristic. The vibration generator 1310 may vibrate (or displace or drive) a vibration member based on a vibration (or displacement or driving) of the piezoelectric material based on an electric signal (or a voice signal or a sound signal) applied to the piezoelectric material. For example, the vibration generator 1310 may alternately repeat contraction and/or expansion by a piezoelectric effect (or a piezoelectric characteristic) to vibrate (or displace or drive). For example, the vibration generator 1310 may vibrate (or displace or drive) in a vertical direction (or a thickness direction) Z as contraction and/or expansion are alternately repeated by an inverse piezoelectric effect. For example, in the vibration generator 1310, the piezoelectric material including a piezoelectric ceramic may vibrate or mechanically displace (or vibrate or drive) in response to an electrical signal applied from the outside.

The vibration generator 1310 may be configured as a ceramic-based piezoelectric material capable of implementing a relatively strong vibration, or may be configured as a piezoelectric ceramic having a perovskite-based crystal structure. For example, the vibration generator 1310 may be a vibration generating device, a vibration film, a vibration generating film, a vibrator, an active vibrator, an active vibration generator, an actuator, an exciter, a film actuator, a film exciter, an ultrasonic actuator, or an active vibration member, or the like, but example embodiments of the present disclosure are not limited thereto.

The vibration generator 1310 according to an example embodiment of the present disclosure may include a vibration generating part 1311.

The vibration generating part 1311 may be configured to vibrate by the piezoelectric effect based on a driving signal. For example, the vibration generating part 1311 may include a piezoelectric type vibration part. The vibration generating part 1311 may include at least one or more of a piezoelectric inorganic material and a piezoelectric organic material. For example, the vibration generating part 1311 may be a vibration device, a piezoelectric device, a piezoelectric device part, a piezoelectric device layer, a piezoelectric structure, a piezoelectric vibration part, or a piezoelectric vibration layer, or the like, but example embodiments of the present disclosure are not limited thereto.

The vibration generating part 1311 according to an example embodiment of the present disclosure may include a vibration part 1311a, a first electrode part 1311b, and a second electrode part 1311c.

The vibration part 1311a may include a piezoelectric material or an electroactive material which includes a piezoelectric effect. For example, the vibration part 1311a may be a piezoelectric layer, a piezoelectric material layer, an electroactive layer, a piezoelectric composite layer, a piezoelectric composite, or a piezoelectric ceramic composite, or the like, but example embodiments of the present disclosure are not limited thereto.

The vibration part 1311a may be configured as a ceramic-based material capable of implementing a relatively strong vibration, or may be configured as a piezoelectric ceramic having a perovskite-based crystalline structure. For example, the vibration part 1311a may include at least one or more of lead titanate (PbTiO₃), lead zirconate (PbZrO₃), lead zirconate titanate (PbZrTiO₃), barium titanate (BaTiO₃), and strontium titanate (SrTiO₃), but example embodiments of the present disclosure are not limited thereto.

The piezoelectric ceramic may be configured as a single crystalline ceramic having a crystalline structure, or may be configured as a ceramic material having a polycrystalline structure or polycrystalline ceramic. A piezoelectric material including the single crystalline ceramic may include α-AlPO₄, α-SiO₂, LiNbO₃, Tb₂(MoO₄)₃, Li₂B₄O₇, or ZnO, but example embodiments of the present disclosure are not limited thereto. A piezoelectric material including the polycrystalline ceramic may include a lead zirconate titanate (PZT)-based material, including lead (Pb), zirconium (Zr), and titanium (Ti), or may include a lead zirconate nickel niobate (PZNN)-based material, including lead (Pb), zirconium (Zr), nickel (Ni), and niobium (Nb), but example embodiments of the present disclosure are not limited thereto. For example, the vibration part 1311a may include at least one or more of calcium titanate (CaTiO₃), BaTiO₃, and SrTiO₃, without lead (Pb), but example embodiments of the present disclosure are not limited thereto.

The first electrode part 1311b may be disposed at a first surface (or an upper surface or a front surface) 1311s1 of the vibration part 1311a. The first electrode part 1311b may have a same size as that of the vibration part 1311a, or may have a size which is smaller than that of the vibration part 1311a, but example embodiments of the present disclosure are not limited thereto.

The second electrode part 1311c may be disposed at a second surface (or a lower surface or a rear surface) 1311s2 which is opposite to or different from the first surface 1311s1 of the vibration part 1311a. The second electrode part 1311c may have a same size as that of the vibration part 1311a, or may have a size which is smaller than that of the vibration part 1311a, but example embodiments of the present disclosure are not limited thereto. For example, the second electrode part 1311c may have a same shape as that of the vibration part 1311a, but example embodiments of the present disclosure are not limited thereto.

One or more of the first electrode part 1311b and the second electrode part 1311c according to an example embodiment of the present disclosure may be formed of a transparent conductive material, a semitransparent conductive material, or an opaque conductive material. For example, the transparent conductive material or the semitransparent conductive material may include indium tin oxide (ITO) or indium zinc oxide (IZO), but example embodiments of the present disclosure are not limited thereto. The opaque conductive material may include gold (Au), silver (Ag), platinum (Pt), palladium (Pd), molybdenum (Mo), magnesium (Mg), carbon, or silver (Ag) including glass frit, or the like, or may be made of an alloy thereof, but example embodiments of the present disclosure are not limited thereto. For example, to enhance an electrical characteristic and/or a vibration characteristic of the vibration part 1311a, each of the first electrode part 1311b and the second electrode part 1311c may include silver (Ag) having a low resistivity. For example, the carbon may include one or more of carbon black, ketjen black, carbon nanotube, and a carbon material including graphite, but example embodiments of the present disclosure are not limited thereto.

The vibration part 1311a may be polarized (or poling) by a certain voltage applied to the first electrode part 1311b and the second electrode part 1311c in a certain temperature atmosphere, or a temperature atmosphere that may be changed from a high temperature to a room temperature, but example embodiments of the present disclosure are not limited thereto. For example, a polarization direction (or a poling direction) formed in the vibration part 1311a may be formed or aligned (or arranged) from the first electrode part 1311b to the second electrode part 1311c, but example embodiments of the present disclosure are not limited thereto. For example, the polarization direction (or the poling direction) formed in the vibration part 1311a may be formed or aligned (or arranged) from the second electrode part 1311c to the first electrode part 1311b.

The vibration part 1311a may alternately and repeatedly contract and/or expand by an inverse piezoelectric effect based on a driving signal applied to the first electrode part 1311b and the second electrode part 1311c from the outside to vibrate. For example, the vibration part 1311a may vibrate in a vertical direction (or thickness direction) and in a planar direction by the signal applied to the first electrode part 1311b and the second electrode part 1311c. The vibration part 1311a may be displaced (or vibrated or driven) by contraction and/or expansion of the planar direction, thereby improving a vibration characteristic including a sound characteristic and/or a sound pressure level characteristic of the vibration generator 1310.

The vibration generator 1310 according to an example embodiment of the present disclosure may further include a first cover member 1313 and a second cover member 1315.

The first cover member 1313 may be disposed at a first surface of the vibration generating part 1311. For example, the first cover member 1313 may be configured to cover the first electrode part 1311b of the vibration generating part 1311. For example, the first cover member 1313 may be configured to have a larger size than that of the vibration generating part 1311, but example embodiments of the present disclosure are not limited thereto. The first cover member 1313 may be configured to protect the first surface of the vibration generating part 1311 and the first electrode part 1311b.

The second cover member 1315 may be disposed at a second surface of the vibration generating part 1311. For example, the second cover member 1315 may be configured to cover the second electrode part 1311c of the vibration generating part 1311. For example, the second cover member 1315 may be configured to have a greater size than that of the vibration generating part 1311 and may be configured to have a same size as that of the first cover member 1313, but example embodiments of the present disclosure are not limited thereto. The second cover member 1315 may be configured to protect the second surface of the vibration generating part 1311 and the second electrode part 1311c.

The first cover member 1313 and the second cover member 1315 according to an example embodiment of the present disclosure may include a same material or a different material. For example, each of the first cover member 1313 and the second cover member 1315 may be a polyimide (PI) film, a polyethylene terephthalate (PET) film, or a polyethylene naphthalate (PEN) film, but example embodiments of the present disclosure are not limited thereto.

The first cover member 1313 may be connected or coupled to the first surface of the vibration generating part 1311 or the first electrode part 1311b by using a first adhesive layer 1317. For example, the first cover member 1313 may be connected or coupled to the first surface of the vibration generating part 1311 or the first electrode part 1311b by a film laminating process using the first adhesive layer 1317.

The second cover member 1315 may be connected or coupled to the second surface of the vibration generating part 1311 or the second electrode part 1311c by using a second adhesive layer 1319. For example, the second cover member 1315 may be connected or coupled to the second surface of the vibration generating part 1311 or the second electrode part 1311c by a film laminating process using the second adhesive layer 1319.

Any one of the first cover member 1313 and the second cover member 1315 may be omitted. For example, any one of the first cover member 1313 and the second cover member 1315 may be configured to cover or protect at least one or more of the first and second surfaces of the vibration generating part 1311.

Each of the first adhesive layer 1317 and second adhesive layer 1319 according to an example embodiment of the present disclosure may include an electrically insulating material which has adhesiveness and is capable of compression and decompression. For example, each of the first adhesive layer 1317 and the second adhesive layer 1319 may include an epoxy resin, an acrylic resin, a silicone resin, a urethane resin, an acrylic-based polymer, a silicone-based polymer, or a urethane-based polymer, but example embodiments of the present disclosure are not limited thereto.

The first adhesive layer 1317 and second adhesive layer 1319 may be configured between the first cover member 1313 and the second cover member 1315 to surround the vibration generating part 1311. For example, one or more of the first adhesive layer 1317 and second adhesive layer 1319 may be configured to partially or completely surround the vibration generating part 1311.

Any one of the first cover member 1313 and the second cover member 1315 may be connected or coupled to the vibration member 331 by using the adhesive member 332 illustrated in FIGS. 3 to 44.

The vibration generator 1310 according to an example embodiment of the present disclosure may further include a signal supply member 1320.

The signal supply member 1320 may be configured to supply the driving signal supplied from a driving circuit part to the vibration generating part 1311. The signal supply member 1320 may be configured to be electrically connected to the vibration part 1311a. The signal supply member 1320 may be configured to be electrically connected to the first electrode part 1311b and the second electrode part 1311c of the vibration generating part 1311.

A portion of the signal supply member 1320 may be accommodated (or inserted) between the first cover member 1313 and the second cover member 1315. An end portion (or a distal end portion or one side) of the signal supply member 1320 may be disposed or inserted (or accommodated) between one edge portion of the first cover member 1313 and one edge portion of the second cover member 1315. The one edge portion of the first cover member 1313 and the one edge portion of the second cover member 1315 may accommodate or vertically (or up and down) cover the end portion (or the distal end portion or the one side) of the signal supply member 1320. Accordingly, the signal supply member 1320 may be integrated as one body with the vibration generating part 1311. Accordingly, the sound generating module 330 or the vibration apparatus 333 may be implemented in a film type integrated with the signal supply member 1320. For example, the signal supply member 1320 may be configured as one component with the vibration generating part 1311, thereby realizing an effect of uni-materialization. For example, the signal supply member 1320 may be configured as a signal cable, a flexible cable, a flexible printed circuit cable, a flexible flat cable, a single-sided flexible printed circuit, a single-sided flexible printed circuit board, a flexible multilayer printed circuit, or a flexible multilayer printed circuit board, but example embodiments of the present disclosure are not limited thereto.

The signal supply member 1320 according to an example embodiment of the present disclosure may include a base member 1321 and a plurality of signal lines 1323a and 1323b. For example, the signal supply member 1320 may include a base member 1321, a first signal line 1323a, and a second signal line 1323b.

The base member 1321 may include a transparent or opaque plastic material, but example embodiments of the present disclosure are not limited thereto. The base member 1321 may have a certain width along a first direction X and may be extended long along a second direction Y intersecting with the first direction X.

The first signal line 1323a and the second signal line 1323b may be disposed at the first surface of the base member 1321 in parallel with the second direction Y and may be spaced apart from each other or electrically separated from each other along the first direction X. The first signal line 1323a and the second signal line 1323b may be disposed in parallel to each other at the first surface of the base member 1321. For example, the first signal line 1323a and the second signal line 1323b may be implemented in a line shape by patterning of a metal layer (or a conductive layer) formed or deposited at the first surface of the base member 1321, but example embodiments of the present disclosure are not limited thereto.

End portions (or distal end portions or one sides) of the first signal line 1323a and the second signal line 1323b may be separated from each other, and thus, may be individually curved or bent.

The end portion (or the distal end portion or the one side) of the first signal line 1323a may be electrically connected to the first electrode part 1311b of the vibration generating part 1311. For example, the end portion of the first signal line 1323a may be electrically connected to at least a portion of the first electrode part 1311b of the vibration generating part 1311 in the one edge portion of the first cover member 1313. For example, the end portion (or the distal end portion or the one side) of the first signal line 1323a may be electrically and directly connected to at least a portion of the first electrode part 1311b of the vibration generating part 1311. For example, the end portion (or the distal end portion or the one side) of the first signal line 1323a may be electrically connected to or directly contact the first electrode part 1311b of the vibration generating part 1311. For example, the end portion of the first signal line 1323a may be electrically connected to the first electrode part 1311b by a conductive double-sided tape. Accordingly, the first signal line 1323a may supply a first driving signal, supplied from a driving circuit part, to the first electrode part 1311b of the vibration generating part 1311.

The end portion (or the distal end portion or the one side) of the second signal line 1323b may be electrically connected to the second electrode part 1311c of the vibration generating part 1311. For example, the end portion of the second signal line 1323b may be electrically connected to at least a portion of the second electrode part 1311c of the vibration generating part 1311 in the one edge portion of the second cover member 1315. For example, the end portion of the second signal line 1323b may be electrically and directly connected to at least a portion of the second electrode part 1311c of the vibration generating part 1311. For example, the end portion of the second signal line 1323b may be electrically connected to or directly contact the second electrode part 1311c of the vibration generating part 1311. For example, the end portion of the second signal line 1323b may be electrically connected to the second electrode part 1311c by a conductive double-sided tape. Accordingly, the second signal line 1323b may supply a second driving signal, supplied from the driving circuit part, to the second electrode part 1311c of the vibration generating part 1311.

The signal supply member 1320 according to an example embodiment of the present disclosure may further include an insulation layer 1325.

The insulation layer 1325 may be disposed at the first surface of the base member 1321 to cover each of the first signal line 1323a and the second signal line 1323b other than the end portion (or one side) of the signal supply member 1320.

An end portion (or one side) of the signal supply member 1320 including an end portion (or one side) of the base member 1321 and an end portion (or one side) 1325a of the insulation layer 1325 may be inserted (or accommodated) between the first cover member 1313 and the second cover member 1315 and may be fixed between the first cover member 1313 and the second cover member 1315 by a first adhesive layer 1317 and the second adhesive layer 1319. Accordingly, the end portion (or one side) of the first signal line 1323a may be maintained with being electrically connected to the first electrode part 1311b of the vibration generating part 1311, and the end portion (or one side) of the second signal line 1323b may be maintained with being electrically connected to the second electrode part 1311c of the vibration generating part 1311. In addition, the end portion (or one side) of the signal supply member 1320 may be inserted (or accommodated) and fixed between the vibration generating part 1311 and the first cover member 1313, and thus, a contact defect between the vibration generator 1310 and the signal supply member 1320 caused by the movement of the signal supply member 1320 may be prevented.

In the signal supply member 1320 according to an example embodiment of the present disclosure, each of the end portion (or one side) of the base member 1321 and the end portion (or one side) 1325a of the insulation layer 1325 may be removed. For example, each of the end portion of the first signal line 1323a and the end portion of the second signal line 1323b may be exposed at the outside without being supported or covered by each of the end portion (or one side) of the base member 1321 and the end portion (or one side) 1325a of the insulation layer 1325, respectively. For example, the end portion (or one side) of each of the first signal line 1323a and the second signal line 1323b may protrude (or extend) to have a certain length from an end 1321e of the base member 1321 or an end 1325e of the insulation layer 1325. Accordingly, each of the end portion (or the distal end portion or the one side) of each of the first signal line 1323a and the second signal line 1323b may be individually or independently bent.

The end portion (or one side) of the first signal line 1323a, which is not supported by the end portion (or one side) of the base member 1321 and the end portion 1325a of the insulation layer 1325, may be directly connected to or directly contact the first electrode part 1311b of the vibration generating part 1311. The end portion (or one side) of the second signal line 1323b, which is not supported by the end portion (or one side) of the base member 1321 and the end portion 1325a of the insulation layer 1325, may be directly connected to or directly contact the second electrode part 1311c of the vibration generating part 1311.

According to an example embodiment of the present disclosure, a portion of the signal supply member 1320 or a portion of the base member 1321 may be disposed or inserted (or accommodated) between the first cover member 1313 and the second cover member 1315, and thus, the signal supply member 1320 may be integrated as one body with the vibration generating part 1311. Accordingly, the vibration generating part 1311 and the signal supply member 1320 may be configured as one component, and thus, an effect of uni-materialization may be obtained.

According to an example embodiment of the present disclosure, the first signal line 1323a and the second signal line 1323b of the signal supply member 1320 may be integrated as one body with the vibration generator 1310, and thus, a soldering process for an electrical connection between the vibration generator 1310 and the signal supply member 1320 may not be needed. Accordingly, a manufacturing process and a structure of the vibration apparatus 333 may be simplified, and hazards associated with the soldering process may be reduced.

FIG. 50 is a diagram illustrating a vibration part according to another example embodiment of the present disclosure. For example, FIG. 50 illustrates another example embodiment of the vibration part described above with reference to FIGS. 47 to 49.

With reference to FIGS. 48 and 50, the vibration part 1311a according to another example embodiment of the present disclosure may include a plurality of first portions 1311a1 and a plurality of second portions 1311a2. For example, the plurality of first portions 1311a1 and the plurality of second portions 1311a2 may be alternately and repeatedly disposed along a second direction Y (or a first direction X).

Each of the plurality of first portions 1311a1 may include an inorganic material portion having a piezoelectric effect (or a piezoelectric characteristic). For example, each of the plurality of first portions 1311a1 may include at least one or more of a piezoelectric inorganic material and a piezoelectric organic material. For example, each of the plurality of first portions 1311a1 may be an inorganic portion, an inorganic material portion, a piezoelectric portion, a piezoelectric material portion, or an electroactive portion, but example embodiments of the present disclosure are not limited thereto.

According to an example embodiment of the present disclosure, each of the plurality of first portions 1311a1 may have a width parallel to the second direction Y (or the first direction X) and may be extended along the first direction X (or the second direction Y). Each of the plurality of first portions 1311a1 may be substantially a same as the vibration part 1311a described above with reference to FIGS. 47 to 49, and thus, its repeated descriptions are omitted or will be briefly given below.

Each of the plurality of second portions 1311a2 may be disposed between the plurality of first portions 1311a1. For example, each of the plurality of first portions 1311a1 may be disposed between two adjacent second portions 1311a2 of the plurality of second portions 1311a2. Each of the plurality of second portions 1311a2 may have a width parallel to the second direction Y (or the first direction X) and may be extended along the first direction X (or the second direction Y). The width of the first portion 1311a1 may be a same as or different from the width of the second portions 1311a2. For example, the width of the first portion 1311a1 may be greater than the width of the second portions 1311a2. For example, the first portion 1311a1 and the second portion 1311a2 may include a line shape or a stripe shape which has a same size or different sizes, but example embodiments of the present disclosure are not limited thereto.

Each of the plurality of second portions 1311a2 may be configured to fill a gap between two adjacent first portions of the plurality of first portions 1311a1. Each of the plurality of second portions 1311a2 may be configured to fill a gap between two adjacent first portions of the plurality of first portions 1311a1, and thus, may be connected to or attached on lateral surfaces of the first portion 1311a1 adjacent thereto. According to an example embodiment of the present disclosure, each of the plurality of first portions 1311a1 and the plurality of second portions 1311a2 may be disposed (or arranged) at a same plane (or a same layer) in parallel with each other. Therefore, the vibration part 1311a may be expanded to a desired size or length by a lateral coupling (or connection) of the first portions 1311a1 and the second portions 1311a2.

According to an example embodiment of the present disclosure, each of the plurality of second portions 1311a2 may absorb an impact applied to the first portions 1311a1, and thus, may enhance the durability of the first portions 1311a1 and provide flexibility to the vibration part 1311a. Each of the plurality of second portions 1311a2 may include an organic material having a ductile characteristic. For example, each of the plurality of second portions 1311a2 may include one or more of an epoxy-based polymer, an acrylic-based polymer, and a silicone-based polymer, but example embodiments of the present disclosure are not limited thereto. For example, each of the plurality of second portions 1311a2 may be an organic portion, an organic material portion, an adhesive portion, a stretch portion, a bending portion, a damping portion, or a ductile portion, but example embodiments of the present disclosure are not limited thereto.

A first surface of each of the plurality of first portions 1311a1 and the plurality of second portions 1311a2 may be connected to the first electrode part 1311b in common. A second surface of each of the plurality of first portions 1311a1 and the plurality of second portions 1311a2 may be connected to the second electrode part 1311c in common. For example, one or both of the first electrode part 1311b and the second electrode part 1311c may be formed as pattern-shaped electrodes to correspond only to the plurality of first portions 1311a1.

The plurality of first portions 1311a1 and the plurality of second portion 1311a2 may be disposed on (or connected to) the same plane, and thus, the vibration part 1311a according to another example embodiment of the present disclosure may have a single thin film-type. Accordingly, the vibration generating part 1311 or the vibration generator 1310 including the vibration part 1311a according to another example embodiment of the present disclosure may vibrate by the first portion 1311a1 having a vibration characteristic and may be bent in a curved shape by the second portion 1311a2 having flexibility.

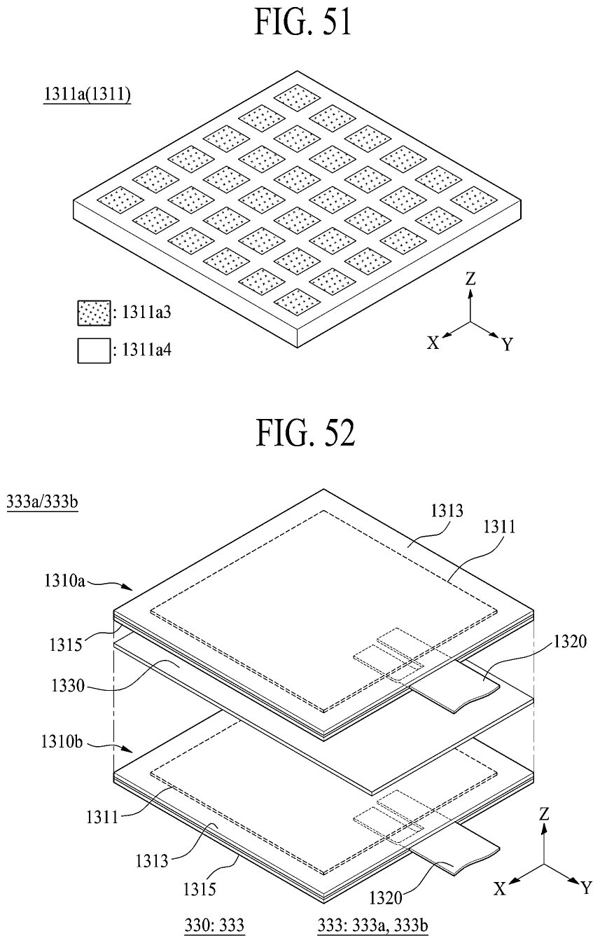

FIG. 51 is a diagram illustrating a vibration part according to another example embodiment of the present disclosure. For example, FIG. 51 illustrates another example embodiment of the vibration part described above with reference to FIGS. 47 to 49.

With reference to FIGS. 48 and 51, the vibration part 1311a according to another example embodiment of the present disclosure may include a plurality of first portions 1311a3 and a second portion 1311a4 disposed between the plurality of first portions 1311a3.

Each of the plurality of first portions 1311a3 may be disposed to be spaced apart from one another along each of the first direction X and the second direction Y. For example, each of the plurality of first portions 1311a3 may have a hexahedral shape having a same size and may be disposed in a lattice shape, but example embodiments of the present disclosure are not limited thereto. For example, each of the plurality of first portions 1311a3 may have a circular shape plate, an oval shape plate, or a polygonal shape plate, which has a same size as each other, but example embodiments of the present disclosure are not limited thereto.

Each of the plurality of first portions 1311a3 may be substantially a same as the first portion 1311a1 described above with reference to FIG. 50, and thus, its repeated descriptions are omitted or will be briefly given below.

The second portion 1311a4 may be disposed between the plurality of first portions 1311a3 along each of the first direction X and the second direction Y. The second portion 1311a4 may be configured to fill a gap between two adjacent first portions 1311a3, or to be adjacent to each of the plurality of first portions 1311a3 or to surround each of the plurality of first portions 1311a3, and thus, the second portion 1311a4 may be connected to or attached on the first portion 1311a3 adjacent thereto. The second portion 1311a4 may be substantially a same as the second portion 1311a2 described above with reference to FIG. 50, and thus, its repeated descriptions are omitted or will be briefly given below.

A first surface of each of the plurality of first portions 1311a3 and the second portions 1311a4 may be connected to the first electrode part 1311b in common. A second surface of each of the plurality of first portions 1311a3 and the second portions 1311a4 may be connected to the second electrode part 1311c in common. For example, one or both of the first electrode part 1311b and the second electrode part 1311c may be formed as pattern-shaped electrodes to correspond only to the plurality of first portions 1311a3.

The plurality of first portions 1311a3 and the second portion 1311a4 may be disposed on (or connected to) the same plane, and thus, the vibration part 1311a according to another example embodiment of the present disclosure may have a single thin film-type. Accordingly, the vibration generating part 1311 or the vibration generator 1310 including the vibration part 1311a according to another example embodiment of the present disclosure may vibrate by the first portion 1311a3 having a vibration characteristic and may be bent in a curved shape by the second portion 1311a4 having flexibility.

FIG. 52 is a diagram illustrating a vibration apparatus according to another example embodiment of the present disclosure.

With reference to FIG. 52, the vibration apparatus 333 according to another example embodiment of the present disclosure may include a plurality of vibration generators 1310a and 1310b. Each of a first vibration apparatus 333a and a second vibration apparatus 333b of the vibration apparatus 333 may include a plurality of vibration generators 1310a and 1310b. For example, the vibration apparatus 333 or each of the first vibration apparatus 333a and the second vibration apparatus 333b may include a first vibration generator 1310a and a second vibration generator 1310b.

The first vibration generator 1310a and the second vibration generator 1310b may overlap or be stacked with each other to be displaced (or driven or vibrated) in a same direction to maximize an amplitude displacement of the vibration apparatus 333 and/or an amplitude displacement of a vibration member 331. For example, the first vibration generator 1310a and the second vibration generator 1310b may have substantially a same size, but example embodiments of the present disclosure are not limited thereto. Therefore, the first vibration generator 1310a and the second vibration generator 1310b may maximize the amplitude displacement of the vibration apparatus 333 and/or the amplitude displacement of the vibration member 331.

According to an example embodiment of the present disclosure, any one of the first vibration generator 1310a and the second vibration generator 1310b may be connected or coupled to the vibration member 331 by using the adhesive member 332 illustrated in FIGS. 3 to 6 and 28 to 44. For example, the first vibration generator 1310a may be connected or coupled to the vibration member 331 by using the adhesive member 332.

Each of the first vibration generator 1310a and the second vibration generator 1310b may be a same as or substantially a same as that of the vibration generator 1310 described above with reference to FIGS. 47 to 51, and thus, like reference numeral refer to like element and its repeated descriptions are omitted or will be briefly given below.

The vibration apparatus 333 according to another example embodiment of the present disclosure may further include an intermediate member 1330.

The intermediate member 1330 may be disposed or connected between the first vibration generator 1310a and the second vibration generator 1310b. For example, the intermediate member 1330 may be disposed or connected between the second cover member 1315 of the first vibration generator 1310a and the first cover member 1313 of the second vibration generator 1310b. For example, the intermediate member 1330 may be an adhesive member or a connection member, but example embodiments of the present disclosure are not limited thereto.

The intermediate member 1330 according to an example embodiment of the present disclosure may be configured in a material including an adhesive layer which is good in adhesive force or attaching force with respect to each of the first vibration generator 1310a and the second vibration generator 1310b. For example, the intermediate member 1330 may include a foam pad, a double-sided tape, a double-sided foam tape, a double-sided pad, a double-sided foam pad, or an adhesive, or the like, but example embodiments of the present disclosure are not limited thereto. For example, an adhesive layer of the intermediate member 1330 may include epoxy, acrylic, silicone, or urethane, but example embodiments of the present disclosure are not limited thereto. For example, the adhesive layer of the intermediate member 1330 may include a urethane-based material (or substance) having relatively ductile characteristic. Accordingly, the vibration loss caused by displacement interference between the first vibration generator 1310a and the second vibration generator 1310b may be reduced or minimized, or each of the first vibration generator 1310a and the second vibration generator 1310b may be freely displaced (or vibrated or driven).

The vibration apparatus 333 or the first and second vibration apparatus 333a and 333b according to another example embodiment of the present disclosure may include the first vibration generator 1310a and the second vibration generator 1310b which are stacked (or piled or overlap) to vibrate (or displace or drive) in the same direction, and thus, the amount of displacement or an amplitude displacement may be maximized or increase. Accordingly, the amount of displacement (or a bending force or a driving force) or an amplitude of displacement of the vibration member 331 may be maximized or increased.

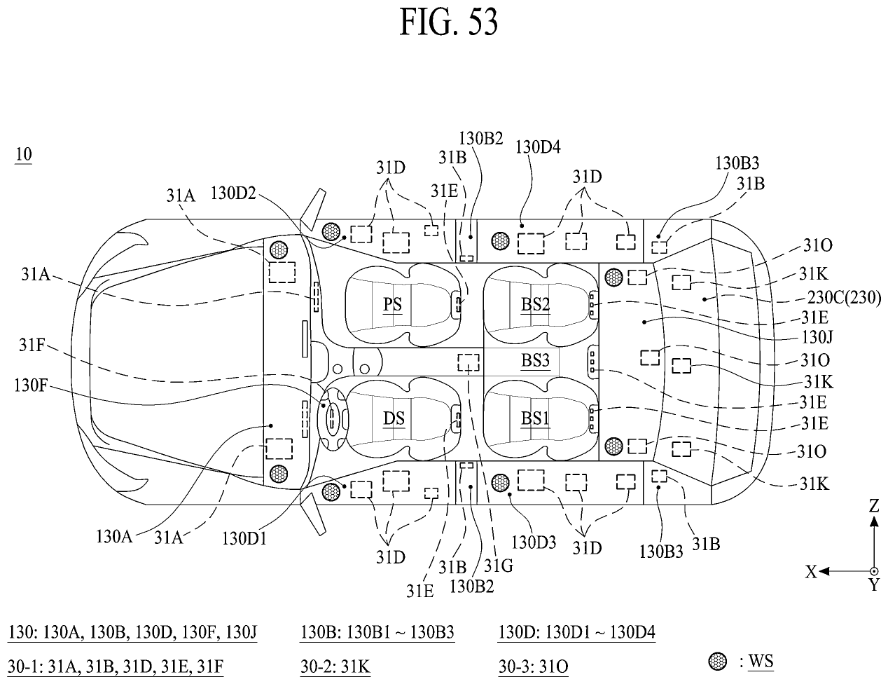

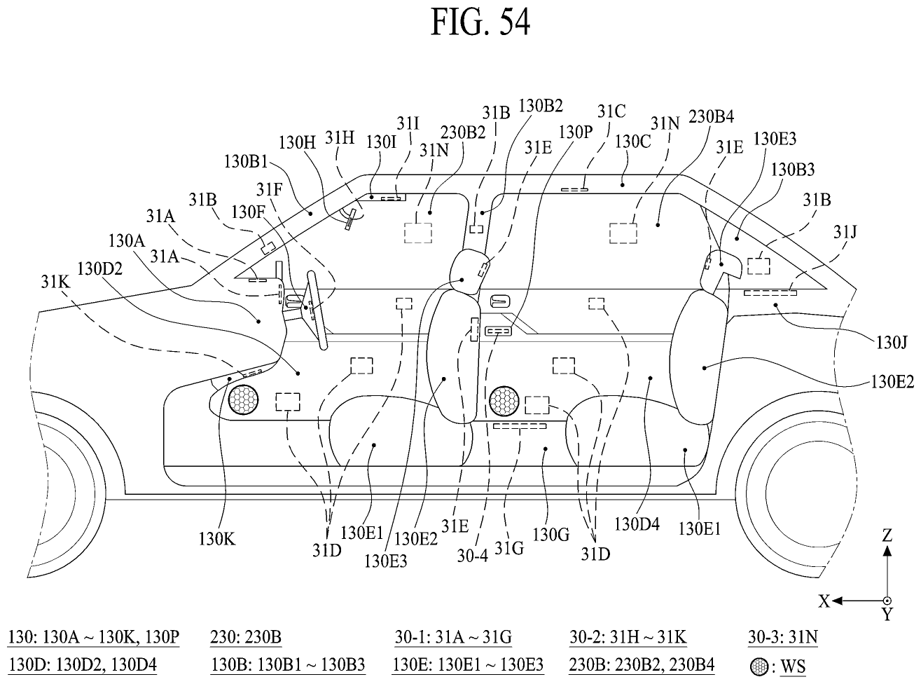

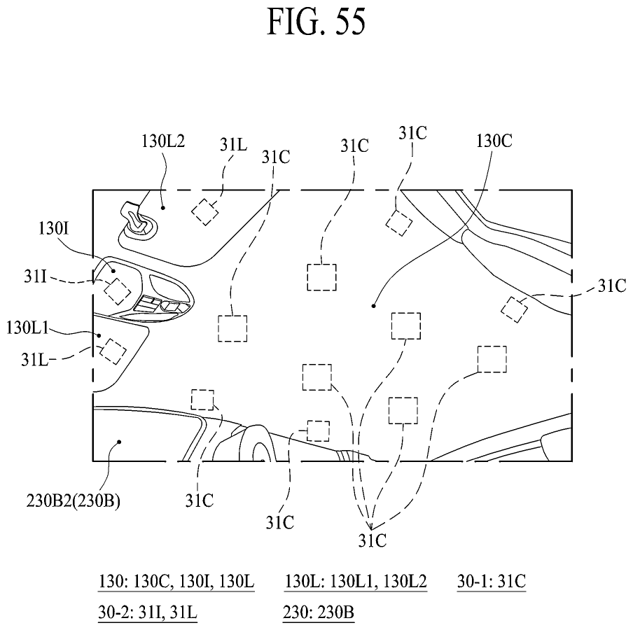

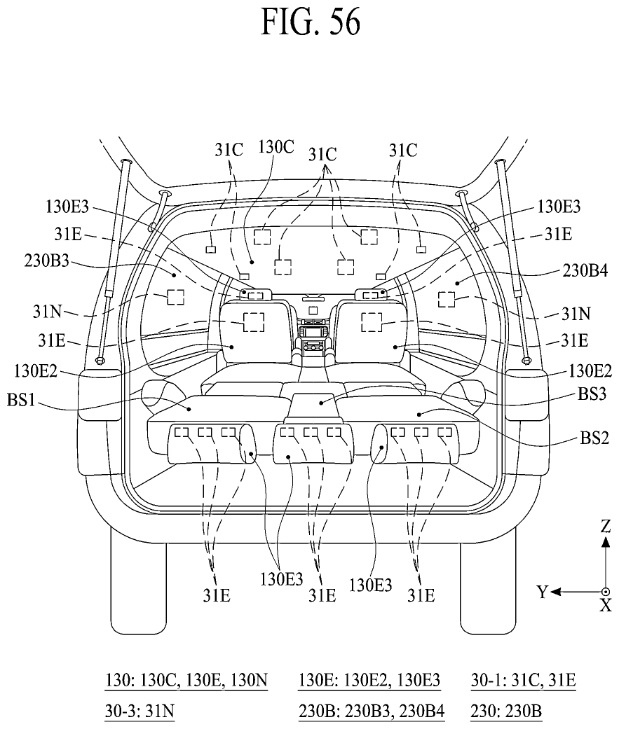

FIG. 53 is a diagram illustrating a vehicular apparatus according to an example embodiment of the present disclosure. FIG. 54 is a diagram illustrating a vehicular apparatus according to an example embodiment of the present disclosure. FIG. 55 is a diagram illustrating a sound generating apparatus disposed at a roof of a vehicular apparatus illustrated in FIGS. 53 and 54. FIG. 56 is a diagram illustrating a sound generating apparatus disposed at a roof and a seat of a vehicular apparatus illustrated in FIGS. 53 and 54.

With reference to FIGS. 53 to 56, a vehicular apparatus 10 according to an example embodiment of the present disclosure may include a vehicle interior material 130 and one or more first sound generating apparatuses 30-1. For example, the vehicle interior material 130 may output a sound based on a vibration of the one or more first sound generating apparatuses 30-1. For example, the vehicle interior material 130 may be exposed at an interior space.

The first sound generating apparatus 30-1 may include at least one or more sound generators 31A to 31G which are disposed in at least one or more of the dashboard 130A, the pillar interior material 130B, the roof interior material 130C, the door interior material 130D, the seat interior material 130E, the handle interior material 130F, and the floor interior material 130G. For example, the first sound generating apparatus 30-1 may include at least one or more of the first to seventh sound generators 31A to 31G, and thus, may output sounds of one or more channels.

The first sound generating module 31A according to an example embodiment of the present disclosure may be disposed between the dashboard 130A and a dash panel and may be configured to indirectly or directly vibrate the dashboard 130A to output a sound based on a vibration of the dashboard 130A. According to an example embodiment of the present disclosure, the first sound generator 31A may include the sound apparatus 30 described above with reference to FIGS. 3 to 52, and thus, its repeated descriptions are omitted. For example, the first sound generator 31A may be a dashboard speaker.

According to an example embodiment of the present disclosure, at least one or more of the dash panel and the dashboard 130A may include a first region corresponding to a driver seat DS, a second region corresponding to a passenger seat PS, and a third region (or a middle region) between the first region and the second region. At least one or more of the dash panel and the dashboard 130A may include a fourth region which is inclined to face the passenger seat PS. According to an example embodiment of the present disclosure, the first sound generator 31A may be disposed to vibrate at least one or more of the first to fourth regions of the dashboard 130A. For example, the first sound generator 31A may be configured to output a sound of about 150 Hz to about 20 kHz. For example, the first sound generator 31A configured to vibrate at least one or more of the first to fourth regions of the dashboard 130A may have a same sound output characteristic or different sound output characteristics.

The second sound generator 31B according to an example embodiment of the present disclosure may be disposed between the pillar interior material 130B and a pillar panel and may be configured to indirectly or directly vibrate the pillar interior material 130B to output a sound based on a vibration of the pillar interior material 130B. According to an example embodiment of the present disclosure, the second sound generator 31B may include the sound apparatus 30 described above with reference to FIGS. 3 to 52, and thus, its repeated descriptions are omitted. For example, the second sound generator 31B may be a pillar speaker or a tweeter speaker.

According to an example embodiment of the present disclosure, the pillar panel may include a first pillar (or an A pillar) disposed at both sides of a front window, a second pillar (or a B pillar) disposed at both sides of a center of a vehicle body, and a third pillar (or a C pillar) disposed at both sides of a rear portion of the vehicle body. The pillar interior material 130B may include a first pillar interior material 130B1 covering the first pillar, a second pillar interior material 130B2 covering the second pillar, and a third pillar interior material 130B3 covering the third pillar. According to an example embodiment of the present disclosure, the second sound generator 31B may be disposed in at least one or more of a region between the first pillar and the first pillar interior material 130B1, a region between the second pillar and the second pillar interior material 130B2, and a region between the third pillar and the third pillar interior material 130B3, and thus, may vibrate at least one or more of the first to third pillar interior materials 130B1, 130B2, and 130B3. For example, the second sound generator 31B may be configured to output a sound at about 2 kHz to about 20 kHz or may be configured to output a sound at about 150 Hz to about 20 kHz. For example, the second sound generator 31B configured to vibrate at least one or more of the first to third pillar interior materials 130B1, 130B2, and 130B3 may have a same sound output characteristic or different sound output characteristics.

With reference to FIGS. 54 to 56, the third sound generator 31C according to an example embodiment of the present disclosure may be disposed between the roof interior material 130C and a roof frame (or a roof panel) and may vibrate the roof interior material 130C to output a sound based on a vibration of the roof interior material 130C. For example, the third sound generator 31C may indirectly or directly vibrate the roof interior material 130C to output a sound based on a vibration of the roof interior material 130C. According to an example embodiment of the present disclosure, the third sound generator 31C may include the sound apparatus 30 described above with reference to FIGS. 3 to 52, and thus, its repeated descriptions are omitted. For example, the third sound generator 31C may be a roof speaker.

With reference to FIG. 55, the roof interior material 130C may include the first region corresponding to the driver seat DS, the second region corresponding to the passenger seat PS, a third region corresponding to a region between the driver seat DS and the passenger seat PS, a fourth region corresponding to a first rear seat BS1 behind the driver seat DS, a fifth region corresponding to a second rear seat BS2 behind the passenger seat PS, a sixth region corresponding to a region between the first rear seat BS1 and the second rear seat BS2, and a seventh region between the third region and the sixth region. For example, the third sound generator 31C may be disposed to vibrate at least one or more of the first to seventh regions of the roof interior material 130C. For example, the third sound generator 31C may be configured to output a sound of about 150 Hz to about 20 kHz. For example, the third sound generator 31C configured to vibrate at least one or more of the first to seventh regions of the roof interior material 130C may have a same sound output characteristic or different sound output characteristics. For example, at least one or more third sound generators 31C configured to vibrate at least one or more of the first to seventh regions of the roof interior material 130C may be configured to output a sound of about 2 kHz to about 20 kHz, and the other third sound generators 31C may be configured to output a sound of about 150 Hz to about 20 kHz.

With reference to FIGS. 53 and 54, the fourth sound generator 31D according to an example embodiment of the present disclosure may be disposed between the door frame and the door interior material 130D and may be configured to indirectly or directly vibrate the door interior material 130D to output a sound based on a vibration of the door interior material 130D. According to an example embodiment of the present disclosure, the fourth sound generator 31D may include the sound apparatus 30 described above with reference to FIGS. 3 to 52, and thus, its repeated descriptions are omitted. For example, the fourth sound generator 31D may be a door speaker.

According to an example embodiment of the present disclosure, at least one or more of the door frame and the door interior material 130D may include an upper region, a middle region, and a lower region with respect to a height direction Z of the vehicular apparatus 10. For example, the fourth sound generator 31D may be disposed in at least one or more of the upper region, the middle region, and the lower region between the door frame and the door interior material 130D, and thus, may vibrate at least one or more of the upper region, the middle region, and the lower region of the door interior material 130D.

According to an example embodiment of the present disclosure, the upper region of the door interior material 130D may have a relatively small curvature radius. The fourth sound generator 31D for vibrating the upper region of the door interior material 130D may include the sound apparatus 30 having a flexible characteristic described above with reference to FIGS. 50 and 51.

According to an example embodiment of the present disclosure, the door frame may include a first door frame (or a left front door frame), a second door frame (or a right front door frame), a third door frame (or a left rear door frame), and a fourth door frame (or a right rear door frame). According to an example embodiment of the present disclosure, the door interior material 130D may include a first door interior material (or a left front door interior material) 130D1 covering the first door frame, a second door interior material (or a right front door interior material) 130D2 covering the second door frame, a third door interior material (or a left rear door interior material) 130D3 covering the third door frame, and a fourth door interior material (or a right rear door interior material) 130D4 covering the fourth door frame. For example, the fourth sound generator 31D may be disposed in at least one or more of an upper region, a middle region, and a lower region between each of the first to fourth door frames and the first to fourth door interior materials 130D1, 130D2, 130D3, and 130D4 and may vibrate at least one or more of the upper region, the middle region, and the lower region of each of the first to fourth door interior materials 130D1, 130D2, 130D3, and 130D4.

According to an example embodiment of the present disclosure, the fourth sound generator 31D configured to vibrate the upper region of each of the first to fourth door interior materials 130D1, 130D2, 130D3, and 130D4 may be configured to output a sound of about 2 kHz to about 20 kHz, or may be configured to output a sound of about 150 Hz to about 20 kHz.

According to an example embodiment of the present disclosure, the fourth sound generator 31D configured to vibrate the middle regions and the lower regions of at least one or more of the first to fourth door interior materials 130D1, 130D2, 130D3, and 130D4 may be configured to output a sound of about 150 Hz to about 20 kHz. The fourth sound generator 31D configured to vibrate the middle region and the lower region of each of the first to fourth door interior materials 130D1, 130D2, 130D3, and 130D4 may be configured to output a sound of about 150 Hz to about 20 kHz. For example, the fourth sound generator 31D configured to vibrate the middle regions and the lower regions of at least one or more of the first to fourth door interior materials 130D1, 130D2, 130D3, and 130D4 may be any one or more of a woofer, a mid-woofer, and a sub-woofer. For example, the fourth sound generator 31D configured to vibrate the middle region and the lower region of each of the first to fourth door interior materials 130D1, 130D2, 130D3, and 130D4 may be one or more of a woofer, a mid-woofer, and a sub-woofer.

Sounds, which are respectively output from the fourth sound generator 31D disposed at the first door interior material 130D1 and the fourth sound generator 31D disposed at the second door interior material 130D2, may be combined and output. For example, sounds, which are respectively output from at least one or more of the fourth sound generators 31D disposed at the first door interior material 130D1 and the fourth sound generator 31D disposed at the second door interior material 130D2, may be combined and output. In addition, sounds, which are respectively output from the fourth sound generator 31D disposed at the third door interior material 130D3 and the fourth sound generator 31D disposed at the fourth door interior material 130D4 may be combined and output.

According to an example embodiment of the present disclosure, the upper region of each of the first to fourth door interior materials 130D1, 130D2, 130D3, and 130D4 may include a first upper region adjacent to the dashboard 130A, a second upper region adjacent to the first to third rear seats BS1, BS2, and BS3, and a third upper region between the first upper region and the second upper region. For example, the fourth sound generator 31D may be disposed at one or more of the first to third upper regions of at least one or more of the first to fourth door interior materials 130D1, 130D2, 130D3, and 130D4. For example, the fourth sound generator 31D configured to vibrate the first upper regions of one or more of the first and second door interior materials 130D1 and 130D2 may be configured to output a sound of about 2 kHz to about 20 kHz, and the fourth sound generator 31D configured to vibrate one or more of the second and third upper regions of each of the first and second door interior materials 130D1 and 130D2 may be configured to output a sound of about 2 kHz to about 20 kHz, or may be configured to output a sound of about 150 Hz to about 20 kHz. For example, the fourth sound generator 31D configured to vibrate one or more of the second and third upper regions of at least one or more of the first and second door interior materials 130D1 and 130D2 may be configured to output a sound of about 2 kHz to about 20 kHz, or may be configured to output a sound of about 150 Hz to about 20 kHz.

With reference to FIGS. 53, 54, and 56, the fifth sound generator 31E according to an example embodiment of the present disclosure may be disposed between a seat frame and the seat interior material 130E and may be configured to indirectly or directly vibrate the seat interior material 130E to output a sound based on a vibration of the seat interior material 130E. According to an example embodiment of the present disclosure, the fifth sound generator 31E may include the sound apparatus 30 described above with reference to FIGS. 3 to 52, and thus, its repeated descriptions are omitted. For example, the fifth sound generator 31E may be a sheet speaker or a headrest speaker.

According to an example embodiment of the present disclosure, the seat frame may include a first seat frame (or a driver seat frame), a second seat frame (or a passenger seat frame), a third seat frame (or a first rear seat frame), a fourth seat frame (or a second rear seat frame), and a fifth seat frame (or a third rear seat frame). According to an example embodiment of the present disclosure, the seat interior material 130E may include the first seat interior material surrounding the first seat frame, the second seat interior material surrounding the second seat frame, the third seat interior material surrounding the third seat frame, the fourth seat interior material surrounding the fourth seat frame, and the fifth seat interior material surrounding the fifth seat frame.

According to an example embodiment of the present disclosure, at least one or more of the first to fifth seat frames may include a seat bottom frame, a seat back frame, and a headrest frame. The seat interior material 130E may include a seat bottom interior material 130E1 surrounding the seat bottom frame, a seat back interior material 130E2 surrounding the seat back frame, and a headrest interior material 130E3 surrounding the headrest frame. At least one or more of the seat bottom interior material 130E1, the seat back interior material 130E2, and the headrest interior material 130E3 may include an inner interior material and an outer interior material. For example, the inner interior material may include a foam layer. For example, the outer interior material may include a surface member including a fiber or leather. For example, the outer interior material may further include a base member including a plastic material which supports the surface member.

According to an example embodiment of the present disclosure, the fifth sound generator 31E may be disposed in at least one or more of a region between the seat back frame and the seat back interior material 130E2 and a region between the headrest frame and the headrest interior material 130E3, and thus, may vibrate at least one or more of the outer interior material of the seat back interior material 130E2 and the outer interior material of the headrest interior material 130E3.

According to an example embodiment of the present disclosure, the fifth sound generator 31E disposed in at least one or more of the driver seat DS and the passenger seat PS may be disposed in at least one or more of the region between the seat back frame and the seat back interior material 130E2 and the region between the headrest frame and the headrest interior material 130E3.

According to an example embodiment of the present disclosure, the fifth sound generator 31E disposed in at least one or more of the first to third rear seats BS1, BS2, and BS3 may be disposed between the headrest frame and the headrest interior material 130E3. For example, at least one or more of the first to third rear seats BS1, BS2, and BS3 may include at least one or more fifth sound generators 31E disposed between the headrest frame and the headrest interior material 130E3.

According to an example embodiment of the present disclosure, the fifth sound generator 31E vibrating the seat back interior materials 130E2 of at least one or more of the driver seat DS and the passenger seat PS may be configured to output a sound of about 150 Hz to about 20 kHz. According to an example embodiment of the present disclosure, the fifth sound generator 31E vibrating the headrest interior materials 130E3 of at least one or more of the driver seat DS, the passenger seat PS, and the first to third rear seats BS1, BS2, and BS3 may be configured to output a sound of about 2 kHz to about 20 kHz, or may be configured to output a sound of about 150 Hz to about 20 kHz.

With reference to FIGS. 53 and 54, the sixth sound generator 31F according to an example embodiment of the present disclosure may be disposed between a handle frame and the handle interior material 130F and may be configured to indirectly or directly vibrate the handle interior material 130F to output a sound based on a vibration of the handle interior material 130F. According to an example embodiment of the present disclosure, the sixth sound generator 31F may include the sound apparatus 30 described above with reference to FIGS. 3 to 52, and thus, its repeated descriptions are omitted. For example, the sixth sound generator 31F may be a handle speaker or a steering speaker.

According to an example embodiment of the present disclosure, the sixth sound generator 31F may be configured to indirectly or directly vibrate the handle interior material 130F to provide a driver with a sound based on a vibration of the handle interior material 130F. A sound output by the sixth sound generator 31F may be a sound which is the same as or different from sounds output from at least one or more of the first to fifth sound generators 31A to 31E. As an example embodiment of the present disclosure, the sixth sound generator 31F may output a sound which is to be provided to only the driver. As another example embodiment of the present disclosure, the sound output by the sixth sound generator 31F and a sound output by at least one or more of the first to fifth sound generators 31A to 31E may be combined and output.

With reference to FIGS. 53 and 54, the seventh sound generator 31G may be disposed between the floor panel and the floor interior material 130G and may be configured to indirectly or directly vibrate the floor interior material 130G to output a sound based on a vibration of the floor interior material 130G.

The seventh sound generator 31G may be disposed between the floor panel and the floor interior material 130G disposed between the driver seat DS and the passenger seat PS and the third rear seat BS3. For example, the seventh sound generator 31G may include the sound apparatus 30 described above with reference to FIGS. 3 to 52, and thus, its repeated descriptions are omitted. For example, the seventh sound generator 31G may be configured to output a sound of about 150 Hz to about 20 kHz. For example, the seventh sound generator 31G may be a floor speaker, a bottom speaker, or an under speaker.

With reference to FIGS. 53 to 55, the vehicular apparatus or the vehicle 10 according to an example embodiment of the present disclosure may further include a second sound generating apparatus 30-2 which is disposed at the vehicle interior material 130 exposed at an interior space. For example, the vehicular apparatus or the vehicle 10 according to an example embodiment of the present disclosure may include only the second sound generating apparatus 30-2 instead of the first sound generating apparatus 30-1, or may include all of the first sound generating apparatus 30-1 and the second sound generating apparatus 30-2.

According to an example embodiment of the present disclosure, the vehicle interior material 130 may further include a rear view mirror 130H, an overhead console 130I, a rear package interior material 130J, a glove box 130K, and a sun visor 130L, or the like.

The second sound generating apparatus 30-2 may include at least one or more sound generators 31H to 31L which are disposed in at least one of the rear view mirror 130H, the overhead console 130I, the rear package interior material 130J, the glove box 130K, and the sun visor 130L. For example, the second sound generating apparatus 30-2 may include at least one or more of eighth to twelfth sound generators 31H to 31L, and thus, may output sounds of one or more channels.

With reference to FIGS. 53 to 55, the eighth sound generator 31H may be disposed at the rear view mirror 130H and may be configured to indirectly or directly vibrate the rear view mirror 130H to output a sound based on a vibration of the rear view mirror 130H.

The eighth sound generator 31H may be disposed between a mirror housing connected to a vehicle body structure and the rear view mirror 130H supported by the mirror housing. According to an example embodiment of the present disclosure, the eighth sound generator 31H may include the sound apparatus 30 described above with reference to FIGS. 3 to 52, and thus, its repeated descriptions are omitted. For example, the eighth sound generator 31H may be configured to output a sound of about 150 Hz to about 20 kHz. For example, the eighth sound generator 31H may be a mirror speaker.

With reference to FIGS. 55 and 56, the ninth sound generator 31I may be disposed at the overhead console 130I and may be configured to indirectly or directly vibrate a console cover of the overhead console 130I to output a sound based on a vibration of an interior material of the overhead console 130I.

According to an example embodiment of the present disclosure, the overhead console 130I may include a console box embedded into the roof panel or the roof frame, a lighting device disposed at the console box, and the console cover covering the lighting device and the console box.

The ninth sound generator 31I may be disposed between the console cover and the console box of the overhead console 130I and may indirectly or directly vibrate the console cover. According to an example embodiment of the present disclosure, the ninth sound generator 31I may include the sound apparatus 30 described above with reference to FIGS. 3 to 52, and thus, its repeated descriptions are omitted. For example, the ninth sound generator 31I may be configured to output a sound of about 150 Hz to about 20 kHz. For example, the ninth sound generator 31I may be a console speaker or a lighting speaker.

According to an example embodiment of the present disclosure, the vehicular apparatus or the vehicle 10 may further include a center lighting box disposed at a center region of the roof interior material 130C, a center lighting device disposed at the center lighting box, and a center lighting cover covering the center lighting device. In this case, the ninth sound generator 31I may be additionally disposed between the center lighting cover and the center lighting box of the center lighting device and may additionally vibrate the center lighting cover.

With reference to FIGS. 53 and 54, the tenth sound generator 31J may be disposed at the rear package interior material 130J and may be configured to indirectly or directly vibrate the rear package interior material 130J to output a sound based on a vibration of the rear package interior material 130J.

The rear package interior material 130J may be disposed behind the first to third rear seats BS1, BS2, and BS3. For example, a portion of the rear package interior material 130J may be disposed under a rear window 230C.

The tenth sound generator 31J may be disposed at a rear surface of the rear package interior material 130J and may indirectly or directly vibrate the rear package interior material 130J. According to an example embodiment of the present disclosure, the tenth sound generator 31J may include the sound apparatus 30 described above with reference to FIGS. 3 to 52, and thus, its repeated descriptions are omitted. For example, the tenth sound generator 31J may be a rear speaker.

According to an example embodiment of the present disclosure, the rear package interior material 130J may include a first region corresponding to a rear portion of the first rear seat BS1, a second region corresponding to a rear portion of the second rear seat BS2, and a third region corresponding to a rear portion of the third passenger seat BS3. According to an example embodiment of the present disclosure, the tenth sound generator 31J may be disposed in at least one or more of the first to third regions of the rear package interior material 130J to vibrate at least one or more of the first to third regions of the rear package interior material 130J. For example, the tenth sound generator 31J may be configured to output a sound of about 150 Hz to about 20 kHz. For example, the tenth sound generator 31J configured to vibrate at least one or more of the first to third regions of the rear package interior material 130J may have a same sound output characteristic or different sound output characteristics.

With reference to FIGS. 53 and 54, the eleventh sound generator 31K may be disposed at a glove box 130K and may be configured to indirectly or directly vibrate the glove box 130K to output a sound based on a vibration of the glove box 130K.

The glove box 130K may be disposed at a dashboard 130A corresponding to a front portion of the passenger seat PS.

The eleventh sound generator 31K may be disposed at an inner surface of the glove box 130K and may indirectly or directly vibrate the glove box 130K. According to an example embodiment of the present disclosure, the eleventh sound generator 31K may include the sound apparatus 30 described above with reference to FIGS. 3 to 52, and thus, its repeated descriptions are omitted. For example, the eleventh sound generator 31K may be configured to output a sound of about 150 Hz to about 20 kHz, or may be one or more of a woofer, a mid-woofer, and a sub-woofer. For example, the eleventh sound generator 31K may be a glove box speaker.

With reference to FIG. 55, the twelfth sound generator 31L may be disposed at the sun visor 130L and may be configured to indirectly or directly vibrate the sun visor 130L to output a sound based on a vibration of the sun visor 130L.

The sun visor 130L may include a first sun visor 130L1 corresponding to the driver seat DS and a second sun visor 130L2 corresponding to the passenger seat PS.

The twelfth sound generator 31L may be disposed in at least one or more of the first sun visor 130L1 and the second sun visor 130L2 and may indirectly or directly vibrate at least one or more of the first sun visor 130L1 and the second sun visor 130L2. According to an example embodiment of the present disclosure, the twelfth sound generator 31L may include the sound apparatus 30 described above with reference to FIGS. 3 to 52, and thus, its repeated descriptions are omitted. For example, the twelfth sound generator 31L may be configured to output a sound of about 150 Hz to about 20 kHz. For example, the twelfth sound generator 31L may be a sun visor speaker.

According to an example embodiment of the present disclosure, at least one or more of the first sun visor 130L1 and the second sun visor 130L2 may further include a sun visor mirror. In this case, the twelfth sound generator 31L may be configured to indirectly or directly vibrate the sun visor mirror of at least one or more of the first sun visor 130L1 and the second sun visor 130L2. The twelfth sound generator 31L vibrating the sun visor mirror may include the sound apparatus 30 described above with reference to FIGS. 3 to 52, and thus, its repeated descriptions are omitted.

With reference to FIGS. 53 to 55, the vehicular apparatus or the vehicle 10 according to an example embodiment of the present disclosure may further include a third sound generating apparatus 30-3 disposed at a vehicle window 230. For example, the vehicular apparatus or the vehicle 10 may include the third sound generating apparatus 30-3 instead of at least one or more of the first sound generating apparatus 30-1 and the second sound generating apparatus 30-2, or may include all of the first to third sound generating apparatuses 30-1, 30-2, and 30-3.

The third sound generating apparatus 30-3 may include at least one or more sound generators 31N and 310 disposed at the vehicle window 230. For example, the third sound generating apparatus 30-3 may include at least one or more of thirteenth and fourteenth sound generators 31N and 310, and thus, may output sounds of one or more channels. For example, the third sound generating apparatus 30-3 may be a transparent sound generating apparatus.

The vehicle window 230 of the vehicular apparatus or the vehicle 10 may include at least one or more of a front window and a side glass window. The vehicle window 230 may further include at least one or more of a rear window and a roof window.

The vehicle window 230 according to an example embodiment of the present disclosure may be configured to be entirely transparent. The vehicle window 230 according to another example embodiment of the present disclosure may include a transparent portion and a semitransparent portion surrounding the transparent portion. The vehicle window 230 according to another example embodiment of the present disclosure may include a transparent portion and an opaque portion surrounding the transparent portion.

The sound apparatus 30 described above with reference to FIGS. 3 to 52 may be configured to be transparent or semitransparent. For example, when the vehicle window 230 is wholly transparent, the sound apparatus 30 may be configured to be transparent and may be disposed at a middle region or a peripheral region of the vehicle window 230. When the vehicle window 230 includes the semitransparent portion or the opaque portion, the sound apparatus 30 may be configured to be semitransparent or opaque and may be disposed at the semitransparent portion or the opaque portion of the vehicle window 230. For example, the sound apparatus 30 may be a transparent sound apparatus.

The at least one or more of the thirteenth and fourteenth sound generators 31N and 310 according to an example embodiment of the present disclosure may include the transparent or semitransparent sound apparatus 30. For example, when the at least one or more of the thirteenth and fourteenth sound generators 31N and 310 includes the sound apparatus 30, the at least one or more of the thirteenth and fourteenth sound generators 31N and 310 may be configured to indirectly or directly vibrate the vehicle window 230 to output a sound based on a vibration of the vehicle window 230.

According to an example embodiment of the present disclosure, the vehicle window 230 may include the front window, the side window 230B, and the rear window. According to an example embodiment of the present disclosure, the vehicle window 230 may further include the roof window 230D. For example, when the vehicular apparatus or the vehicle 10 includes the roof window 230D, a portion of a region of the roof frame and the roof interior material 130C may be replaced with the roof window 230D. For example, when the vehicular apparatus or the vehicle 10 includes the roof window 230D, the third sound generator 31C may be configured to vibrate an edge portion of the roof interior material 130C surrounding the roof window 230D.

With reference to FIGS. 54 to 56, the thirteenth sound generator 31N according to an example embodiment of the present disclosure may be disposed at the side window 230B and may be configured to output a sound by vibrating itself, or may be configured to indirectly or directly vibrate the side window 230B to output a sound based on a vibration of the side window 230B.

According to an example embodiment of the present disclosure, the side window 230B may include a first glass window (or a right front window) 230B2, a second side window (or a left rear window) 230B3, a third side window (or a right rear window) 230B4, and a fourth side window (or a left front window).

According to an example embodiment of the present disclosure, the thirteenth sound generator 31N may be disposed in at least one or more of the first to third side windows 230B2, 230B3, and 230B4. For example, at least one or more of the first to third side windows 230B2, 230B3, and 230B4 may include at least one or more thirteenth sound generators 31N.

The thirteenth sound generator 31N may be disposed in at least one or more of the first to third side windows 230B2, 230B3, and 230B4 and may output a sound by vibrating itself, or may be configured to indirectly or directly vibrate a corresponding side windows 230B2, 230B3, and 230B4 to output a sound. For example, the thirteenth sound generator 31N may be configured to output the sound of 150 Hz to 20 kHz. For example, the thirteenth sound generator 31N disposed in at least one or more of the first to third side windows 230B2, 230B3, and 230B4 may have a same sound output characteristic or different sound output characteristics. For example, the thirteenth sound generator 31N disposed in at least one or more of the first to third side windows 230B2, 230B3, and 230B4 may be configured to output the sound of 150 Hz to 20 kHz. For example, the thirteenth sound generator 31N may be a side window speaker.

With reference to FIG. 53, the fourteenth sound generator 31O according to an example embodiment of the present disclosure may be disposed at the rear window 230C and may output a sound by vibrating itself, or may be configured to indirectly or directly vibrate the rear window 230C to output the sound based on the vibration of the rear window 230C.

According to an example embodiment of the present disclosure, the rear window 230C may include a first region corresponding to a rear portion of the first rear seat BS1, a second region corresponding to a rear portion of the second rear seat BS2, and a third region corresponding to a rear portion of the third rear seat BS3. According to an example embodiment of the present disclosure, the fourteenth sound generator 31O may be disposed in at least one or more of the first to third regions of the rear window 230C and may vibrate at least one or more of the first to third regions of the rear window 230C to output a sound. For example, the fourteenth sound generator 31O disposed in at least one or more of the first to third regions of the rear window 230C may have a same sound output characteristic or different sound output characteristics. For example, the fourteenth sound generator 31O disposed in at least one or more of the first to third regions of the rear window 230C may be configured to output a sound of about 150 Hz to about 20 kHz, or may be one or more of a woofer, a mid-woofer, and a sub-woofer. For example, the fourteenth sound generator 31O may be a rear window speaker.

With reference to FIGS. 53 and 54, the vehicular apparatus or the vehicle 10 according to an example embodiment of the present disclosure may further include a woofer speaker WS which is disposed in at least one or more of the dashboard 130A, the door frame, and the rear package interior material 130J.

The woofer speaker WS according to an example embodiment of the present disclosure may include one or more of a woofer, a mid-woofer, and a sub-woofer. For example, the woofer speaker WS may be a speaker which outputs a sound of about 60 Hz to about 150 Hz. Therefore, the woofer speaker WS may output a sound of about 60 Hz to about 150 Hz, and thus, may enhance a low-pitched sound band characteristic of a sound which is output to an interior space.

According to an example embodiment of the present disclosure, the woofer speaker WS may be disposed in at least one or more of first and second regions of the dashboard 130A. According to an example embodiment of the present disclosure, the woofer speaker WS may be disposed at each of first to fourth door frames of the door frame and may be exposed at a lower region of each of the first to fourth door interior materials 130D1 to 130D4 of the door interior material 130D. For example, the woofer speaker WS may be disposed in at least one or more of the first to fourth door frames of the door frame and may be exposed at the lower regions of at least one or more of the first to fourth door interior materials 130D1 to 130D4 of the door interior material 130D. For example, the fourth sound generator 31D disposed at the lower region of at least one or more of the first to fourth door interior materials 130D1 to 130D4 may be replaced by the woofer speaker WS.

With reference to FIG. 54, the vehicular apparatus 10 according to an example embodiment of the present disclosure may further include a garnish member 130P which covers a portion of the vehicle interior material 130 exposed at the interior space, and a fourth sound generating apparatus 30-4. For example, the fourth sound generating apparatus 30-4 may be disposed at the garnish member 130P and the vehicle interior material 130 to output a sound. For example, at least one or more of the garnish member 130P and the vehicle interior material 130 may output a sound based on a vibration of the fourth sound generating apparatus 30-4.

The garnish member 130P may be configured to cover a portion of the door interior material 130D exposed at the interior space, but example embodiments of the present disclosure are not limited thereto. For example, the garnish member 130P may be configured to cover a portion of one or more of the dashboard 130A, the pillar interior material 130B, and the roof interior material 130C, which are exposed at the interior space.

The garnish member 130P according to an example embodiment of the present disclosure may include a metal material or a nonmetal material (or a composite nonmetal material) having a material characteristic suitable for generating a sound based on a vibration. For example, a metal material of the garnish member 130P may include any one or more materials of stainless steel, aluminum (Al), an A1 alloy, a magnesium (Mg), a Mg alloy, and a magnesium-lithium (Mg—Li) alloy, but example embodiments of the present disclosure are not limited thereto. The nonmetal material (or the composite nonmetal material) of the garnish member 130P may include one or more of wood, plastic, glass, cloth, fiber, rubber, paper, carbon, and leather, but example embodiments of the present disclosure are not limited thereto. For example, the garnish member 130P may include a metal material having a material characteristic suitable for generating a sound of a high-pitched sound band, but example embodiments of the present disclosure are not limited thereto. For example, the high-pitched sound band may have a frequency of 1 kHz or more or 3 kHz or more, but example embodiments of the present disclosure are not limited thereto.

The fourth sound generating apparatus 30-4 may be disposed between the garnish member 130P and the vehicle interior material 130. For example, the fourth sound generating apparatus 30-4 may be a garnish speaker or the like, but example embodiments of the present disclosure are not limited thereto.

The fourth sound generating apparatus 30-4 according to an example embodiment of the present disclosure may include one or more of the sound apparatus 30 described above with reference to FIGS. 3 to 52. The fourth sound generating apparatus 30-4 may be disposed at a main interior material or the vehicle interior material 130 and the garnish member 130P and may be connected or coupled to the garnish member 130P.

The fourth sound generating apparatus 30-4 according to an example embodiment of the present disclosure may be configured to indirectly or directly vibrate the garnish member 130P to output a sound toward the interior space. For example, the fourth sound generating apparatus 30-4 may be configured to output a sound of a high-pitched sound band, but example embodiments of the present disclosure are not limited thereto.

The vehicular apparatus or the vehicle 10 according to an example embodiment of the present disclosure may output a sound to the interior space IS through at least one or more of the first sound generating apparatus 30-1 disposed at the vehicle interior material 130, the second sound generating apparatus 30-2 disposed at the vehicle interior material 130 exposed at the interior space, the third sound generating apparatus 30-3 disposed at the vehicle window 230, and the fourth sound generating apparatus 30-4 disposed at the garnish member 130P, and thus, may output the sound by a vehicle interior material 130 as a sound vibration plate, thereby outputting a multichannel surround stereo sound.

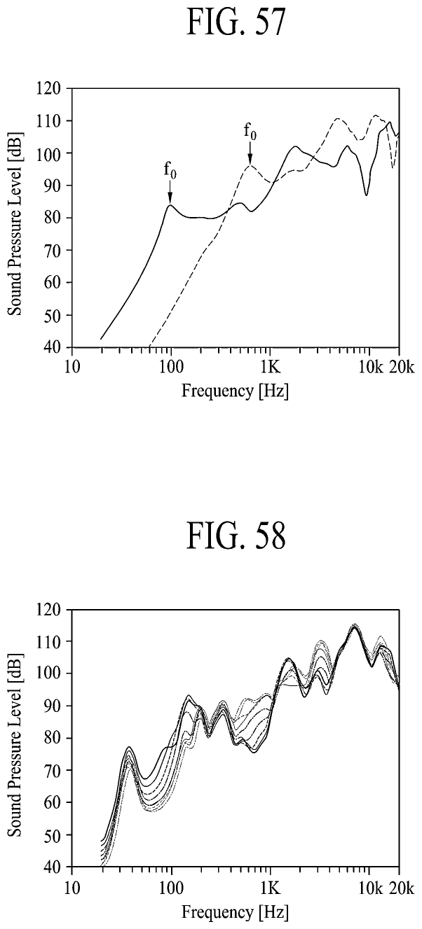

FIG. 57 is a diagram illustrating a sound output characteristic of a sound apparatus according to an example embodiment of the present disclosure and an experimental example.

In FIG. 57, the abscissa axis represents a frequency in hertz (Hz), and the ordinate axis represents a sound pressure level (SPL) in decibels (dB). A thick solid line represents a sound output characteristic of the sound apparatus including the both-short-side fixing structure of the vibration member by using the coupling member illustrated in FIGS. 3 to 6 according to an example embodiment of the present disclosure. A dotted line represents a sound output characteristic of the sound apparatus including the 4-side fixing structure of the vibration member by using the coupling member illustrated in FIG. 7 according to an example embodiment of the present disclosure.

The sound output characteristic may be measured by sound analysis equipment. The sound analysis equipment may include a control PC, a sound card for transmitting and receiving sound, an amplifier for amplifying and transmitting the sound generated from the sound card to the sound apparatus, and a microphone for collecting the sound generated in the apparatus based on driving of the vibration apparatus. The sound collected by the microphone is input to the control PC through the sound card, and the sound is checked in a control program to analyze the sound of the apparatus.

The sound output characteristic has been measured in an anechoic chamber, which is closed in all directions. When measuring, an applied frequency signal is applied as a sine sweep within a range of 10 Hz to 20 kHz, and 1/6 octave smoothing has been performed on a measurement result. A separation distance between the apparatus and the microphone is adjusted to be 30 cm. However, a measurement method of the sound output characteristic may be not limited thereto.

With reference to FIG. 57, comparing with the dotted line, it may be seen that the thick solid line has a low natural frequency fo and has a relatively high sound pressure level in a frequency (or pitched sound band) of about 380 Hz or less. For example, the natural frequency fo of the thick solid line has been measured to be about 100 Hz, and the natural frequency fo of the dotted line has been measured to be about 650 Hz. For example, comparing with the dotted line, it has been measured that a sound pressure level of the thick solid line increases by about 33 dB in a frequency (or pitched sound band) of 100 Hz.

Therefore, the sound apparatus according to an example embodiment of the present disclosure may include the both-short-side fixing structure of the vibration member by using the coupling member, and thus, the natural frequency fo may decrease, and a sound pressure level characteristic and/or a sound characteristic in a pitched sound band of about 380 Hz or less may increase (or be enhanced).

FIG. 58 is a diagram illustrating a sound output characteristic of a sound apparatus according to example embodiments of the present disclosure and an experimental example.

In FIG. 58, the abscissa axis represents a frequency in hertz (Hz), and the ordinate axis represents a sound pressure level (SPL) in decibels (dB). In FIG. 58, a thin dash-double dotted line represents a sound output characteristic of the sound apparatus according to the experimental example illustrated in FIG. 7. A thin dash-single dotted line represents a sound output characteristic of the sound apparatus according to another example embodiment of the present disclosure illustrated in FIG. 8. A thin dotted line represents a sound output characteristic of the sound apparatus according to another example embodiment of the present disclosure illustrated in FIG. 9. A thin solid line represents a sound output characteristic of the sound apparatus according to another example embodiment of the present disclosure illustrated in FIG. 10. A dash-double dotted line represents a sound output characteristic of the sound apparatus according to the experimental example illustrated in FIG. 11. A dash-single dotted line represents a sound output characteristic of the sound apparatus according to another example embodiment of the present disclosure illustrated in FIG. 12. A dotted line represents a sound output characteristic of the sound apparatus according to another example embodiment of the present disclosure illustrated in FIG. 13. A solid line represents a sound output characteristic of the sound apparatus according to an example embodiment of the present disclosure illustrated in FIG. 14. A thick solid line represents a sound output characteristic of the sound apparatus according to an example embodiment of the present disclosure illustrated in FIG. 3 to 6 or 15. A measurement method of a sound output characteristic may be substantially a same as the above description of FIG. 57, and thus, its repeated descriptions are omitted.

With reference to FIG. 58, comparing with the experimental example, it may be seen that the sound apparatus according to example embodiments of the present disclosure has a relatively high sound pressure level in a frequency (or pitched sound band) of about 200 Hz or less and has a relatively low sound pressure level in a frequency (or pitched sound band) of about 200 Hz or more. In addition, according to the other lines except a thin dash-double dotted line, it may be seen that the sound apparatus according to example embodiments of the present disclosure has a relatively high sound pressure level in a frequency (or pitched sound band) of about 200 Hz or less and has a relatively low sound pressure level in a frequency (or pitched sound band) of about 200 Hz or more as a both-long-side region of a vibration member fixed by using the coupling member is progressively reduced.

Therefore, a size of the both-long-side region of the vibration member fixed by using the coupling member may be selected based on a frequency (or pitched sound band) which is to be realized by the sound apparatus, and thus a sound pressure level characteristic and/or a sound characteristic in a desired pitched sound band (or frequency) may be enhanced.

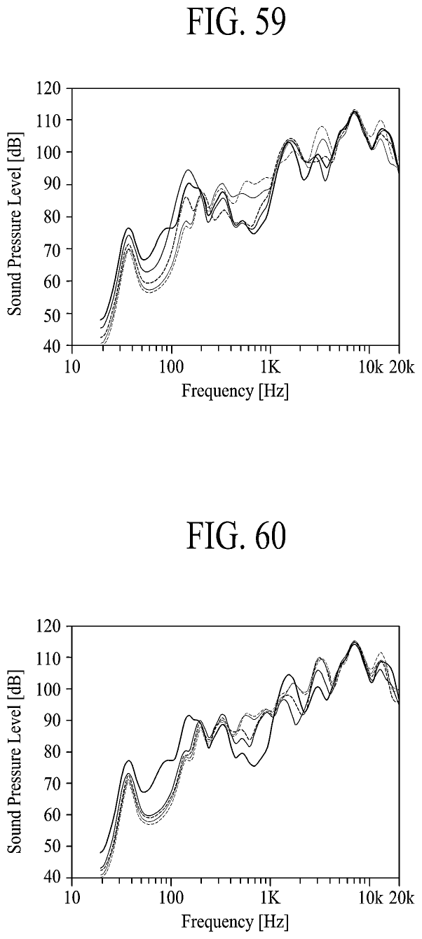

FIG. 59 is a diagram illustrating a sound output characteristic of a sound apparatus according to example embodiments of the present disclosure and an experimental example.

In FIG. 59, the abscissa axis represents a frequency in hertz (Hz), and the ordinate axis represents a sound pressure level (SPL) in decibels (dB). In FIG. 59, a thin dotted line represents a sound output characteristic of the sound apparatus according to the experimental example illustrated in FIG. 7. A thin solid line represents a sound output characteristic of the sound apparatus according to another example embodiment of the present disclosure illustrated in FIG. 16. A dotted line represents a sound output characteristic of the sound apparatus according to another example embodiment of the present disclosure illustrated in FIG. 17. A solid line represents a sound output characteristic of the sound apparatus according to an example embodiment of the present disclosure illustrated in FIG. 18. A thick solid line represents a sound output characteristic of the sound apparatus according to an example embodiment of the present disclosure illustrated in FIG. 3 to 6 or 15. A measurement method of a sound output characteristic may be substantially a same as the above description of FIG. 57, and thus, its repeated descriptions are omitted.

With reference to FIG. 59, comparing with the experimental example, it may be seen that the sound apparatus according to example embodiments of the present disclosure has a relatively high sound pressure level in a frequency (or pitched sound band) of about 200 Hz or less and has a relatively low sound pressure level in a frequency (or pitched sound band) of about 200 Hz or more. In addition, according to the other lines except a thin dotted line, it may be seen that the sound apparatus according to example embodiments of the present disclosure has a relatively high sound pressure level in a frequency (or pitched sound band) of about 200 Hz or less and has a relatively low sound pressure level in a frequency (or pitched sound band) of about 200 Hz or more as a both-long-side region of a vibration member fixed by using the coupling member is progressively reduced.

Therefore, a size of the both-long-side region of the vibration member fixed by using the coupling member may be selected based on a frequency (or pitched sound band) which is to be realized by the sound apparatus, and thus a sound pressure level characteristic and/or a sound characteristic in a desired pitched sound band (or frequency) may be enhanced.

FIG. 60 is a diagram illustrating a sound output characteristic of a sound apparatus according to example embodiments of the present disclosure and an experimental example.

In FIG. 60, the abscissa axis represents a frequency in hertz (Hz), and the ordinate axis represents a sound pressure level (SPL) in decibels (dB). In FIG. 60, a thin dotted line represents a sound output characteristic of the sound apparatus according to the experimental example illustrated in FIG. 7. A thin solid line represents a sound output characteristic of the sound apparatus according to another example embodiment of the present disclosure illustrated in FIG. 21. A dotted line represents a sound output characteristic of the sound apparatus according to another example embodiment of the present disclosure illustrated in FIG. 20. A solid line represents a sound output characteristic of the sound apparatus according to an example embodiment of the present disclosure illustrated in FIG. 19. A thick solid line represents a sound output characteristic of the sound apparatus according to an example embodiment of the present disclosure illustrated in FIG. 3 to 6 or 15. A measurement method of a sound output characteristic may be substantially a same as the above description of FIG. 57, and thus, its repeated descriptions are omitted.

With reference to FIG. 60, comparing with the experimental example, it may be seen that the sound apparatus according to example embodiments of the present disclosure has a relatively high sound pressure level in a frequency (or pitched sound band) of about 200 Hz or less and has a relatively low sound pressure level in a frequency (or pitched sound band) of about 200 Hz or more. In addition, according to the other lines except a thin dotted line, it may be seen that the sound apparatus according to example embodiments of the present disclosure has a relatively high sound pressure level in a frequency (or pitched sound band) of about 200 Hz or less and has a relatively low sound pressure level in a frequency (or pitched sound band) of about 200 Hz or more as a both-long-side region of a vibration member fixed by using the coupling member is progressively reduced.

Therefore, a size of the both-long-side region of the vibration member fixed by using the coupling member may be selected based on a frequency (or pitched sound band) which is to be realized by the sound apparatus, and thus a sound pressure level characteristic and/or a sound characteristic in a desired pitched sound band (or frequency) may be enhanced.

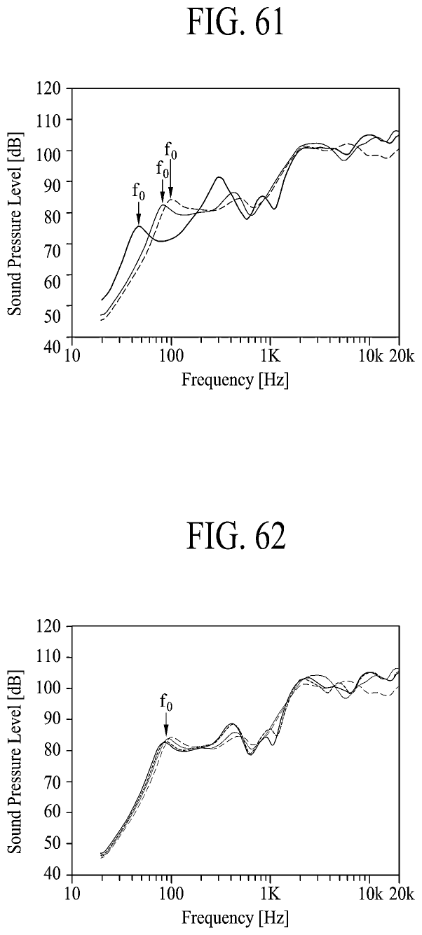

FIG. 61 is a diagram illustrating a sound output characteristic of a sound apparatus according to an example embodiment of the present disclosure.

In FIG. 61, the abscissa axis represents a frequency in hertz (Hz), and the ordinate axis represents a sound pressure level (SPL) in decibels (dB). In FIG. 61, a dotted line represents a sound output characteristic of the sound apparatus according to an example embodiment of the present disclosure illustrated in FIG. 3 to 6 or 15. A solid line represents a sound output characteristic of the sound apparatus according to another example embodiment of the present disclosure illustrated in FIG. 22. A thick solid line represents a sound output characteristic of the sound apparatus according to another example embodiment of the present disclosure illustrated in FIG. 23. A measurement method of a sound output characteristic may be substantially a same as the above description of FIG. 57, and thus, its repeated descriptions are omitted.

With reference to FIG. 61, comparing with a dotted line, it may be seen that a solid line has a low natural frequency fo. Comparing with the solid line, it may be seen that a thick solid line has a low natural frequency fo. For example, the natural frequency fo of the dotted line has been measured to be about 102 Hz, the natural frequency fo of the solid line has been measured to be about 86 Hz, and the natural frequency fo of the thick solid line has been measured to be about 47 Hz.

Therefore, a sound apparatus according to an example embodiment of the present disclosure may include an extension portion extending in a long-side length direction of the vibration member in the both-short-side fixing structure of the vibration member based on a coupling member, and thus, a sound pressure level characteristic and/or a sound characteristic in a low pitched sound band of about 100 Hz or less may be increased (or enhanced).

FIG. 62 is a diagram illustrating a sound output characteristic of a sound apparatus according to an example embodiment of the present disclosure.

In FIG. 62, the abscissa axis represents a frequency in hertz (Hz), and the ordinate axis represents a sound pressure level (SPL) in decibels (dB). In FIG. 62, a thin dotted line represents a sound output characteristic of the sound apparatus according to an example embodiment of the present disclosure illustrated in FIG. 3 to 6 or 15. A thin solid line represents a sound output characteristic of the sound apparatus according to another example embodiment of the present disclosure illustrated in FIG. 24. A dotted line represents a sound output characteristic of the sound apparatus according to an example embodiment of the present disclosure illustrated in FIG. 25. A solid line represents a sound output characteristic of the sound apparatus according to another example embodiment of the present disclosure illustrated in FIG. 26. A measurement method of a sound output characteristic may be substantially a same as the above description of FIG. 57, and thus, its repeated descriptions are omitted.

With reference to FIG. 62, comparing with a thin dotted line, it may be seen that a thin solid line has a low natural frequency fo. Comparing with the thin solid line, it may be seen that a dotted line has a low natural frequency fo. Comparing with the dotted line, it may be seen that a solid line has a low natural frequency fo. For example, the natural frequency fo of the thin dotted line has been measured to be about 102 Hz, the natural frequency fo of the thin solid line has been measured to be about 95 Hz, the natural frequency fo of the dotted line has been measured to be about 89 Hz, and the natural frequency fo of the solid line has been measured to be about 86 Hz.

According to an example embodiment of the present disclosure, it may be seen that the sound apparatus according to another example embodiment of the present disclosure illustrated in FIGS. 24 to 26 has a natural frequency fo similar to that of the sound apparatus according to an example embodiment of the present disclosure illustrated in FIG. 15.

Therefore, according to an example embodiment of the present disclosure, a sound apparatus may implement a sound pressure level characteristic and/or a sound characteristic of a vibration member having a relatively small size, based on an arrangement size (or area) of a coupling member disposed at a short side edge portion and a long side edge portion of an extension portion of the vibration member. In addition, in the sound apparatus according to an example embodiment of the present disclosure, a natural frequency fo may be lowered as an arrangement region of a coupling member disposed at the extension portion of the vibration member is progressively reduced, and thus, a sound pressure level characteristic and/or a sound characteristic of a low pitched sound band may be increased (or enhanced).

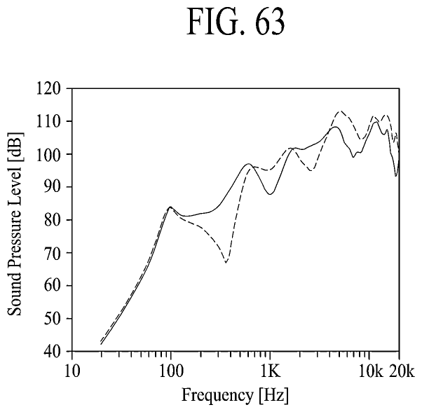

FIG. 63 is a diagram illustrating a sound output characteristic of a sound apparatus according to another example embodiment of the present disclosure illustrated in FIG. 27.

In FIG. 63, the abscissa axis represents a frequency in hertz (Hz), and the ordinate axis represents a sound pressure level (SPL) in decibels (dB). In FIG. 63, a dotted line represents a sound output characteristic of a case where a driving signal having the same phase is applied to the 1-1^{th} vibration apparatus and the 1-2^{th} vibration apparatus illustrated in FIG. 27. A solid line represents a sound output characteristic of a case where a driving signal having an antiphase is applied to the 1-1^{th} vibration apparatus and the 1-2^{th} vibration apparatus illustrated in FIG. 27. A measurement method of a sound output characteristic may be substantially a same as the above description of FIG. 57, and thus, its repeated descriptions are omitted.

With reference to FIG. 63, it may be seen that a solid line and a dotted line have similar sound pressure level characteristic in a pitched sound band (or frequency) of about 100 Hz or less. Comparing with the solid line, it may be seen that the dotted line has a high sound pressure level characteristic in a pitched sound band (or frequency) of about 680 Hz to 1.8 kHz and a pitched sound band (or frequency) of about 4 kHz or more. Comparing with the dotted line, it may be seen that the solid line has a high sound pressure level characteristic in a pitched sound band (or frequency) of about 100 Hz to 680 Hz and a pitched sound band (or frequency) of about 1.8 kHz to 4 kHz.

According to another example embodiment of the present disclosure, when a frequency of a driving signal to be supplied to the 1-1^{th} vibration apparatus 333a1 and the 1-2^{th} vibration apparatus 333a2 is included in a first pitched sound band (for example, 100 Hz or less, 680 Hz to 1.8 kHz, or 4 kHz or more), the 1-1^{th} vibration apparatus 333a1 and the 1-2^{th} vibration apparatus 333a2 may be configured to vibrate based on a driving signal having the same phase. In addition, when a frequency of a driving signal to be supplied to the 1-1^{th} vibration apparatus 333a1 and the 1-2^{th} vibration apparatus 333a2 is included in a second pitched sound band (for example, 100 Hz to 680 Hz or 1.8 kHz to 4 kHz), the 1-1^{th} vibration apparatus 333a1 and the 1-2^{th} vibration apparatus 333a2 may be configured to vibrate based on a driving signal having an antiphase.

Therefore, the sound apparatus according to another example embodiment of the present disclosure may include a vibration member including a first region and a second region fixed by a coupling member through different types and the 1-1^{th} vibration apparatus 333a1 and the 1-2^{th} vibration apparatus 333a2 configured to respectively vibrate the first and second regions of the vibration member, based on a driving signal having the same phase or a driving signal having an antiphase, and thus, a sound reproduction band may extend based on a sound generated in each of the first and second regions of the vibration member, and a dip phenomenon occurring in a specific pitched sound band (or frequency) may be prevented or minimized.

A sound apparatus and a vehicular apparatus including the same according to one or more example embodiments of the present disclosure are described below.

A sound apparatus according to one or more example embodiments of the present disclosure may comprise an enclosure including an internal space, a sound generating module in the internal space of the enclosure, and a coupling member partially provided between the enclosure and the sound generating module.

According to one or more example embodiments of the present disclosure, the sound apparatus may further comprise an air gap between an edge portion of the sound generating module and the enclosure.

According to one or more example embodiments of the present disclosure, the sound generating module may comprise a vibration member, and a vibration apparatus connected to the vibration member and configured to vibrate the vibration member. The coupling member may be partially provided between the vibration member and the enclosure.

According to one or more example embodiments of the present disclosure, the sound apparatus may further comprise an air gap between the vibration member and the enclosure.

According to one or more example embodiments of the present disclosure, the air gap may be in at least a portion of a region between an edge portion of the vibration member and an edge portion which is adjacent to a long side of the enclosure.

According to one or more example embodiments of the present disclosure, the coupling member may be disposed between the enclosure and an edge portion which is adjacent to a short side of the vibration member and may be not disposed between the enclosure and an edge portion which is adjacent to a long side of the vibration member.

According to one or more example embodiments of the present disclosure, the enclosure may comprise a plate spaced apart from the sound generating module, and a sidewall portion between the plate and the sound generating module. The coupling member may be between the vibration member and the sidewall portion of the enclosure.

According to one or more example embodiments of the present disclosure, the sidewall portion of the enclosure may be disposed along an edge portion of the plate and may provide the internal space between the plate and the sound generating module.

According to one or more example embodiments of the present disclosure, the sidewall portion of the enclosure may comprise a first sidewall connected to a first edge portion which is adjacent to a first short side of the plate, a second sidewall connected to a second edge portion which is adjacent to a second short side of the plate, a third sidewall connected to a third edge portion which is adjacent to a first long side of the plate, and a fourth sidewall connected to a fourth edge portion which is adjacent to a second long side of the plate. The coupling member may be between the vibration member and each of the first sidewall and the second sidewall of the enclosure.

According to one or more example embodiments of the present disclosure, the coupling member may comprise a 1-1^{th} coupling member between the vibration member and the first sidewall of the enclosure, and a 1-2^{th} coupling member between the vibration member and the second sidewall of the enclosure.

According to one or more example embodiments of the present disclosure, the coupling member may further comprise a 1-3^{th} coupling member in at least a portion of a region between the vibration member and the third sidewall of the enclosure, and a 1-4^{th} coupling member in at least a portion of a region between the vibration member and the fourth sidewall of the enclosure.

According to one or more example embodiments of the present disclosure, the vibration member may comprise a first extension portion extending from a first short side of the vibration member, and a second extension portion extending from a second short side of the vibration member. Each of the first extension portion and the second extension portion may comprise a region which is at least 1.5 or more times a short-side length of the vibration member from a center portion of the vibration member. The coupling member may be disposed between the enclosure and each of the first extension portion and the second extension portion.

According to one or more example embodiments of the present disclosure, the coupling member may comprise a 1-1^{th} coupling member between the enclosure and an edge portion which is adjacent to a short side of the first extension portion, and a 1-2^{th} coupling member between the enclosure and an edge portion which is adjacent to a short side of the second extension portion.

According to one or more example embodiments of the present disclosure, the coupling member may further comprise a 1-3^{th} coupling member between the enclosure and at least a portion of an edge portion of each of the first extension portion and the second extension portion adjacent to a first long side of the vibration member, and a 1-4^{th} coupling member between the enclosure and at least a portion of an edge portion of each of the first extension portion and the second extension portion adjacent to a second long side of the vibration member.

According to one or more example embodiments of the present disclosure, the vibration member may comprise a first region and a second region. The vibration apparatus may be configured to vibrate each of the first region and the second region of the vibration member. The coupling member may be disposed at first and second edge portions which is adjacent to a short side of the vibration member and may be disposed at third and fourth edge portions which is adjacent to a long side of the vibration member.

According to one or more example embodiments of the present disclosure, the first region has the first edge portion, the third edge portion and the fourth edge portion, and the second region has the second edge portion, the third edge portion and the fourth edge portion, and the coupling member may be disposed at each of the third and fourth edge portions of any one of the first region and the second region of the vibration member.

According to one or more example embodiments of the present disclosure, the vibration apparatus may comprise a 1-1^{th} vibration apparatus configured to vibrate the first region of the vibration member, and a 1-2^{th} vibration apparatus configured to vibrate the second region of the vibration member.

According to one or more example embodiments of the present disclosure, the 1-1^{th} vibration apparatus and the 1-2^{th} vibration apparatus may vibrate based on a same driving signal, or may vibrate based on different driving signals.

According to one or more example embodiments of the present disclosure, the vibration member may comprise a metal material, or may comprise one or more materials of wood, rubber, plastic, carbon, glass, fiber, cloth, paper, mirror, and leather.

According to one or more example embodiments of the present disclosure, the vibration apparatus may comprise one or more vibration generators. Each vibration generator may comprise a vibration part including a piezoelectric material, a first electrode part in a first surface of the vibration part, and a second electrode part in a second surface different from the first surface of the vibration part.

According to one or more example embodiments of the present disclosure, the vibration part may comprise a plurality of inorganic material portions including the piezoelectric material, and an organic material portion between the plurality of inorganic material portions.

According to one or more example embodiments of the present disclosure, each vibration generator may further comprise a first cover member in the first electrode part, and a second cover member in the second electrode part.

According to one or more example embodiments of the present disclosure, each vibration generator may further comprise a signal supply member electrically connected to the first electrode part and the second electrode part. A portion of the signal supply member may be accommodated between the first cover member and the second cover member.

According to one or more example embodiments of the present disclosure, the vibration apparatus may comprise a first vibration generator and a second vibration generator stacked on each other. Each of the first vibration generator and the second vibration generator may comprise a vibration part, a first electrode part in a first surface of the vibration part, and a second electrode part in a second surface different from the first surface of the vibration part.

According to one or more example embodiments of the present disclosure, the vibration apparatus may comprise a first vibration apparatus configured in a first surface of the vibration member, and a second vibration apparatus configured in a second surface different from the first surface of the vibration member.

According to one or more example embodiments of the present disclosure, the sound apparatus may further comprise a connection member in a rear surface of the enclosure.

According to one or more example embodiments of the present disclosure, the enclosure may comprise a plate spaced apart from the sound generating module, and a sidewall portion connected to the plate to form the internal space. The connection member may be connected to a rear surface of the plate and has a width which is a same as or different from a width of the sidewall portion.

According to one or more example embodiments of the present disclosure, the enclosure may comprise a plate spaced apart from the sound generating module, and a sidewall portion connected to the plate to form the internal space. The connection member may be connected to a rear surface of the plate. The plate may have a thickness which is a same as or different from a thickness of the vibration member.

According to one or more example embodiments of the present disclosure, the connection member may comprise a first connection member connected to a first edge portion which is adjacent to a first short side of the enclosure, and a second connection member connected to a second edge portion which is adjacent to a second short side of the enclosure.

According to one or more example embodiments of the present disclosure, the sound apparatus may further comprise a gap member between the enclosure and the connection member.

According to one or more example embodiments of the present disclosure, the gap member may comprise a material which differs from a material of the connection member.

According to one or more example embodiments of the present disclosure, the gap member may comprise a first gap member connected to a first rear edge portion of the enclosure, and a second gap member connected to a second rear edge portion of the enclosure. The connection member may comprise a first connection member connected to the first gap member, and a second connection member connected to the second gap member.

According to one or more example embodiments of the present disclosure, the enclosure may further comprise an opening part connected to the internal space and overlapping the sound generating module.

According to one or more example embodiments of the present disclosure, the opening part may comprise a short axis and a long axis. A long-axis direction of the opening part may be parallel to a long-side length direction or a short-side length direction of the enclosure.

According to one or more example embodiments of the present disclosure, the enclosure may further comprise a plurality of holes configured with the opening part therebetween.

According to one or more example embodiments of the present disclosure, the plurality of holes may be extended along a long-side length direction of the enclosure.

A vehicular apparatus according to one or more example embodiments of the present disclosure may comprise an interior material exposed at an interior space, and at least one or more sound generating apparatuses connected to the interior material and configured to output a sound to the interior space. The at least one or more sound generating apparatuses may comprise a sound apparatus. The sound apparatus may comprise an enclosure including an internal space, a sound generating module in the internal space of the enclosure, and a coupling member partially provided between the enclosure and the sound generating module.

According to one or more example embodiments of the present disclosure, the enclosure in the sound apparatus may further comprise an opening part connected to the internal space.

According to one or more example embodiments of the present disclosure, the interior material may comprise one or more opening holes overlapping the opening part of the enclosure.

According to one or more example embodiments of the present disclosure, the vehicular apparatus may further comprise a connection member between the interior material and the enclosure in the sound apparatus. The connection member may comprise a hole overlapping each of the opening part and the one or more opening holes.

According to one or more example embodiments of the present disclosure, the vehicular apparatus may further comprise a connection member between the interior material and the enclosure in the sound apparatus. The connection member may comprise a first connection member connected to a first edge portion which is adjacent to a first short side of the enclosure, and a second connection member connected to a second edge portion which is adjacent to a second short side of the enclosure.

According to one or more example embodiments of the present disclosure, the enclosure in the sound apparatus may further comprise an opening part connected to the internal space. The opening part may overlap a region between the first connection member and the second connection member.

According to one or more example embodiments of the present disclosure, a width of each of the first connection member and the second connection member may be a same as that of the coupling member.

According to one or more example embodiments of the present disclosure, a width of each of the first connection member and the second connection member may be greater or smaller than a width of the coupling member.

According to one or more example embodiments of the present disclosure, the vehicular apparatus may further comprise a gap member between the enclosure and the connection member.

According to one or more example embodiments of the present disclosure, the gap member may comprise a material which differs from a material of the connection member.

According to one or more example embodiments of the present disclosure, the opening part may comprise a short axis and a long axis. A long-axis direction of the opening part may be parallel to a long-side length direction or a short-side length direction of the enclosure.

According to one or more example embodiments of the present disclosure, the enclosure may further comprise a plurality of holes configured with the opening part therebetween.

According to one or more example embodiments of the present disclosure, the interior material may comprise an opening hole connected to the opening part of the enclosure. The enclosure may further comprise a protrusion part protruding from the enclosure to surround the opening part and configured to be accommodated into the opening hole.

According to one or more example embodiments of the present disclosure, the interior material may comprise one or more materials of metal, wood, rubber, plastic, carbon, glass, fiber, cloth, paper, a mirror, and leather.

According to one or more example embodiments of the present disclosure, the interior material may comprise at least one or more of a dashboard, a pillar interior material, a roof interior material, a door interior material, a seat interior material, a handle interior material, a floor interior material, a rear package interior material, an overhead console, a rear view mirror, a glove box, a garnish member, and a sun visor. The at least one or more sound generating apparatuses may be configured to vibrate at least one or more of the dashboard, the pillar interior material, the roof interior material, the door interior material, the seat interior material, the handle interior material, the floor interior material, the rear package interior material, the overhead console, the rear view mirror, the glove box, the garnish member, and the sun visor, to generate a sound.

A vehicular apparatus according to one or more example embodiments of the present disclosure may comprise an interior material exposed at an interior space, and at least one or more sound apparatuses as described above, connected to the interior material and configured to output a sound to the interior space.

According to one or more example embodiments of the present disclosure, the interior material may comprise an opening hole connected to the enclosure in the sound apparatus. The enclosure may further comprise a protrusion part protruding from the enclosure and configured to be accommodated into the opening hole.

A sound apparatus according to one or more example embodiments of the present disclosure may be applied to or included in a sound apparatus disposed at an apparatus (or a display apparatus). The apparatus according to an example embodiment of the present disclosure may be applied to or included in mobile apparatuses, video phones, smart watches, watch phones, wearable apparatuses, foldable apparatuses, rollable apparatuses, bendable apparatuses, flexible apparatuses, curved apparatuses, sliding apparatuses, variable apparatuses, electronic organizers, electronic books, portable multimedia players (PMPs), personal digital assistants (PDAs), MP3 players, mobile medical devices, desktop personal computers (PCs), laptop PCs, netbook computers, workstations, navigation apparatuses, automotive navigation apparatuses, automotive display apparatuses, automotive apparatuses, theatre apparatuses, theatre display apparatuses, TVs, wall paper display apparatuses, signage apparatuses, game machines, notebook computers, monitors, cameras, camcorders, and home appliances, or the like. In addition, the sound apparatus according to one or more example embodiments of the present disclosure may be applied to or included in an organic light-emitting lighting apparatus or an inorganic light-emitting lighting apparatus. When the sound apparatus is applied to or included in the lighting apparatuses, the lighting apparatuses may act as lighting and a speaker. In addition, when the sound apparatus according to one or more example embodiments of the present disclosure is applied to or included in the mobile apparatuses, or the like, the sound apparatus may be one or more of a speaker, a receiver, and a haptic device, but example embodiments of the present disclosure are not limited thereto.

The above-described feature, structure, and effect of the present disclosure are included in at least one example embodiment of the present disclosure, but are not limited to only one example embodiment. Furthermore, the feature, structure, and effect described in at least one example embodiment of the present disclosure may be implemented through combination or modification of other example embodiments by those skilled in the art. Therefore, content associated with the combination and modification should be construed as being within the scope of the present disclosure. The scope of protection of the present disclosure should be construed based on the following claims, and all technical features within the scope of equivalents thereof should be construed as being included within the scope of the present disclosure.

What is claimed is:

1. A sound apparatus, comprising:
an enclosure including an internal space;
a sound generating module in the internal space of the enclosure; and
a coupling member partially provided between the enclosure and the sound generating module.

2. The sound apparatus of claim 1, further comprising an air gap between an edge portion of the sound generating module and the enclosure.

3. The sound apparatus of claim 1,
wherein the sound generating module comprises:
a vibration member; and
a vibration apparatus connected to the vibration member and configured to vibrate the vibration member, and
wherein the coupling member is partially provided between the vibration member and the enclosure.

4. The sound apparatus of claim 3, wherein the coupling member is disposed between the enclosure and an edge portion which is adjacent to a short side of the vibration member and is not disposed between the enclosure and an edge portion which is adjacent to a long side of the vibration member.

5. The sound apparatus of claim 3,
wherein the enclosure comprises:
a plate spaced apart from the sound generating module; and
a sidewall portion between the plate and the sound generating module, and
wherein the coupling member is between the vibration member and the sidewall portion of the enclosure.

6. The sound apparatus of claim 5,
wherein the sidewall portion of the enclosure comprises:
a first sidewall connected to a first edge portion which is adjacent to a first short side of the plate;
a second sidewall connected to a second edge portion which is adjacent to a second short side of the plate;
a third sidewall connected to a third edge portion which is adjacent to a first long side of the plate; and
a fourth sidewall connected to a fourth edge portion which is adjacent to a second long side of the plate, and
wherein the coupling member is between the vibration member and each of the first sidewall and the second sidewall of the enclosure.

7. The sound apparatus of claim 3,
wherein the vibration member comprises:
a first extension portion extending from a first short side of the vibration member; and
a second extension portion extending from a second short side of the vibration member,
wherein each of the first extension portion and the second extension portion comprises a region which is at least 1.5 or more times a short-side length of the vibration member from a center portion of the vibration member, and
wherein the coupling member is disposed between the enclosure and each of the first extension portion and the second extension portion.

8. The sound apparatus of claim 3, wherein the vibration member comprises a first region and a second region,
wherein the vibration apparatus is configured to vibrate each of the first region and the second region of the vibration member, and
wherein the coupling member is disposed at first and second edge portions which are adjacent to a short side of the vibration member and is disposed at third and fourth edge portions which are adjacent to a long side of the vibration member.

9. The sound apparatus of claim 3,
wherein the vibration apparatus comprises one or more vibration generators, and
wherein each vibration generator comprises:
a vibration part including a piezoelectric material;
a first electrode part in a first surface of the vibration part; and
a second electrode part in a second surface different from the first surface of the vibration part.

10. The sound apparatus of claim 1, wherein the enclosure further comprises an opening part connected to the internal space and overlapping the sound generating module.

11. The sound apparatus of claim 10, wherein the enclosure further comprises a plurality of holes configured with the opening part therebetween.

12. A vehicular apparatus, comprising:
an interior material exposed at an interior space; and
at least one or more sound generating apparatuses connected to the interior material and configured to output a sound to the interior space,
wherein the at least one or more sound generating apparatuses comprise the sound apparatus of claim 1.

13. The vehicular apparatus of claim 12, wherein the enclosure in the sound apparatus further comprises an opening part connected to the internal space.

14. The vehicular apparatus of claim 13, further comprising a connection member between the interior material and the enclosure in the sound apparatus,
wherein the connection member comprises a hole overlapping the opening part.

15. The vehicular apparatus of claim 12, further comprising a connection member between the interior material and the enclosure in the sound apparatus,
wherein the connection member comprises:
a first connection member connected to a first edge portion which is adjacent to a first short side of the enclosure; and
a second connection member connected to a second edge portion which is adjacent to a second short side of the enclosure.

16. The vehicular apparatus of claim 15, wherein the enclosure in the sound apparatus further comprises an opening part connected to the internal space,
wherein the opening part overlaps a region between the first connection member and the second connection member.

17. The vehicular apparatus of claim 15, further comprising a gap member between the enclosure and the connection member.

18. The vehicular apparatus of claim 17, wherein the gap member comprises a material which differs from a material of the connection member.

19. The vehicular apparatus of claim 13,
wherein the interior material comprises an opening hole connected to the opening part of the enclosure, and
wherein the enclosure further comprises a protrusion part protruding from the enclosure to surround the opening part and configured to be accommodated into the opening hole.

20. The vehicular apparatus of claim 12, wherein the interior material comprises one or more materials of metal, wood, rubber, plastic, carbon, glass, fiber, cloth, paper, a mirror, and leather.
